(19) United States
(12) Patent Application Publication
(10) Pub. No.: US 2008/0007146 A1
(43) Pub. Date: Jan. 10, 2008

(54) Cash dispenser

(75) Inventor: Roger Hillman, Flen (SE)

Correspondence Address: OLIFF & BERRIDGE, PLC, P.O. BOX 320850, ALEXANDRIA, VA, 22320-4850, US

(73) Assignee: De La Rue International Limited, Basingstoke (GB)

(21) Appl. No.: 11/797,748

(22) Filed: May 7, 2007

Related U.S. Application Data
(60) Provisional application No. 60/801,070, filed on May 18, 2006.

(51) Int. Cl. B42F 17/00

(52) U.S. Cl. 312/183

(57) ABSTRACT

A document handling apparatus is disclosed. The apparatus comprises a cabinet within which is housed a frame to which a number of feed modules are mounted. Feed cassettes containing banknotes may be removeably inserted into each of the feed modules which are operable to feed notes from the cassettes to a stacker and delivery module via a document transport. Dispensing of documents is performed on receipt of an appropriate command, typically from an external personal computer, and overall operation of the banknote dispenser is controlled by a controller printed circuit board.

### BACKGROUND OF THE INVENTION

The present invention relates to a document handling apparatus. The apparatus is particularly well suited for handling documents of value such as banknotes or other such documents, for example cheques, certificates, vouchers, tickets or tokens. This type of document handling apparatus is used in many different environments including banks and other cash processing institutions.

### SUMMARY OF INVENTION

The present invention provides a document handling apparatus substantially as herein described with reference to the accompanying drawings.

A document handling apparatus is disclosed. The apparatus comprises a cabinet within which is housed a frame to which a number of feed modules are mounted. Feed cassettes containing banknotes may be removeably inserted into each of the feed modules which are operable to feed notes from the cassettes to a stacker and delivery module via a document transport. Dispensing of documents is performed on receipt of an appropriate command, typically from an external personal computer, and overall operation of the banknote dispenser is controlled by a controller printed circuit board, which is also described in detail later.

### BRIEF DESCRIPTION OF DRAWINGS

An example of the invention will now be described with reference to the accompanying drawings in which:

FIG. 1 shows a first variant of cabinet;

FIG. 2 shows a second variant of cabinet;

FIG. 3 shows a first variant of frame;

FIG. 4 shows a second variant of frame;

FIGS. 5a and 5b show how the feed modules fit into each variant of frame;

FIG. 6 is a perspective view of a feed module;

FIG. 7 shows the rear side of a feed module;

FIG. 8 shows a cassette bay and part of the transport module;

FIGS. 9a to 9c show the inner feeder assembly of the transport module;

FIGS. 10a to 10e show a shaft assembly in the transport module;

FIG. 11 shows the top transport assembly;

FIGS. 12a and 12b show a sensor for detecting the passage of a note through the shaft assembly;

FIG. 13 shows feed cassettes in each of the feed modules;

FIG. 14 shows a feed cassette;

FIG. 15 shows the interior of a feed cassette;

FIGS. 16 and 17 show exploded views of a feed cassette;

FIGS. 18a and 18b show a pusher plate assembly of the feed cassette;

FIGS. 19a and 19b show two variants of the stacker and delivery module respectively;

FIG. 20 shows a front perspective view of the stacker and delivery module;

FIG. 21 shows a rear perspective view of the stacker and delivery module;

FIG. 22 shows the stacker system;

FIG. 23 shows the delivery system;

FIGS. 24a and 24b show further aspects of the stacker and delivery module;

FIG. 25a to 25e show a sensor system incorporated into the stacker and delivery module;

FIGS. 26 and 27 show views of two examples of doubles detector;

FIGS. 28 to 32 show five different variants of presenter system;

FIGS. 33 and 34 show schematic layouts of the cash dispenser system;

FIGS. 35 to 37 show the vertical transport module used in one variant;

FIG. 38 to 40 show a reject cassette;

FIGS. 41 to 44 show a loading frame and its operation;

FIG. 45 shows a block diagram of the electronic control system;

FIG. 46 shows a schematic of the central processing unit;

FIG. 47 shows a schematic of the address decoder;

FIG. 48 shows a schematic of the memory system;

FIGS. 49 and 49a show the doubles detector note counting circuit;

FIGS. 50 and 51 show the serial communications and counter time circuits;

FIGS. 52 to 55 show the module controller;

FIG. 56 shows cassette interface circuitry;

FIG. 57 shows a circuit to control the operation of the feed solenoids and note lift motors;

FIG. 58 shows control circuitry for the motors in the delivery module.

### DETAILED DESCRIPTION

0. Overview

This description relates to an apparatus for dispensing banknotes from banknote storage cassettes to one or more users, typically bank tellers.

The banknote dispenser comprises a cabinet within which is housed a frame to which are mounted the function components of the banknote dispenser. In particular, a number of feed modules are mounted in the frame along with a stacker and delivery module. Feed cassettes containing banknotes of different denominations may be removably inserted into each of the feed modules which are operable to feed notes from the cassettes to the stacker and delivery module which then presents them to a user or, if necessary, rejects them to a reject cassette.

The operation of the banknote dispenser is controlled by a controller printed circuit board (PCB) and optionally an internal personal computer (PC). These receive commands issued by the teller via an external terminal or PC and operate the machine accordingly.

The banknote dispenser is provided with an internal mains power supply.

Each subsystem will be described in detail below.

1. Cabinet And Frame

1.1 Cabinet

The cabinet is manufactured from steel plate, which may be 3 millimetres or 12 millimetres thick depending on the application.

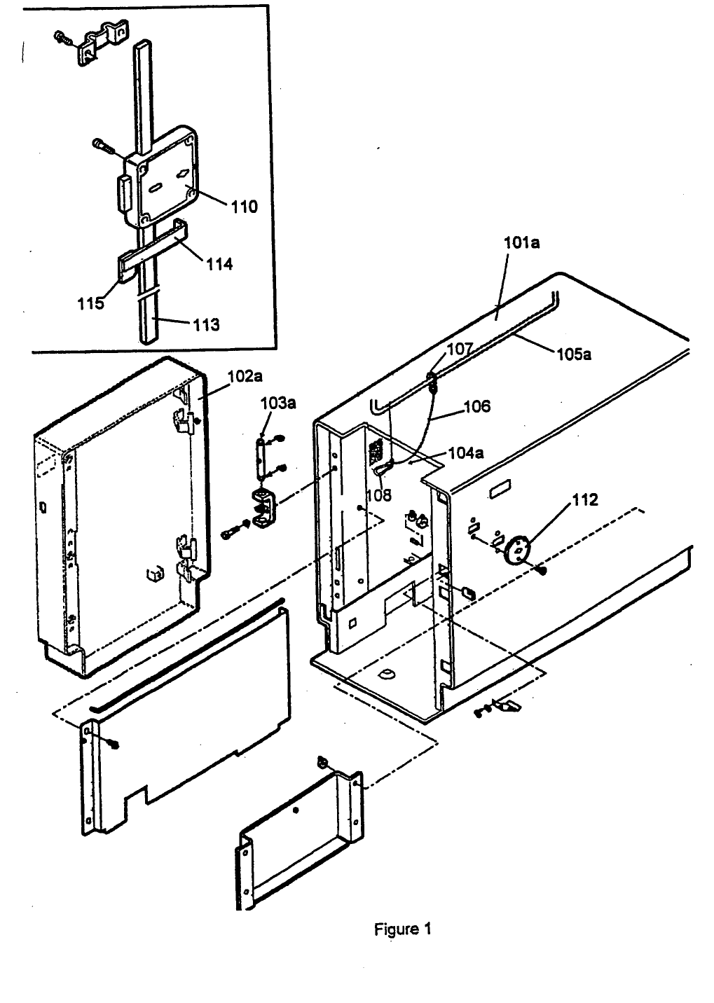

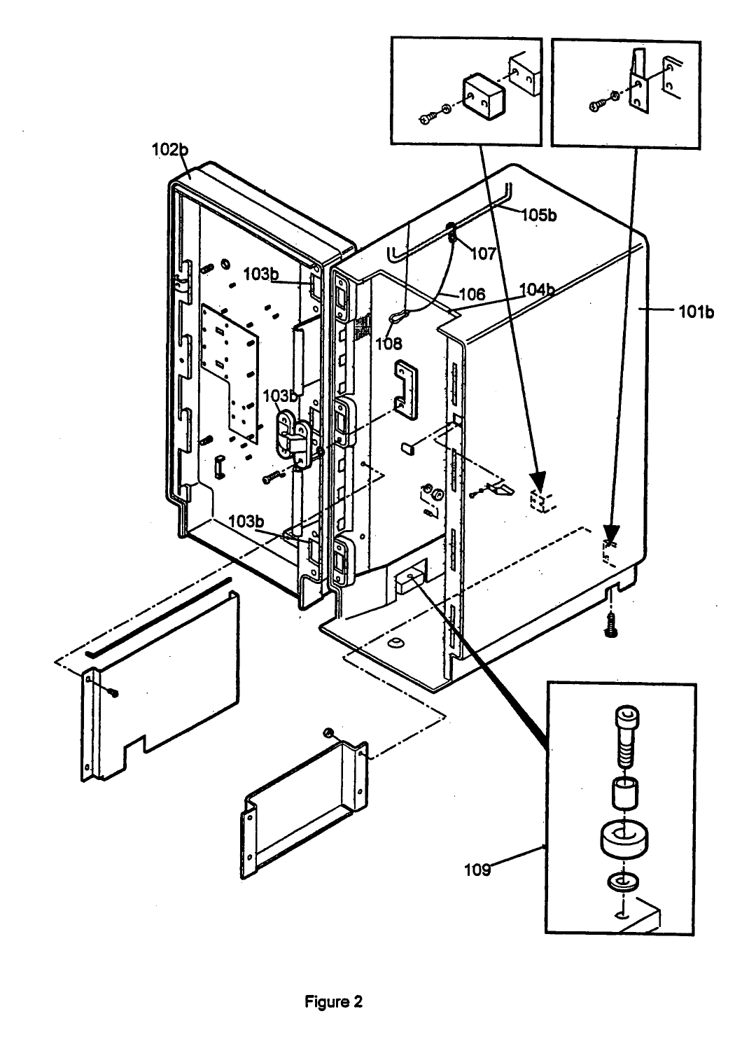

There are two main variants of the cabinet, and these are shown in FIGS. 1 and 2 respectively.

The first variant shown in FIG. 1 is a cabinet 1 that is longer than it is tall. In this variant, the feed cassettes containing the banknotes are all located within the frame in a single tier. The length of the cabinet may be varied to accommodate 4, 5 or 6 feed cassettes. The second variant shown in FIG. 2 is a cabinet 1b that is taller than it is long. In this variant, the feed cassettes are arranged on two tiers one above the other, and the cabinet is available in two lengths, one for housing four feed cassettes and the other for housing six feed cassettes.

1.1.1 First Variant of Cabinet

A door 102a is attached to the cabinet 101a by means of a pair of hinges 103a. The door 102a is similarly manufactured from steel plate, and when it is closed the cabinet 101a and door 102a form a secure environment within which the frame, feed modules and feed cassettes are stored. A recess 104a in the top of cabinet 101a is provided through which notes are delivered to a teller.

The cabinet 101a may be secured to the surface on which it is mounted, normally the floor. For example, if the floor is made of concrete then shield anchors may be passed through holes in the base of cabinet 101a to secure the cabinet 101a to the floor.

A rail 105a is attached to the inside of the top of cabinet 101a. A lanyard 106 is free to slide along the rail 105a by means of an eyelet 107. A clasp 108 at the other end of the lanyard 106 can be releasably attached to the frame to restrict the degree by which this can be withdrawn from cabinet 101a. The frame may be moveable either by means of castors provided on its underside, or it may be mounted to the cabinet 101a by means of runners. This will be described in detail later. In the event where the frame is mounted on castors, then centralising guide wheels (see for example reference numeral 109 in FIG. 2) are provided to ensure that the frame is centralised in the cabinet 101a when it is inserted therein.

The door of the cabinet 102a is secured to the cabinet 101a by means of a lock mechanism. The hinges are internally mounted so that when the door 102a is closed they cannot be tampered with.

The lock mechanism is housed in the side of the cabinet 101a opposite the hinge side. It comprises two locks, a teller lock 110 and a supervisor lock (not shown). Keys may be inserted into each of these through the side of cabinet 101a via apertures in the cabinet 101a that are covered by escutcheon plates 112. Operation of the key for the teller lock 110 moves a locking bar 113 vertically such that the ends engage with locking hasps (not shown) provided on the door 102a. Simultaneously, a cross bar 114 attached to the locking bar 113 also moves vertically. A locking member 115 attached to the cross bar 114 engages with a third locking hasp (not shown). The door is therefore secured at three points.

However, the supervisor lock (not shown) must first be unlocked before the teller lock 110 can be operated since the supervisor lock (not shown) will otherwise prevent the cross bar 114 from being moved in a vertical direction. Therefore, two separate keys which may be retained by different individuals must be used in order to unlock the cabinet 101a. Other configurations of cabinet may be provided with a combination lock in place of the supervisor lock (not shown).

In another configuration, a push button and indicator light are provided in close proximity to the escutcheon plates 112, and are used to activate and indicate the status of a time delay. In this configuration, in order to open the door 102a, a button must first be depressed and held until the indicator light changes from a steady green state to a flashing green state. The button is then released and the green indicator continues to flash. After a predetermined time delay, the light will begin to flash in a red colour and an optional buzzer tone may be emitted. At this point, the armature of a solenoid that was preventing the supervisor lock from being operated is withdrawn. A supervisor may now insert a key through the escutcheon plate 112 into the supervisor lock (not shown) and unlock the supervisor lock allowing the teller lock 110 to be operated as before. However if the supervisor lock is not operated whilst the red light is flashing, then after a predetermined time delay the solenoid will be deactivated and the procedure must be commenced again.

1.1.2 Second Variant of Cabinet

As already explained, the second variant of the cabinet 101b is shorter than it is tall in order to accommodate feed modules arranged on two tiers. As in the first variant, the feed modules are arranged in a frame and this is tethered to the cabinet 1b by means of a lanyard 106 fastened to a rail 105b by means of an eyelet 107. A clasp 108 allows the frame to be detached from the lanyard 106. Centralising rollers 109 are provided in order to centralise the frame within the cabinet 101b. The door 102b is attached to cabinet 101b via three hinges 103b, and a similar locking arrangement as in the first variant is provided with the exception that the locks are mounted on the door 102b rather than cabinet 101b. A recess 104b in the top of cabinet 101b is provided through which notes are delivered to a teller.

1.2 Frame

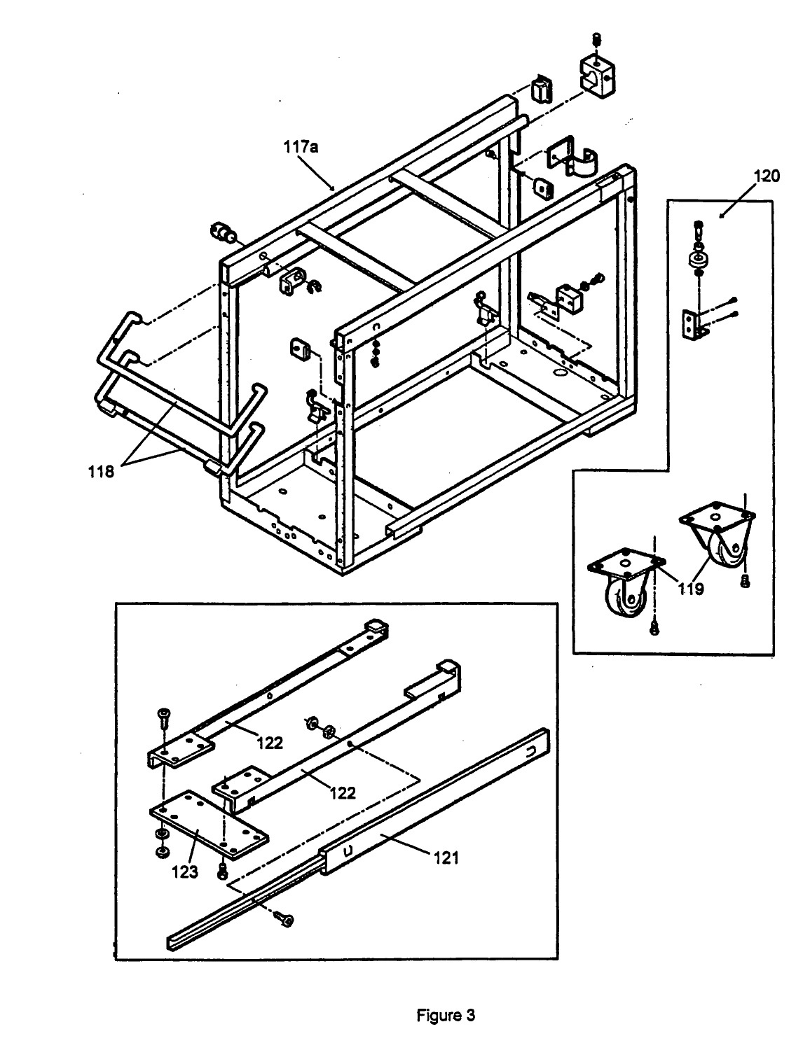

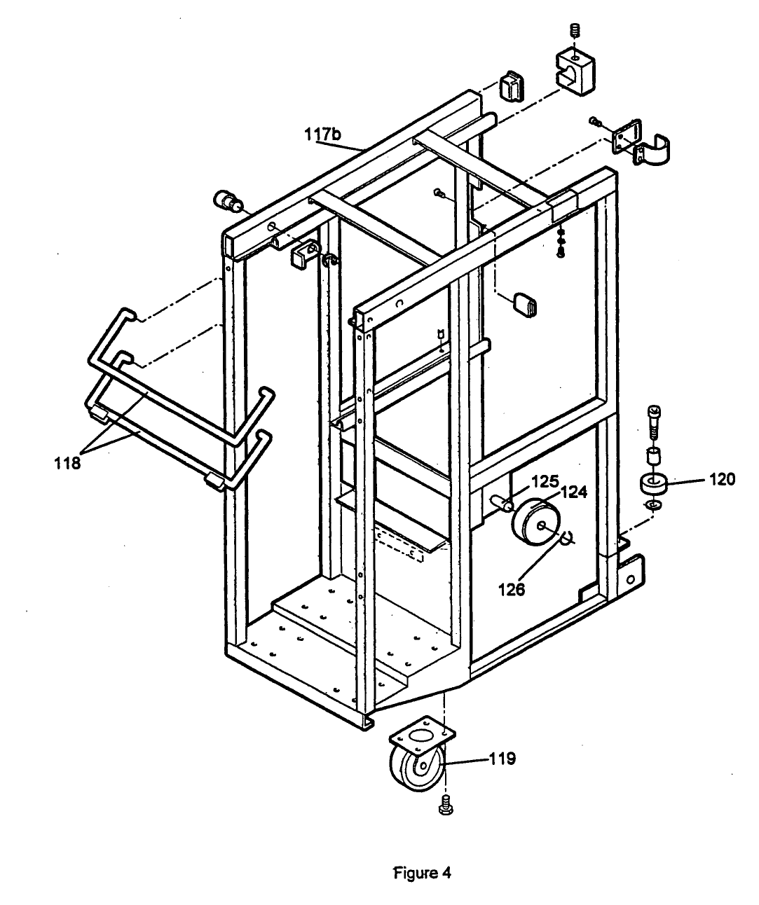

As already discussed, all the functional components of the banknote dispenser are attached to a frame, and different variants of this frame are provided for each of the first and second variant of the cabinet and these are discussed below with reference to the associated FIGS. 3 and 4.

1.2.1 First Variant of Frame

The frame 117a is a simple welded steel construction as shown in FIG. 3. The length of the frame 117a depends on the number of feed modules which it is desired for it to carry, and versions are available for carrying any number between 2 and 6 feed modules.

The frame 117a may be withdrawn from cabinet 101a by means of a pair of handles 118, which normally lie flat against the front of the frame 117a by virtue of gravity but which can be clipped together and used to withdraw the frame 117a from the cabinet 101a.

The frame 117a may be mounted on a set of four castor wheels 119, one of which is provided in each corner of the frame 117a. In this case the frame 117a may be provided with a pair of centralising rollers 120 provided on either side at its rear.

Alternatively, the frame 117a may be mounted on a pair of runners 121, one of which is attached to each side of cabinet 101a. The frame 117a itself is mounted on a pair of brackets 122, each of which is fixed to a respective one of the runners 121. A brace 123 is fixed between the two brackets 122 and helps to prevent lateral motion when the frame 117a is withdrawn from the cabinet 101a.

1.2.2 Second Variant of Frame

The second variant of the frame 117b, shown in FIG. 4, is very similar to the first frame, but obviously its dimensions are different in order to accommodate feed modules arranged on two tiers. Different versions are available capable of housing either 4 or 6 feed modules.

Again, the frame 117b may be withdrawn from cabinet 101b by means of handles 118, which are identical to those described with respect to the first variant. In this variant, the frame 117b is always mounted on wheels. The two front wheels are castor wheels 119, and are identical to those used with the first variant whilst the rear wheels 124 are mounted on stub axles 125 fixed to frame 117b and are retained in place by circlips 126. Again, centralising rollers 120 are provided at the rear of the frame 117b to ensure that it is inserted centrally into cabinet 101b.

2. Feed Module 200

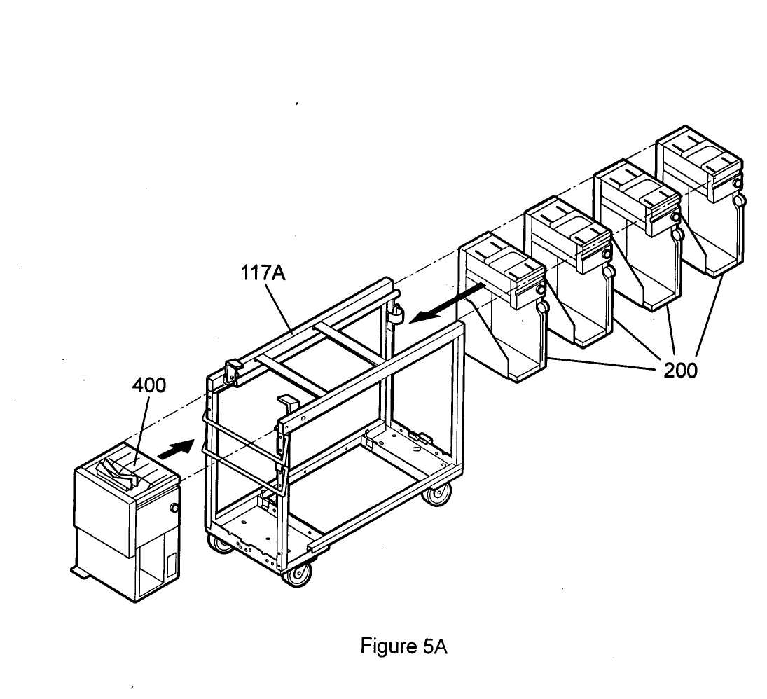

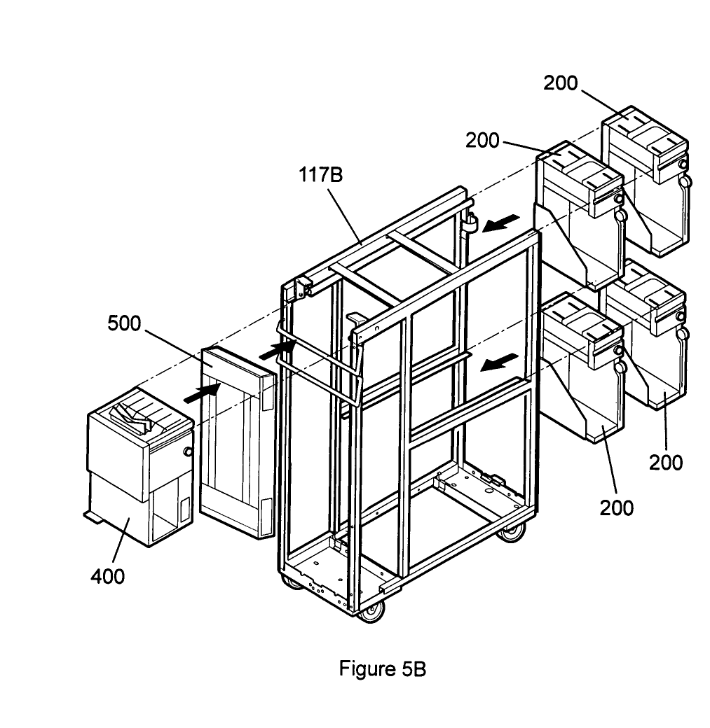

Each teller cash dispenser (TCD) is provided with a plurality of feed modules 200 which fit into the frame alongside the delivery module 400 as shown in FIG. 5A or FIG. 5B. The feed modules 200 may be configured to sit adjacent to one another, all in the same horizontal plane (FIG. 5A), or could alternatively be arranged in two rows, one above the other (FIG. 5B). In the latter case, the TCD will additionally be provided with a vertical transport system 500 which will be described below.

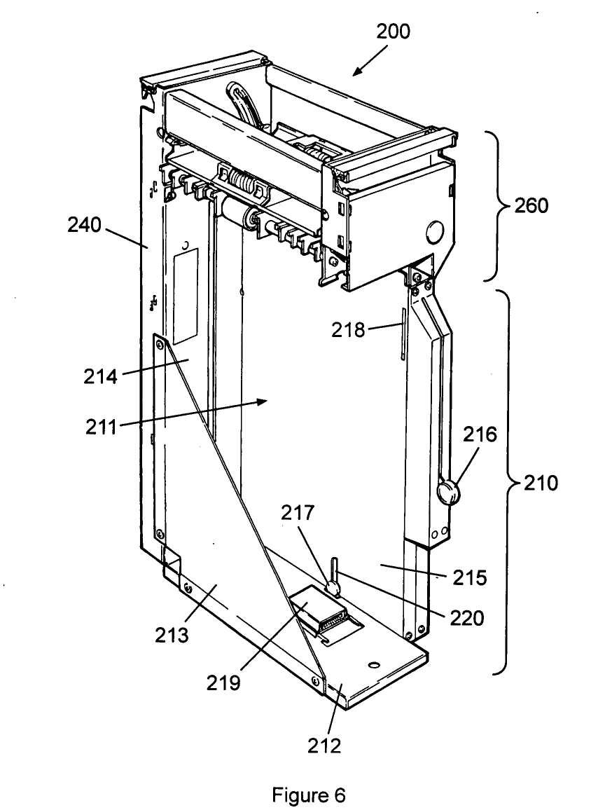

Each feed module 200 carries out a number of different functions. FIG. 6 is a perspective view of a feed module 200 illustrating, in simplified form, the parts associated with each function. The feed module 200 is provided with a cassette bay 210 into which a feed cassette 300 (not shown) may be mounted. A lift mechanism 240 interacts with the feed cassette 300 to move the banknotes contained therewithin upwards. There, transport module 260 removes banknotes from the top of the feed cassette 300 and transports them away from the feed module 200 towards the delivery module 400.

2.1 Cassette Bay 210

The feed module 200 has a base 212, side walls 213 and 215 and a rear wall 214 which together define a cavity 211 which is sized to accommodate a feed cassette 300. In practice, the cavity 211 will be slightly longer than the feed cassette 300 in the direction extending between the base plate 212 and the transport system 260. When the feed cassette 300 is loaded into the cassette bay 210, it rests on base plate 212. The cassette 300 is then lifted into its operational position by pin 217 which is connected to lifting lever 216, mounted in side wall 215. Raising lever 216 towards the transport module 260 moves pin 217 up to the top of slot 220 in the interior face of side wall 215. Side wall 215 is also provided with a second slot 218 into which a tab on the feed cassette 300 fits when the feed cassette is properly inserted into the feed module 200.

The cassette bay 210 is further provided with a PCB connector socket 219 mounted on the base plate 212. The PCB connector socket 219 couples with a PCB connector plug on the feed module 300 which in turn communicates with a printed circuit board (PCB) in the feed module 300. The PCB socket 219 is connected to the TCD control system. The PCB plug is typically connected to the feed cassette 300 via a flexible cable (as will be described in Section 4) but alternatively PCB connector socket 219 could be flexibly connected to the base plate 212. Either way, the connector socket 219 should remain attached to the PCB plug as the feed cassette 300 is lifted into position by pin 217.

2.2 Lift Mechanism 240

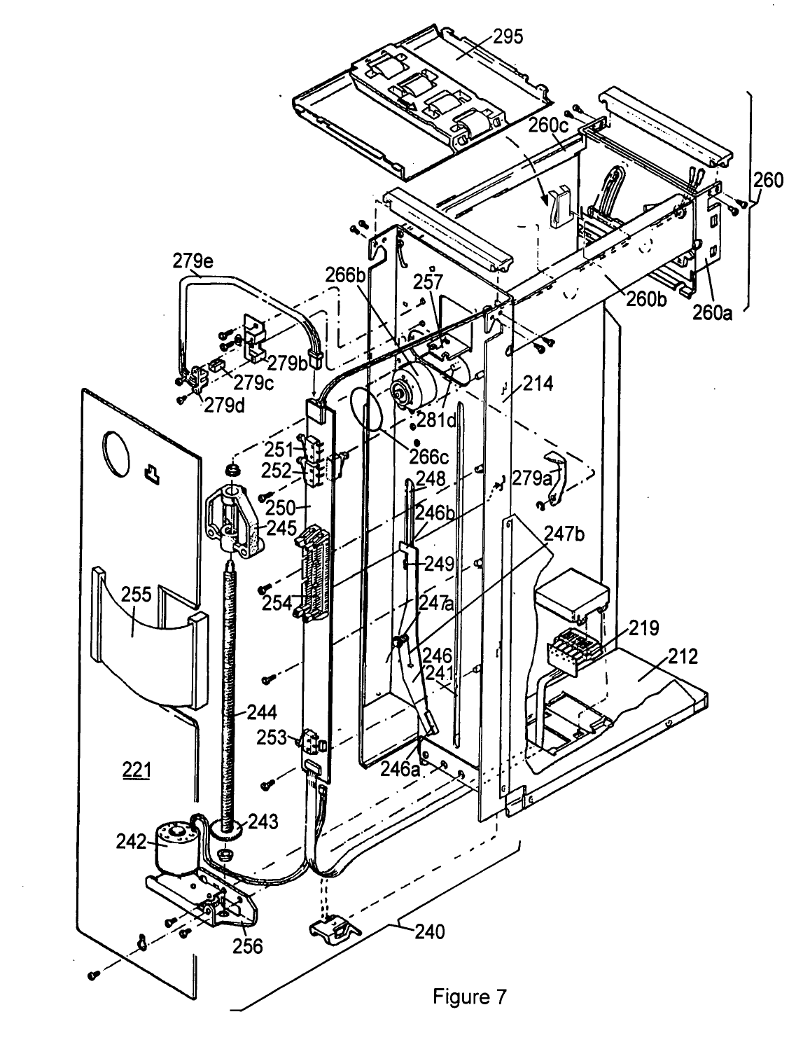

The rear side of the feed module 200 is depicted in exploded form in FIG. 7. The lift mechanism 240 is housed between the rear wall 214 of the cassette bay 210 and a back panel 221. An elongate aperture 241 is provided through back wall 214 and extends in the direction between the base plate 212 and the transport module 260, which will hereinafter be referred to as the vertical direction. A spindle 244 is arranged adjacent and parallel to the elongate aperture 241. The spindle 244 is rotatably mounted between motor casing 256 and bracket 257. A lifter carriage 245 with an internal screw thread is disposed on the spindle 244, which is provided with an external screw thread. The spindle 244 is coupled to a motor 242 via toothed cog 243. Activation of the motor causes the spindle 244 to rotate about its vertical axis and as a result lifter carriage 245 moves up or down the spindle 244, depending on the spindle's direction of rotation, under the action of the opposing screw threads.

A locking lever 246 is mounted on the lift mechanism side of rear wall 214 via pin 247A. A spring 247B is provided to bias the lever toward an upright position (as shown). When the lifter carriage 245 is at the bottom of spindle 244, it exerts a force on the lower end 246A of locking lever 246, causing the lever 246 to pivot in a clockwise direction about pin 247A. As the lifter carriage 245 moves up the spindle 244, the pressure is released and, under the action of spring 247B, the lever 246 pivots in an anticlockwise direction. A second slot 248 is provided in rear wall 214 through which extends a tab 249 which is connected to lifting lever 216 of the carriage bay 210 (see FIG. 6). When the cassette 300 is properly loaded into the feed module 200, and raised into position, tab 249 moves to the bottom of slot 248, as shown. The anticlockwise pivoting of lever 246 engages tab 249 at the bottom of slot 248, locking the cassette 300 into position. On lifter carriage 245 is disposed a protrusion (not shown) which extends through elongate aperture 241 and engages a feed cassette 300 loaded into the feed module 200. As will be described fully below, the cassette 300 is provided with a complementary groove into which the protrusion extends. The protrusion can engage with a plate inside the cassette 300, on which the banknotes are held. Upward movement of the lifter carriage 245 thus causes the plate inside the carriage to move towards the transport module 260. The banknotes inside the cassette 300 are forced towards the top of the cassette where they may be dispensed by the transport module 260.

Before operation, the lifter carriage 245 is positioned at or near to the bottom of spindle 243. On loading the cassette 300 into the cassette bay 210 and activating the TCD, the motor 242 operates to rotate the spindle 244 in a first direction. The lifter carriage 245 moves up the spindle, allowing lever 246 to lock with tab 249 as described above. The lifter carriage 245 continues to move upward until it contacts the plate bearing the banknotes inside carriage 300. At this point, the extra loading on the motor 242 is detected by a current monitor (not shown) and the motor 242 stops. The lifter carriage 245 remains at this position until it is necessary to dispense notes from that feed module 200. When an instruction to dispense notes is received, the motor 242 activates to rotate the spindle 244 in the first direction for a set period of time, raising the lifter carriage 245 by the required amount to present the required number of banknotes to the transport module 260. The motor then stops until another dispensing instruction is received.

Microswitches 251 and 252 are provided on a PCB 250 to indicate when the feed cassette 300 is running out of banknotes. When lifter carriage 245 has been raised so far as to contact microswitch 252, a signal is sent via the PCB 250 and connectors 254 and 255 to the TCD control system to indicate that the feed cassette 300 is low on banknotes. Similarly, contact between the lifter carriage 245 and microswitch 251 indicates that the cassette 300 is empty.

When the feed module is deactivated, either to change feed cassette 300 or when the TCD is switched off, motor 242 reverses so as to rotate the spindle 244 in a second direction, moving lifter carriage 245 down. Lever 246 is thus disengaged from tab 249, allowing lifting lever 216 to be moved down and the cassette 300 removed from the feed module 200. A further microswitch 253 is disposed near the bottom of TCD 250 so as to signal to the system when the lifter carriage 245 has reached the bottom of the spindle 244.

2.3 Transport Module 260

The transport module 260 is located immediately above the cassette bay 210. This is indicated generally in FIG. 7 where it can be seen that the transport module area is defined by the top portion of the back panel 214, a facing front panel 260A and side spacer bars 260B and 260C. In use, the transport module is covered by a top transport assembly 295, described below.

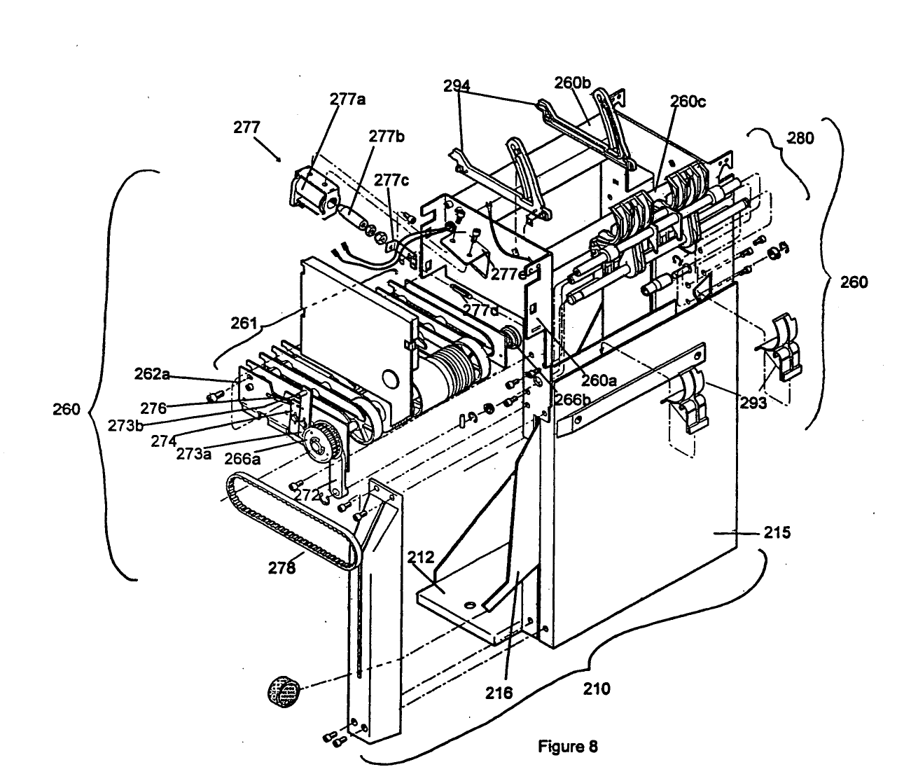

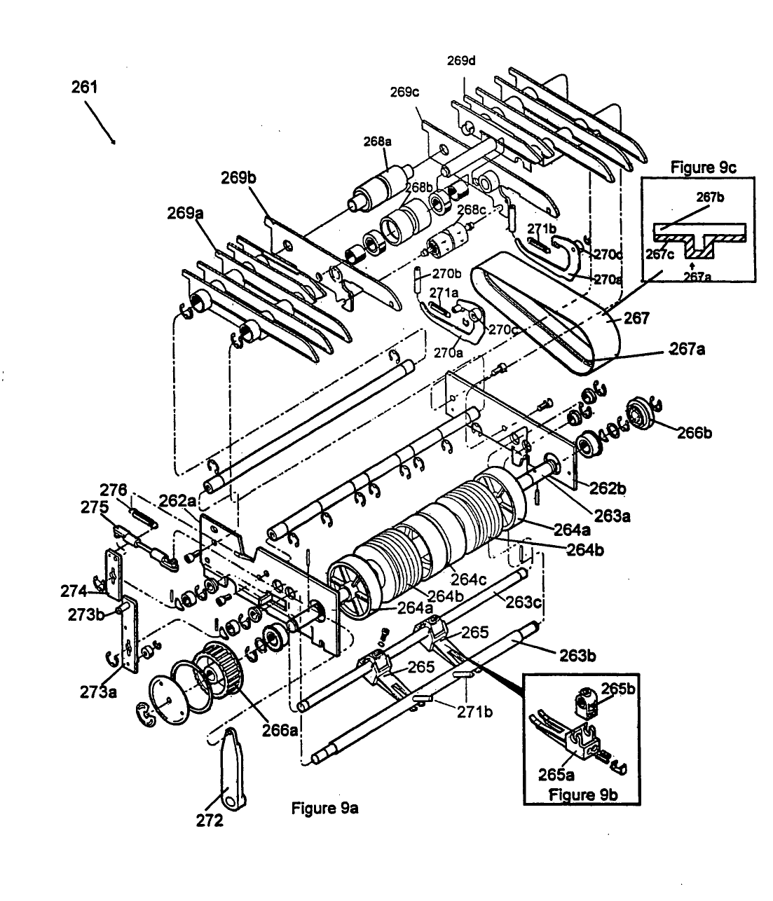

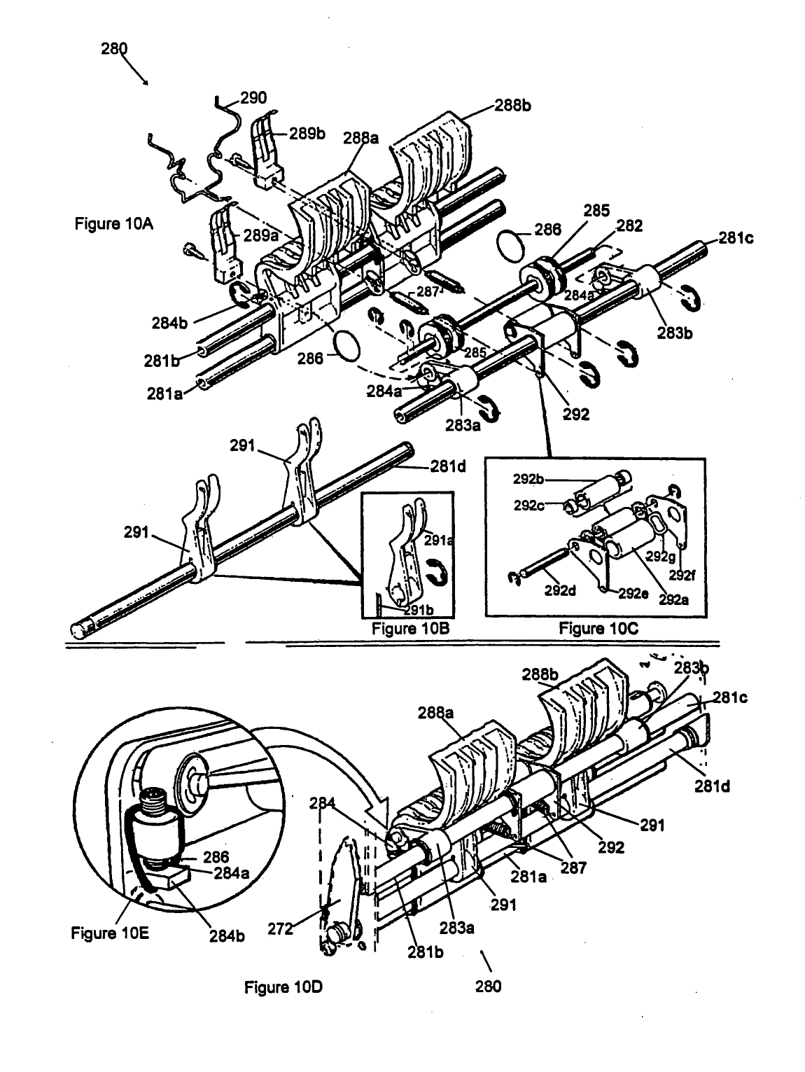

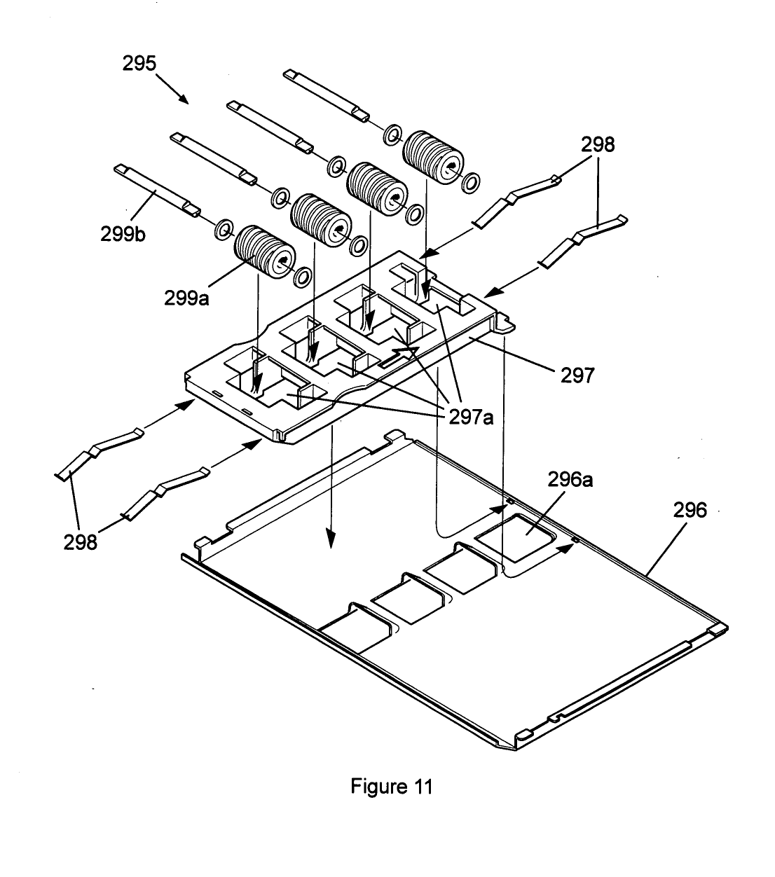

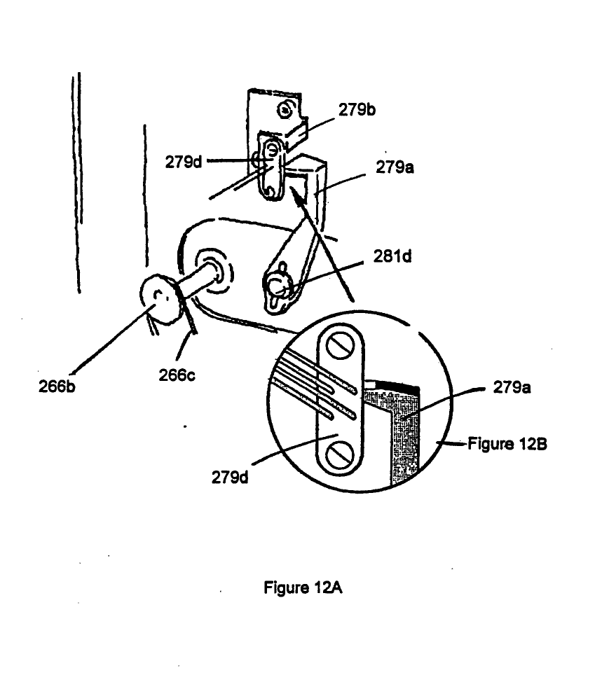

The transport module 260 comprises a number of assemblies which interact with one another. The inner feeder assembly 261 provides the feeding means for removing a banknote from the top of the cassette 300 and moving it towards the stacker and delivery module 400. The inner feeder assembly is shown in detail in exploded form in FIGS. 9A to 9C. The shaft assembly 280 is positioned adjacent to the inner feeder assembly 261 and assists in separating and guiding the banknotes. The shaft assembly 280 is shown in exploded form in FIGS. 10A to 10E. A solenoid assembly 277 is provided which controls the inner feeder assembly 261 and shaft assembly 280 so that notes are fed at the appropriate times. Solenoid assembly 277 may most clearly be seen in FIG. 8. Top transport assembly 295 completes the transport module and helps to guide the banknotes towards the stacker and delivery module 400. The top transport assembly 295 is shown in exploded form in FIG. 11.

2.3.1 Inner Feeder Assembly 261

The inner feeder assembly 261 essentially comprises a rubber transport belt 267, which extends around a series of rollers 264 and 268, and a series of guides. The rollers 264 are connected to a driver motor which causes them to rotate and drive the transport belt 267. When the transport belt 267 comes into contact with the uppermost banknote in the feed cassette 300, friction between the belt 267 and the banknote removes the banknote from the feed cassette 300 and, in conjunction with the rollers and guides, moves it along a U-shaped path (so that it is on top of the inner feeder assembly) and then transports the banknote towards the stacker and delivery module 400.

A series of axles 263A to 263E extend between two parallel end plates 262A and 262B. Rollers 264A to C are disposed on axle 263A which is located towards one end of the end plates 262A and 262B. The axle 262A is fixed to a drive pulley 266A at its front end and to pulley 266B at its rear end. Drive pulley 266A is connected to a remote motor by means of timing belt 278 (see FIG. 8). The motor acts to rotate the drive-pulley 266A, along with the shaft 263A and rollers 264A to C, in an anti-clockwise direction about the axis of shaft 263A (when viewed from the drive pulley 266A end).

The central roller 264C contacts the interior of the belt 267 and imparts motion to the belt 267 as it rotates. The belt 267 is formed from two layers of rubber having a cross-section as shown in FIG. 9C. The outermost layer 267B is T-shaped in cross-section. The inner layer 267C is provided with a U-shape protrusion such that the two layers couple together as shown. The resulting ridge 267A extends around the interior of belt 267 and, in use, engages a groove in central roller 264C. The belt 267 is held taut by roller 268A at its other end, which is also provided with a groove to accommodate ridge 267A.

A feed roller 264B is provided on either side of the central drive roller 264C. Each feed roller 264B consists of a series of annular disks, spaced from one another at their peripheries but sharing a common core. In use, the feed rollers 264B contact the banknote directly and assist the belt 267 in feeding the banknote around the U-shaped path. Additional rollers 264A are provided on the outer side of each feed roller 264B to guide larger banknotes.

Axle 263E extends between end plates 262A and 262B adjacent to the end of the end plate furthest from drive shaft 263A. Shaft 263D extends between the two end plates 262A and 262B approximately halfway between shafts 263A and 263E. Together, shafts 263D and 263E support a series of guide fingers 269A to D. The guide fingers 269A to D have flat top surfaces with curved ends adjacent to the drive roller assembly 264. The top edges of guide fingers 269 align with the top portion of belt 267 so as to provide support to the banknote across its whole length as it is transported towards the stacker and delivery module 400. The assembled configuration of guide fingers 269, drive rollers 264 and belt 267 may be seen more clearly in FIG. 8.

The shafts 263D and 263E also support rollers 268A and 268B between guide fingers 269B and 269C. These rollers 268A and 268B act to tension the belt 267 and support it so as to present a flat surface to the passing banknote. A further roller 268C, of eccentric diameter, is supported between guide fingers 269B and 269C. This eccentric roller 268C can be positioned to move the belt 267 towards the banknote when feeding.

As previously described, the teller cash dispenser (TCD) comprises a number of feed modules 200 disposed adjacent to one another. The drive pulley 266A on each feed module 200 is coupled to the drive pulley 266A on the next feed module 200 by timing belt 278. The drive pulley 266A on the endmost feed module 200 (situated adjacent to the stacker and delivery module 400) is driven by a motor. During a banknote dispensing operation, the motor operates to drive all the drive pulleys 266A simultaneously. The motor continues to run until all the required banknotes have been transported to the stacker and delivery module 400. In order that the correct number and denominations of banknotes are dispensed, a series of components are provided which prevent the uppermost banknote in each feed cassette 300 from contacting the transport belt 267 or feed rollers 264B until an instruction to dispense that banknote is received.

Firstly, spacer fingers 270A are provided to prevent the uppermost banknote from contacting the transport belt 267. One spacer finger 270A is disposed on either side of the transport belt 267, and is pivotably mounted on guide fingers 269B and 269C respectively. Each spacer finger 270A has a substantially flat lower edge with an upwardly curved portion at one end which may be covered by a rubber sleeve 270B to prevent the spacer finger 270A from damaging the banknotes and to protect the spacer finger 270A from wear. At its other end, the spacer finger 270A has a U-shaped portion at the top of which is a pivot point 270C, used to mount the spacer finger 270A to the guide fingers 269B or 269C.

A spacer shaft 263B extends between the end plates 262A and 262B and is provided with two spring pins 271B. A spring 271A extends between a protrusion 270D on the spacer finger 270A and the spring pin 271B on spacer shaft 263B. In its default position, the spring 271A acts to urge the spacer finger 270A against the uppermost banknote in the feed cassette 300, which is thus spaced from the transport belt 267.

Stop fingers 265 act to separate the uppermost banknote in the feed cassette 300 from feed rollers 264B. Two stop fingers 265 are disposed on the stopper shaft 263C which extends between end plates 262A and 262B adjacent to the spacer shaft 263B. Each stopper finger 265 comprises a body 265A equipped with a fork-like protrusion and a mount 265B which couples the fork to the stopper shaft 263C. Each stopper finger 265 aligns with one of the feed rollers 264B in such a way that the forked protrusion of stopper finger 265 interdigitates with the annular disks of the feed roller 264B. The stopper fingers 265 are fixed to the stopper shaft 263 in such a way that they rotate with the shaft. The stopper shaft 263C is disposed such that the default position of the stopper fingers acts to space the uppermost banknote from the feed rollers 264B.

By rotating each of the spacer shaft 263B and the stopper shaft 263C, the spacer fingers 270A and the stopper fingers 265 can be moved so as to allow the uppermost banknotes to contact the transport belt 267. Rotation of the spacer shaft 263B and stopper shaft 263C is controlled by the solenoid assembly 277 which in turn is operated by the TCD control system (see section 8). As shown in FIG. 8, the solenoid assembly 277 comprises an electromagnet 277A, a plunger 277B, a solenoid arm 277C and a spring 277D. The electromagnet 277A is mounted on front panel 260A by means of a tab 277E. Plunger 277B is made of a suitable ferromagnetic material and is fixed at its end furthest from the electromagnet 277A to the solenoid arm 277C. The spring 277D connects the solenoid arm 277C to the side of front panel 260A and acts to pull the solenoid arm 277C and plunger 277B away from the electromagnet 277A. The solenoid arm 277C connects to a pin 273B disposed at the top end of a spacer panel 273A. As shown in FIGS. 8 and 9A, the spacer panel 273A is fixed to the end of spacer shaft 263B. The two components are prevented from rotating relative to one another by means of a pin extending through the shaft 263B and the spacer-panel 273A.

Similarly, a stopper panel 274 is fixed to the end of stopper shaft 263C. The spacer panel 273A and the stopper panel 274 are sized and positioned so as to sit adjacent to one another in such a way that any movement imparted to the spacer panel 273A by the solenoid arm 277C is also imparted to stopper panel 274. A spring 276 extends between the stopper panel 274 and a tab provided on end plate 262A. A second tab on the same end plate is positioned adjacent to the base of stopper panel 274.

When the feed module 300 receives instructions to dispense a banknote from the feed cassette 300, the electromagnet 277A is activated. As a result, the ferromagnetic plunger 277B is attracted into the electromagnet cavity, pulling the solenoid arm 277C with it. This causes the spacer panel 273A and the stopper panel 274 to pivot anticlockwise, assisted by the action of spring 276.

The spacer shaft 263B and stopper shaft 263C are thus rotated a small amount anticlockwise. The spring pins 271B and stopper fingers 265 are disposed such that synchronous rotation of their respective shafts 263B and 263C causes first the spacer fingers 270A to lift up, followed by the stopper fingers 265. Raising the spacer fingers 270A allows the uppermost banknote to contact transport belt 267. Rotation of the stopper fingers 265 causes the forked protrusions to interleave with the annular disks, thus allowing contact between the banknote and the drive roller 264B. The banknote is fed out of the feed cassette 300 towards the feed rollers 264B. The banknote follows a U-shaped path around the rollers guided by shaft assembly 280, shown in FIGS. 10A to 10D.

2.3.2 Shaft Assembly 280

Guides 288A and 288B complement the feed rollers 264B and are supported by two shafts 281A and 281B which extend between front and back panels of the feed module 200. Each guide 288A and 288B consists of a panel of ridges which is curved so as to accommodate the feed roller 264B. Although not visible in the drawings, the ridges are separated by apertures in the panel whose functions will be explained below. Two guards 289A and 289B are disposed in front of the base of guides 288A and 288B. The guards 289A and 289B prevent additional notes contacting the counter rollers 285 (described below). Only the uppermost note (that in the picking position) should be in contact with the counter rollers 285.

Two further shafts 281C and 281D extend between the front and back panels of the feed module 200. Shaft 281C supports a belt counter roller assembly 292 as well as two holders 283A and 283B. The belt counter roller assembly 292 comprises a roller 292B attached by means of bearings 292C and axle 292D to two brackets 292E and F. The brackets 292E and F are separated by spacer tube 292A. The roller 292B extends between the guides 288A and 288B so as to oppose the transport belt 267 and assist in carrying the banknote through the guides 288A and 288B.

A note pusher 290, comprising a shaped length of wire, is connected to the brackets 292E and 292F via springs 287. The note pusher 290 pushes undispersed banknotes into the feed cassette 300 when the cassette is lowered using lever 216 (see FIG. 8 and section 2.1).

Bushings 283A and 283B are disposed on the outer side of each of guides 288A and 288B. Between them, the bushings 283A and 283B support shaft 282 on which are disposed counter rollers 285. When assembled, the counter rollers extend through apertures in guides 288A and 288B and are driven through a gearbox to counter rotate, ensuring separation of the banknotes. The holders 283A and 283B are each provided with set screws 284A. In use, these are coupled to tabs 284B provided on the guides 288A and 288B by O-rings 286 as shown in FIG. 10E. The O-rings act as spring elements to keep the counter rollers 285 in their adjusted positions against the set-screws 284A.

Two counter fingers 291 are disposed on counter shaft 281D. Each counter finger 291 comprises a curved, forked member 291A which is fixed to the shaft 281D via pin 291B so that the two components cannot move relative to one another. As shown in FIG. 10D, when assembled, the forked member 291A protrudes into apertures provided in guides 288A and 288B, inbetween the ridges.

At its front end, the counter shaft 281D is connected to a counter panel 272, shown in FIGS. 8 and 9A. The counter panel 272 is rigidly fixed to counter shaft 281D and connects to the stopper panel 274 via rigging screw 275. Thus movement of the solenoid arm 277C is also transmitted to the counter shaft 281D. When the electromagnet 277A is activated for a banknote dispensing operation, the counter panel 272 pivots in the same direction as the spacer and stopper panels 273A and 274, turning the counter shaft 281D a small amount anticlockwise. The counter fingers 291 extend through apertures in the guides 288A and 288B, into the path of the banknote.

The force exerted on the counter fingers 291 by a passing banknote is sufficient to push the counter fingers 291 back towards the guides 288A and 288B against the action of the solenoid assembly 277. This in turn rotates the counter shaft 281D clockwise, which acts on the spacer and stopper panels 273A and 274 (via the counter panel 272) to move the spacer fingers 270A and stop fingers 265 back towards their original positions. This helps to prevent the next banknote from exiting the feed cassette 300.

The primary use of counter fingers 291 is however to detect the passage of a note through the shaft assembly. A flag 279A is provided on the rear end of counter shaft 281D (opposite to that attached to the counter panel 272). An optical sensor 279D is mounted to the back panel 214 of the feed module 200 by means of a bracket 279B. A cover 279C may be provided to protect the sensor from dust. The sensor 279B is electrically connected to PCB 250 via cable 279E. FIGS. 12A and 12B show the sensor and flag in their assembled configuration. As the banknote passes the counter fingers 291, pushing the counter shaft 281 in a clockwise direction with respect to FIG. 10 (anticlockwise in FIG. 12A), the flag 279A moves into the optical path of sensor 279B, blocking the transmission of a lightbeam between the sensor parts. The sensor 279B can therefore detect the passage of each note through the shaft assembly. The sensor 279B and flag 279A could also be used in conjunction with a timing circuit to monitor the width of the banknote as it passes, thereby providing early detection of multiple, overlapping banknotes or incorrect denominations.

The drive rollers 264 and shaft assembly 280 guide the banknotes around a U-shape path so that it emerges on top of the guide fingers 269A to D. The transport belt 267 carries the banknote away from the drive rollers towards the next feed module 200 or the stacker and delivery module 400. The banknote travels between the guide fingers 269B and the transport belt 267 on its lower side and the top transport assembly 295 above it.

2.3.3 Top Transport Assembly

The top transport assembly 295 is shown in exploded form in FIG. 11. A guide plate 296 having four apertures 296A forms the “lid” of the transport module 260. A roller cage 297 is mounted on the guide plate 296. The roller cage has four apertures 297A which correspond to the apertures 296A in guide plates 296. A roller 299A is mounted in each of the apertures 297A by means of axles 299B. The rollers 299A are spring-mounted by means of leaf springs 298. Each roller 299A is provided with a series of grooves which act to keep the banknote travelling in a straight path.

The top transport assembly slides into position above the transport belt and guide fingers by means of guides 294 which are positioned on the front and back panels 260A and 214 of the feed module 200.

3 Feed Cassette

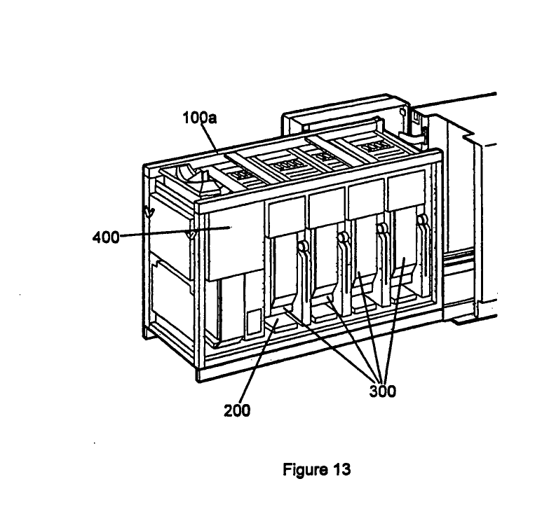

In use, each feed module 200 is fitted with a feed cassette 300 as shown in FIG. 13. The feed cassette 300 contains a stack of banknotes, preferably all of the same denomination, ready to be dispensed by the TCD. Typically, each feed cassette 300 in a TCD would hold a different denomination of banknote, but this would depend on the currency in use and on the user's preferences.

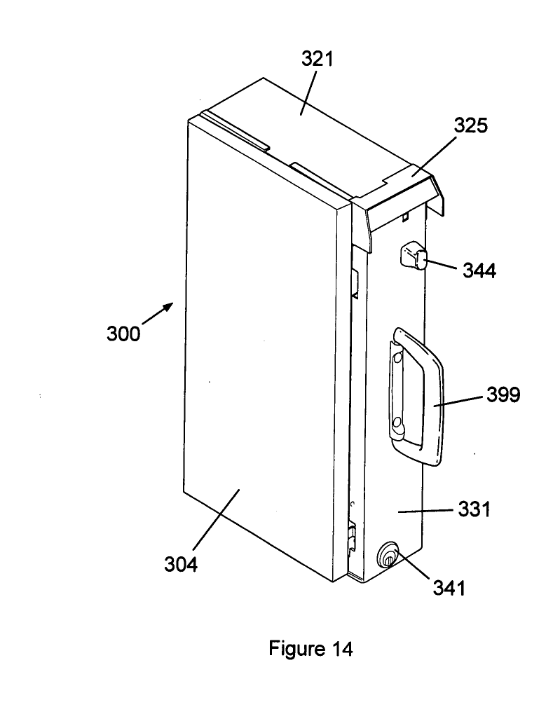

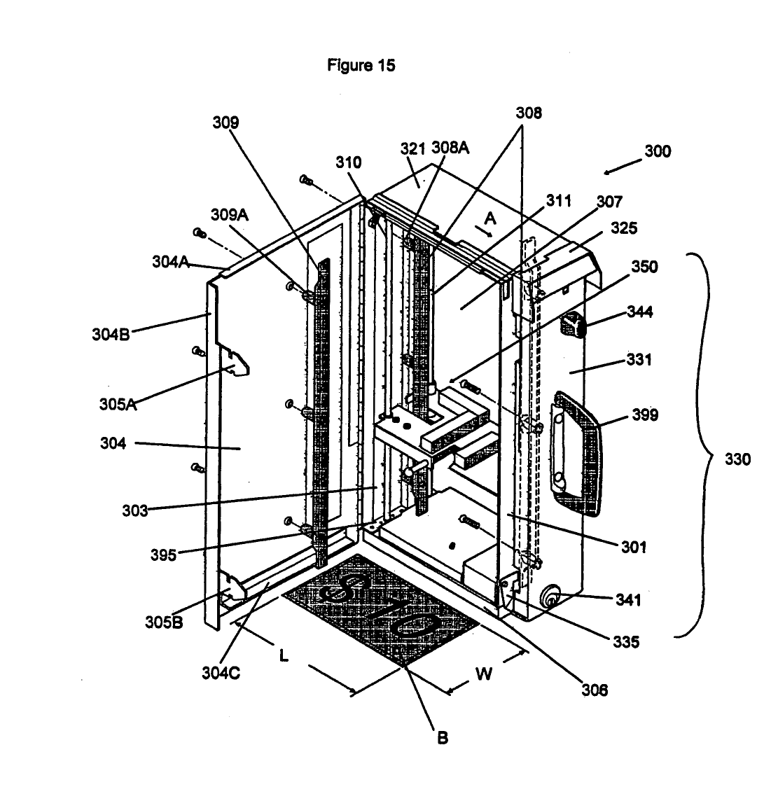

An example of a feed cassette 300 is shown in FIG. 14. This external view shows that the feed cassette 300 essentially comprises a case having a door 304, which can be opened so as to load the cassette with banknotes, and a lid 321 which, in use, is open and through which banknotes may be dispensed by the TCD. A handle 399 is disposed on front panel 331 for ease of handling. As will be described below, slide 344 is operable to release a series of latches which allow the door 304 and lid 321 to be opened. The feed cassette 300 may optionally be provided with one or more locks 341, detailed below.

The interior of the feed cassette 300 is shown in FIG. 15, in which door 304 is open and lid 321 is shut, ready for banknotes B to be loaded into the cassette 300. The container is defined by a front wall 301, rear wall 303, a side wall 307 and door 304, together with base 306 and lid 321. In use, a stack of banknotes B sits on a pusher plate assembly 350. The pusher plate assembly 350 (detailed below) is slidably engaged with pusher shafts 310 and 311 which extend inside the feed cassette 300 between the base 306 and the lid 321. The pusher plate assembly 350 is raised towards lid 321 by the action of lifter carriage 245 in the feed module 200 (section 2.2, see FIG. 7).

The positioning of banknotes B in the feed cassette 300 is maintained by means of guides 308 and 309. Each guide 308 and 309 comprises an elongate beam having a planar guiding surface facing the banknote, supported by a number of stems 308A and 309A. The stems 308A and 309A act as fixing points as well as spacers. The two length guides 308 are provided on the inside of front wall 301 and back wall 303. In order to guide the banknote B accurately, the distance between the two length guides 308 ought to correspond to the length L of the banknote B. Preferably, the guides 308 should also locate the banknote B centrally between the front wall 301 and back wall 303 in the feed cassette 300. Typically, this is achieved by providing a number of different sets of length guides 308 with each feed cassette 300, which vary in the size of their stems 308A. Thus the spacing of the guiding surface from the interior wall can be selected as appropriate for the size of banknote. Similarly, a width guide 309 is disposed on the interior of door 304 and in use acts to retain the banknotes B against side wall 307 of the feed cassettes 300. Again, the size of stems 309A is selected as appropriate for the width W of banknote B.

Door 304 is hinged along its rear edge to back wall 303. The door 304 is provided with flanges 304A, B and C, at its top, front and base edges respectively which, when the door 304 is closed, fit with the other sides of the feed cassette 300 so as to securely close the cassette. The door 304 is further provided with locking tabs 305A and 305B which co-operate with latches in the front locking assembly 330 (to be described below).

3.1 Cassette Lid Assembly 320

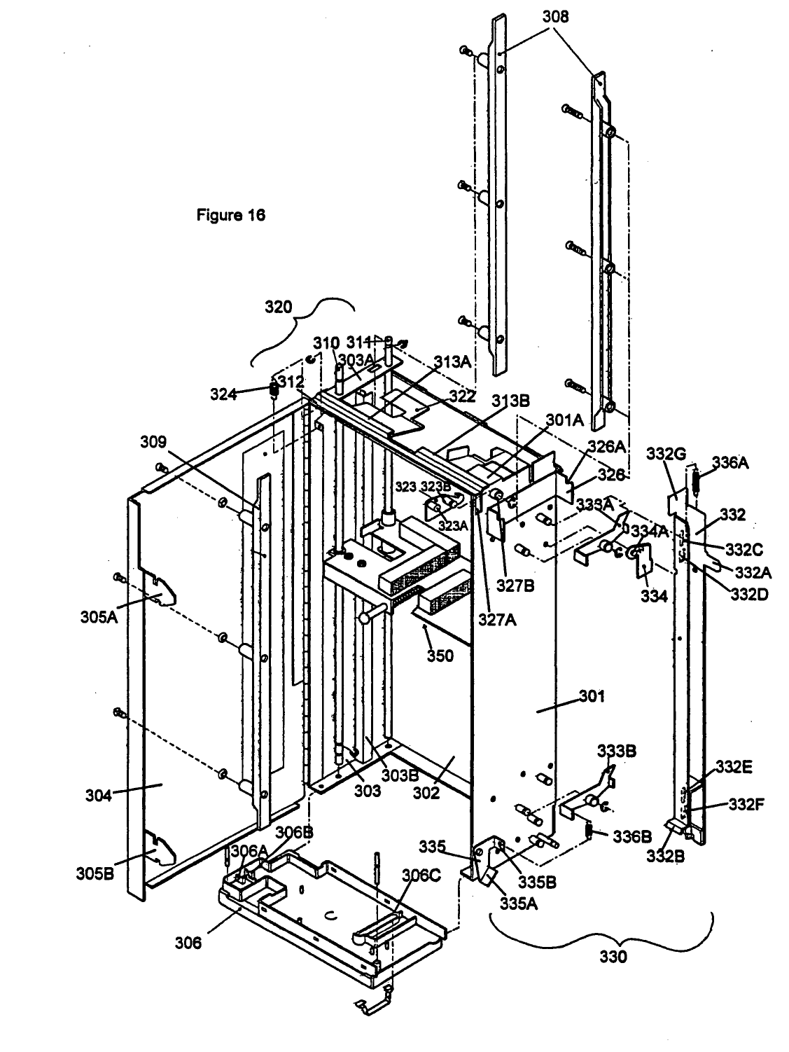

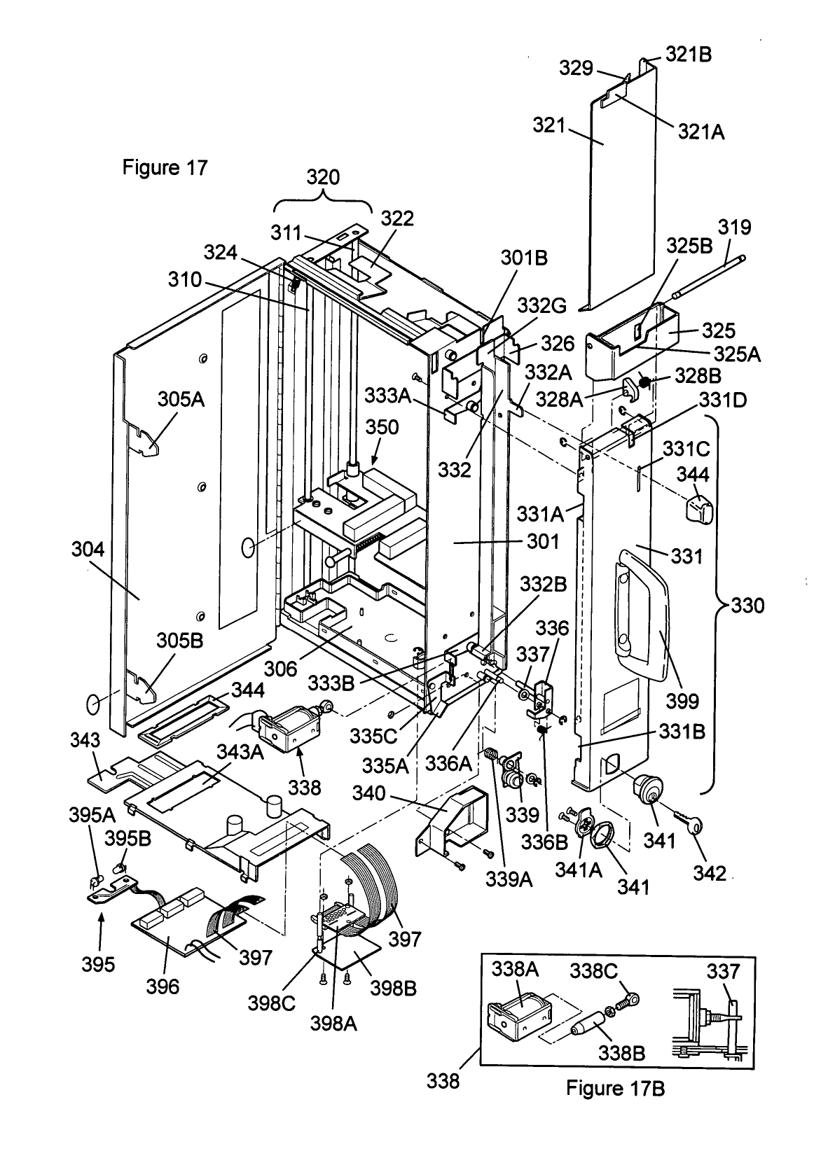

The lid 321 is a panel having a flat top with a flange 321B running along one side and a tab 321C at the front (see FIG. 17). The lid 321 slidably couples with the top of the feed cassette 300 by means of beam 312 (see FIG. 16), which is welded to tabs 301A and 303A at the top end of the front wall 301 and back wall 303 respectively. Beam 312 is provided with guides 313A and 313B which, together with beam 312, define a slot into which the edge of lid 321 fits. Similarly, although not visible in the figures, a guide slot is provided on the outside of side wall 307 into which the edge of flange 321B fits.

Hinge support 326 is disposed near the top of front wall 301 on its exterior surface. Two mounting points are provided, which, in combination with front panel 331, allow for pivotable mounting of a corner guide 325 via an axle 319. The corner guide 325 is shaped so as to allow the lid 321 to slide through it in its lengthwise direction. The corner guide 325 can pivot about its mounting from a horizontal position (shown in FIG. 15) to a vertical position (shown in FIG. 17).

To open the lid 321, the user slides the lid 321 in direction A (FIG. 15) using tab 321C as a handle. A protrusion 321A provided on the top surface of lid 321 fits into a corresponding cut-out 325A on corner guide 325 so as to prevent the lid 321 from being fully removed. Once the lid 321 has been slid so far as to be free of guides 313A and 313B, the corner guide 325 and lid 321 are free to pivot about axle 319 together. The two components are rotated through 90 degrees from the horizontal position to the vertical. Thus the lid 321 can be swung down and, in this open position, covers a portion (typically the majority) of front panel 331.

Also pivotably mounted on axle 319 is cam lever 328A and spring 328B. The cam lever 328A extends through slot 331D at the top of front panel 331 and through slot 325B in the base of corner hinge 325. When the lid 321 is slid out, the cam lever 328A contacts rib 329 provided along part of the length of the interior surface of lid 321. The cam lever 328A, being spring loaded, helps to ensure the lid and corner hinge pivot smoothly during the opening operation and also assists in locking the feed module 300 as will be described below.

The lid 321 opens to reveal plate 322 which, in use, holds down the stack of banknotes B. The plate 322 is provided with a series of cutouts which fit with the guides 308 and 309 and allow the uppermost banknote to contact the transport belt 326 in the feed module 200 (see section 2.3.1). The plate 322 is pivotably mounted to the top of front and back walls 301 and 303 at the sides nearest the door 304. A spring 324 is provided between a tab on the inside of back wall 303 and the plate 322 which urges the plate 322 down so as to exert a pressure on the stack of banknotes. A lift arm 323 is pivotably mounted to point 327B on front wall 301 and contacts the underside of plate 322. A pin 323A on lift arm 323 extends through slot 327A in front wall 301 and co-operates with a feature on the interior of feed module 200 so as to push the plate 322 up when the feed cassette 300 is lifted into the dispensing position.

3.2 Front Locking Assembly 330

The front locking assembly 330 is contained between the front wall 301 and front panel 331. The front panel 331 is provided with two slots 331A and 331B through which locking tabs 305A and 305B on door 304 fit respectively. A corresponding latch 333A,333B is provided adjacent to each of the slots 331A and 331B. Each latch 333A and 333B is pivotally mounted to the exterior side of wall 301 by means of a pin. At its end nearest door 304, each latch has a tab which extends in the direction of front panel 331 so that (in the locked position) each of the slots 331A and 331B is partially obscured. At its other end, each latch 331 and 331B has a second tab which extends through a hole 332D or 352F in a latch actuator 332. The latch actuator 332 is an elongate member having a series of apertures and tabs, one of which, 332A, extends through slot 331C in front panel 331 so as to be accessible by a user. A slide cover 344 is affixed to tab 332A for ease of handling. The latch actuator 332 is slidably mounted on the exterior of front wall 301 by means of pins which extend through elongate apertures 332C and 332E on the actuator 332. A spring 337 is provided between one of the pins and the actuator so as to urge the actuator upward. In this default position, the latches 333A and 333B partially cover slots 331A and 331B in front panel 331, preventing tabs 305A and 305B from exiting the slots and thus holding the door 304 shut.

When the latch actuator 332 is slid down by a user, the latches 333A and 333B pivot, moving the tabs upward and releasing the door 304.

Corner latch 335 is provided to further secure the door 304. The corner latch 335 is provided with a tab 335A which is accessible by the user and a second tab 335B which, in the locked position, obscures a further portion of slot 331B. The lower latch 335 is again pivotably mounted to the exterior of front wall 301. A spring 336 is provided between tab 335B and latch 333B so as to urge the two towards one another, thereby preventing the exit of tab 335B and the opening of door 304. To release the door, the user must simultaneously slide the latch actuator 332 downwards by means of slide 344 and open corner tab 335B by exerting a force (towards door 304) on latch 335.

The latch actuator 332 also stops lid 321 from opening. At the top of actuator 332 is a protrusion 332G which extends towards the top surface of lid 321. The rib 329 which extends partially along the inner surface of lid 321 fits through slot 301B at the top of front wall 301 but cannot proceed past protrusion 332G when the actuator 332 is in its raised position. Similarly, cam lever 328A rests against the top of actuator 332 and cannot rotate when the actuator is raised. Thus, in order to open lid 321, slide 344 must be depressed by the user. Once the lid is open, the cam lever 328A causes the actuator to remain in its lower position. Cassette bolt 334 is provided to lock the cassette 300 into the feed module 200. The bolt 334 is pivotably mounted to the exterior of front wall 301 and is provided with a protrusion 334A which couples with the actuator 332. When the actuator 332 is lowered, the bolt 334 protrudes through a slot (not shown) in the side of front panel 331 and into slot 218 on feed module 200 (section 2.1). It is therefore not possible to remove the feed cassette 300 from the feed module 200 when the lid 321 is open.

3.3 Cassette Base Assembly 306

The base 306 completes the cassette enclosure and comprises a panel with raised edges to accommodate a PCB 396 and cover 343 (FIG. 17). The PCB may be programmed by the user so as to contain information such as the dimensions of the banknotes B loaded into the cassette and their denomination. Further details of the PCB may be found in section 8 below. The PCB 396 communicates with the TCD control system via cable 397 which passes through aperture 306C, and PCB connector plug 398A, mounted on connector guide 398B. The connector guide 398B is fixed to the underside of base 306 by slidable rods 398C. Thus when the PCB connector plug 398A is coupled to socket 219 on the base of the feed module 200, and the feed cassette 300 is lifted into position, the flexible connection allows the PCB to remain connected throughout. The cover 343 is provided with an aperture 343A for access to the PCB, sealed in use by lid 344. Protrusions 343B are provided to accommodate the slidable rods 398C.

The base 306 may also be provided with mounting points 306A and 306B for supporting an optical sensor assembly 395 (FIG. 17). This comprises an infrared LED 395A and receiver 395B, disposed either side of pusher shaft 310. Movement of shaft 310 disrupts the lightpath and so can be detected by the sensor assembly.

3.4 Pusher Plate Assembly 350

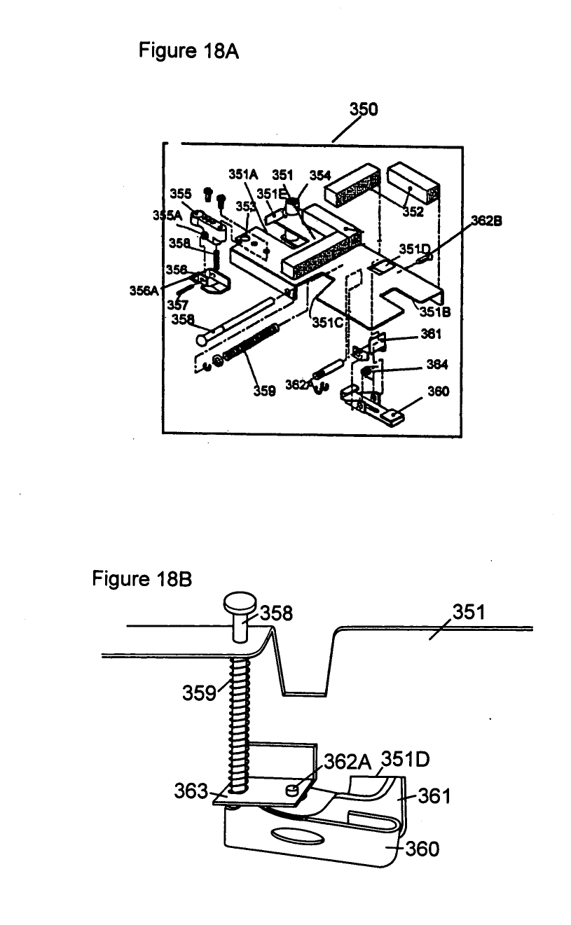

The pusher plate assembly 350 is disposed inside the feed cassette 300 and in use supports the stack of banknotes to be dispensed, urging them against plate 322. The pusher plate assembly is shown in exploded form in FIG. 18A and a detail of the assembled arrangement is shown in FIG. 18B. Pusher plate 351 is a substantially planar member having a series of cutouts 351A to 351C to accommodate guides 308 and 309. The pusher plate 351 has an aperture 353 and tubular portion 354 for receiving the first and second pusher shafts, 310 and 311 respectively (see FIG. 17). The pusher shafts 310 and 311 are both moveably mounted in the feed cassette 300 in such a way that they can slide along their axial direction (upwards) by a small amount. Apertures are provided in tab 303A at the top of rear wall 303 to allow the pusher shafts to slide. A mount 355 is attached to the underside of pusher plate 351 and is provided with an aperture which aligns with aperture 353 so as to allow pusher shaft 310 to pass therethrough. A catch 356 is pivotably mounted to mount 355 at point 355A via pin 356A. Catch 356 is also provided with an aperture to accommodate pusher shaft 310. A compression spring 358 extends between the mount 355 and the catch 356 in such a way as to angle the catch 356 so that it exerts a pressure on pusher shaft 310. The friction between pusher shaft 310 and catch 356 is sufficient to prevent the pusher plate 351 sliding downwards. When the feed cassette 300 needs to be refilled with banknotes B, the user can release the catch by applying a force to catch 356, compressing the spring 358 and releasing the pressure on the shaft 310. The pusher plate can then be lowered so as to receive a new stack of banknotes B.

In order to dispense banknotes correctly, once a new stack has been placed on the pusher plate 351, the plate must be raised to such a position that a moderate pressure is applied to the stack of banknotes. A number of components are provided to achieve this. Firstly, a series of rubber pads 352 are arranged on top of pusher plate 351 which help to hold the banknotes in position and accommodate any curvature or other discrepancies. A door interlock rod 359 is also provided which, when too much or too little pressure is applied to the stack of banknotes, will prevent door 304 from closing.

FIG. 18B shows an underneath view of pusher plate 351. Interlock rod 358 passes through an aperture in a side flange of pusher plate 351 and extends through a corresponding aperture in tab 363, provided on the underside of the pusher plate 351. A compression spring 359 is provided along the length of interlock rod 358 between these two points. Tab 363 also supports a pin 362A which together with pin 362B (FIG. 18A) pivotably mounts an interlock 360 and a note sensor 361. These two components are urged apart by spring 364. Interlock 360 is provided with a U-shaped feature at its end nearest the interlock rod 358 into which the end of interlock rod 358 can fit. However, when the components are not so aligned, interlock 360 obstructs the passage of interlock rod 358, causing it to extend beyond the width of the feed cassette 300. It is therefore not possible to shut door 304 unless interlock 360 is positioned such that interlock rod 358 can align with the U-shaped portion.

The feed cassette 300 is designed to be held at an angle whilst it is being reloaded with banknotes. Specifically, the base 306 should be raised higher than the lid 321. The interlock 360 is weighted so that, under gravity, the U-shaped portion pivots away from the pusher plate 351, obstructing the passage of interlock rod 358. Thus if insufficient pressure is applied to the stack of banknotes, it will not be possible to close door 304. Note sensor 361 has a tab which extends through aperture 351D in pusher plate 351 so as to contact the stack of banknotes B. If too much pressure is applied to the stack of banknotes, note sensor 361 is pushed through aperture 351D towards base 306, which causes the U-shaped portion of interlock 360 to pivot towards the underside of pusher plate 351. This also obstructs the passage of interlock rod 358 and prevents closing of door 304.

Once the stack of banknotes is loaded and the pusher plate 351 raised so as to exert the correct pressure on the banknotes B, the door 304 is closed and the feed cassette 300 is ready to be inserted into the TCD. This involves sliding the feed cassette 300, rear wall 303 first, into the cassette bay 210 of one of the feed modules 200. The PCB plug and socket 398A and 219 couple to one another. The lid 321 is opened by pressing slide 344 downwards and sliding the lid 321 out in direction A. The lid 321 and corner hinge 325 can then be swung down so as to cover front panel 331. Depression of slide 344 also causes cassette bolt 334 to couple with the feed module 200 so as to prevent removal of the feed cassette 300 whilst the lid is open. The user then raises the lifting lever 216 which raises the cassette 300 to the dispensing position.

The pusher plate 351 is provided with lifter tab 351E which protrudes into a slot 303B provided along the length of rear wall 303. As the lifter carriage 245 moves up towards the transport module 260, it comes into contact with the lifter tab 351E. As previously described (section 2.2), the lift mechanism 240 senses when the lift carriage reaches the pusher plate 351 by means of a current monitor. When the TCD is initially switched on, on first contact between the lifter carriage and the pusher plate, the lift mechanism 240 continues to move the lifter carriage upwards, pushing the pusher plate 351 up with it. The pressure exerted on pusher shaft 310 by catch 356 causes the shaft to slide upwards, through an aperture in tab 303A at the top of rear wall 303. Similarly, friction between tube 354 and pusher shaft 311 causes the second pusher shaft 311 to move upwards also. The pusher shaft 210 is provided with an aperture near its lower end through which the light path of sensor assembly 395 passes when the shaft 310 is at its lowered position. The sensor assembly 395 can therefore detect the position of the shaft 310. The distance moved by pusher rods 310 and 311 is limited either by clips extending round the periphery of each pusher shaft 310, 311, or by a rod extending between the two pusher shafts (not shown).

In their raised position, pusher shafts 310 and 311 interlock with the interior of feed module 200 and so prevent feed cassette 300 being removed from the feed module when the pusher plate is elevated. In this position, the pressure exerted on the stack of banknotes is such that the plate 322 is pushed upward, exposing the uppermost banknotes to the transport module 216. The banknotes B are then ready for dispensing as previously described.

3.5 Cassette Locks

The feed module 300 can optionally be provided with one or more locks. In the example shown in FIGS. 14, 15 and 17, the feed cassette 300 is equipped with a mechanical lock as well as an electronic lock.

Lock actuator cover 340 fits underneath latch 333B and allows the lower end of actuator 332 to extend into the cover through slot 340A. The cover 340 houses locking arm 336 which is pivotably mounted to pin 336A on the exterior surface of front wall 301. The top end of locking arm 336 bears against the lower end of actuator 332 and in its default position (as shown) stops actuator 332 from moving downwards. At its lower end, locking arm 336 is provided with a tab which, when depressed, pivots the locking arm so as to release the actuator 332. A spring is provided so as to urge the locking arm back into the default, locked position when the force is removed.

Where a mechanical lock is deployed, the locking arm 336 is operated by lock 341 which consists of a rotatable barrel affixed to a lock tab 341A. When locked, the tab 341A is in an upright position as shown and does not contact locking arm 336. When the barrel is rotated using key 342, the tab 341A rotates 90 degrees clockwise (as seen from the point of view of the user), coming into contact with the lower tab on locking arm 336 and thus pivoting the components to its unlocked position.

Where the feed cassette 300 is provided with an electronic lock, a solenoid assembly 338 is disposed on base 306 under cover 343, adjacent to front wall 301. As shown in FIG. 17B, the solenoid assembly comprises an electromagnet 338A, a ferromagnetic plunger 338B and a connecting rod 338C. In use, a shaft 337, affixed to the upper side of locking arm 336, extends through an aperture in front wall 301 to couple with connecting rod 338C as depicted in FIG. 17B. When the electromagnet 338A is activated, plunger 338B is attracted into the electromagnet cavity, drawing connecting rod 338C with it. Since the aperture in front wall 301 is larger than the diameter of shaft 337, shaft 337 is pulled towards the solenoid assembly 338 causing locking arm 336 to pivot anticlockwise (as seen from the front of cassette 300), releasing the actuator 332.

A counterweight 339 is also provided inside housing 340 and pivotally mounted adjacent to locking arm 336. The counterweight 339 is spring mounted and bears against locking arm 336 in such a way as to return the component to its upright position when solenoid assembly 338 deactivates. Thus, in the example shown, to unlock the cassette 300, the user must not only turn the key to apply a force to locking arm 336, but must also activate the solenoid to operate shaft 337. The solenoid could be activated for example by a keypad or other such means (not shown), or in a preferred embodiment by connection to a loading frame 700 (see section 7).

4. Stacker and Delivery Module 400

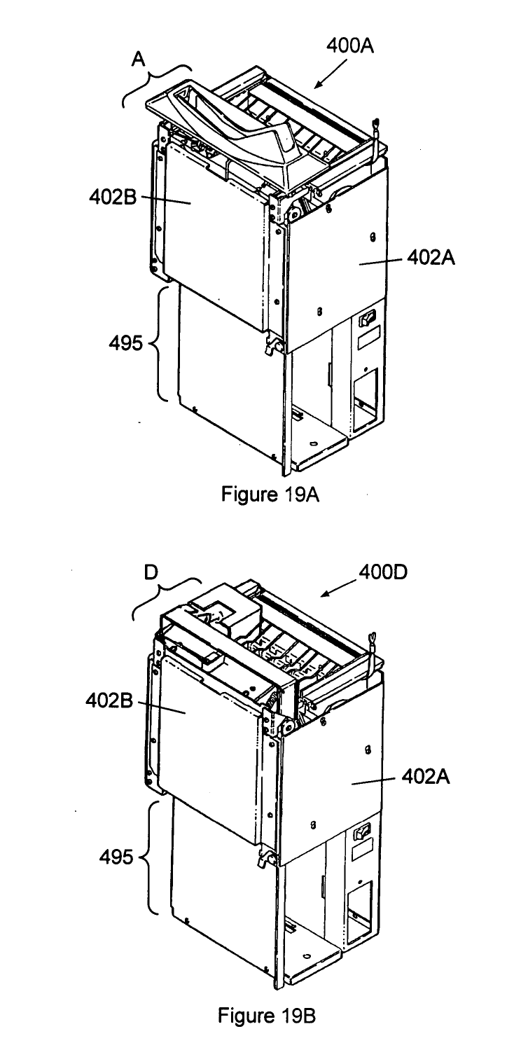

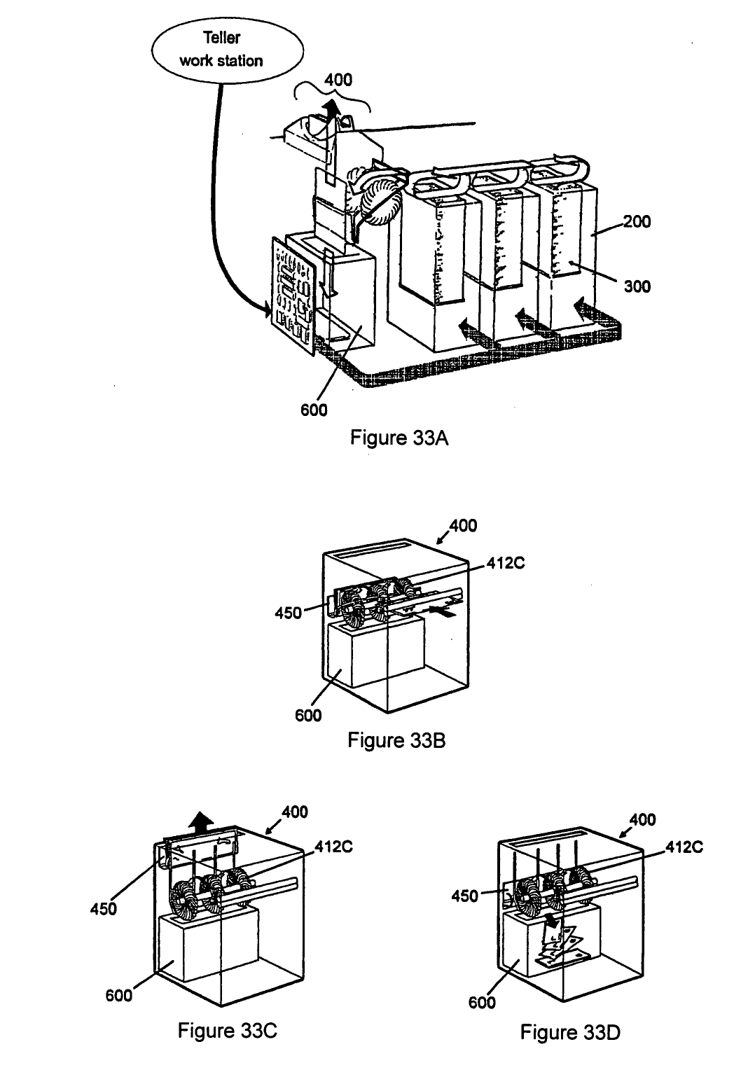

FIG. 33A shows, schematically, the path taken by a banknote dispensed by a TCD having a single row of feed modules 200 (a version having two rows and including a vertical transport module 500 will be discussed in section 5). The banknotes fed out of each feed cassette 300 are transported by the transport module 260 of each feed module 200 to the stacker and delivery module 400. Here, the banknotes are formed into a stack ready for presenting to the teller and then the stack is dispensed (FIGS. 33B and C). The stacker and delivery module 400 also includes detectors for determining whether banknotes have been misfed, in which case the stack of banknotes is rejected (FIG. 33D) and deposited into a reject cassette 600 (see Section 6). A number of variants of the stacker and delivery module 400 are available, of which two are shown in FIGS. 19A and 19B respectively. The differences lie in the manner in which the stack of banknotes is presented to the teller, for example via a cradle arrangement A or shutter system D. These and other examples will be detailed below.

The stacker and delivery module 400 comprises four main parts. The lower portion of the stacker and delivery module 400 comprises a housing 495 which in use holds a reject cassette 600 and also provides mounting for a power supply unit and various switches which need to be accessed by the user. The upper part consists of a stacker system 410 and a delivery system 440. The stacker system 410 transports the banknotes horizontally from the endmost feed module 200 towards the delivery system 440 and rotates them to form a stack. The stack is then transported vertically and presented to the teller by the delivery system 440.

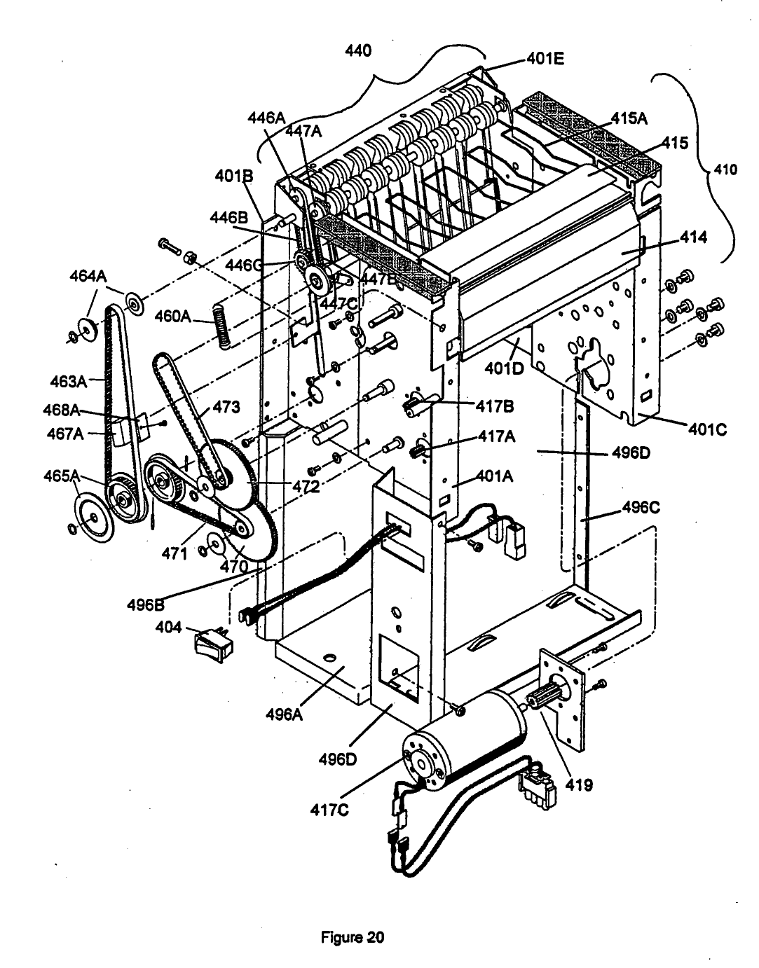

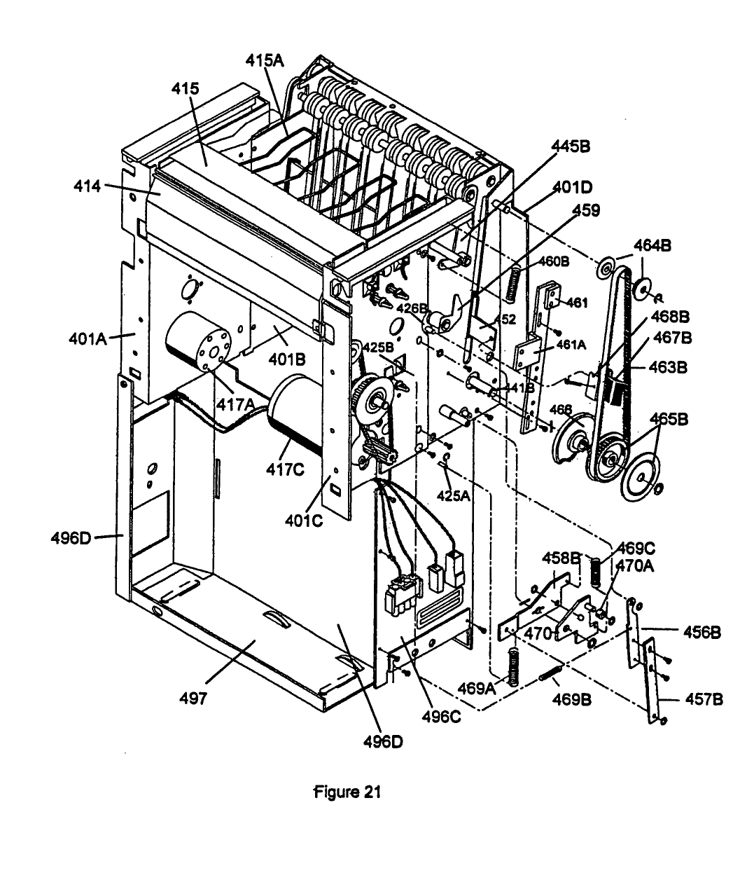

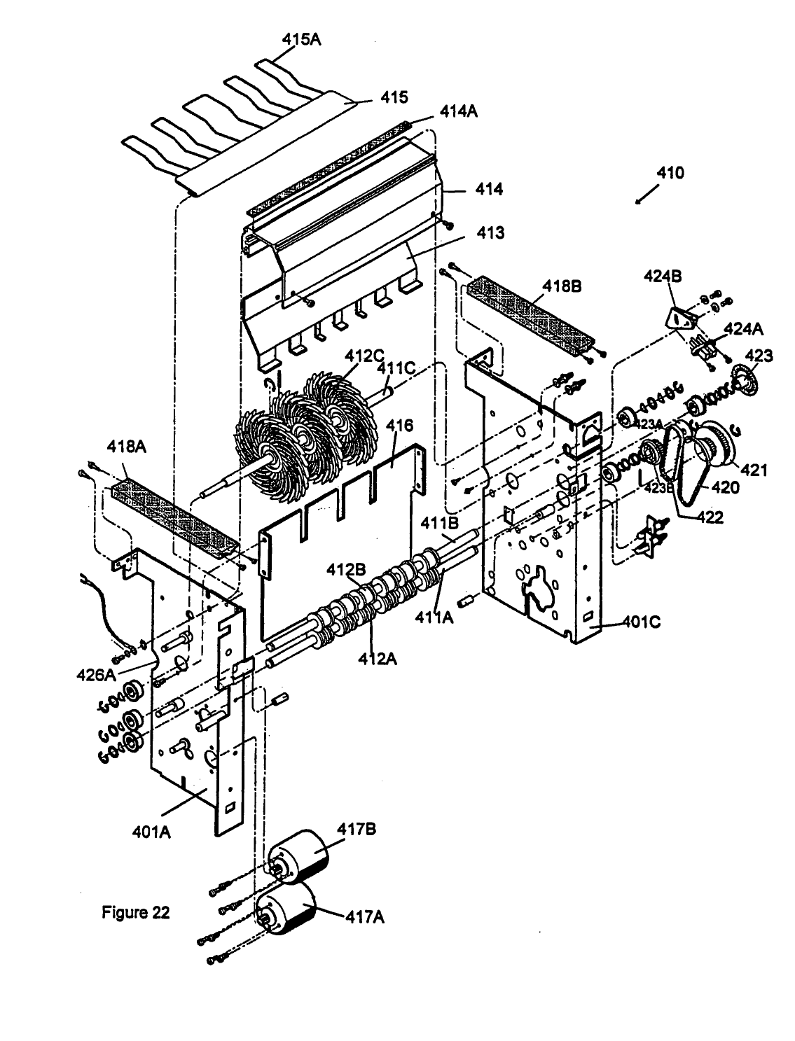

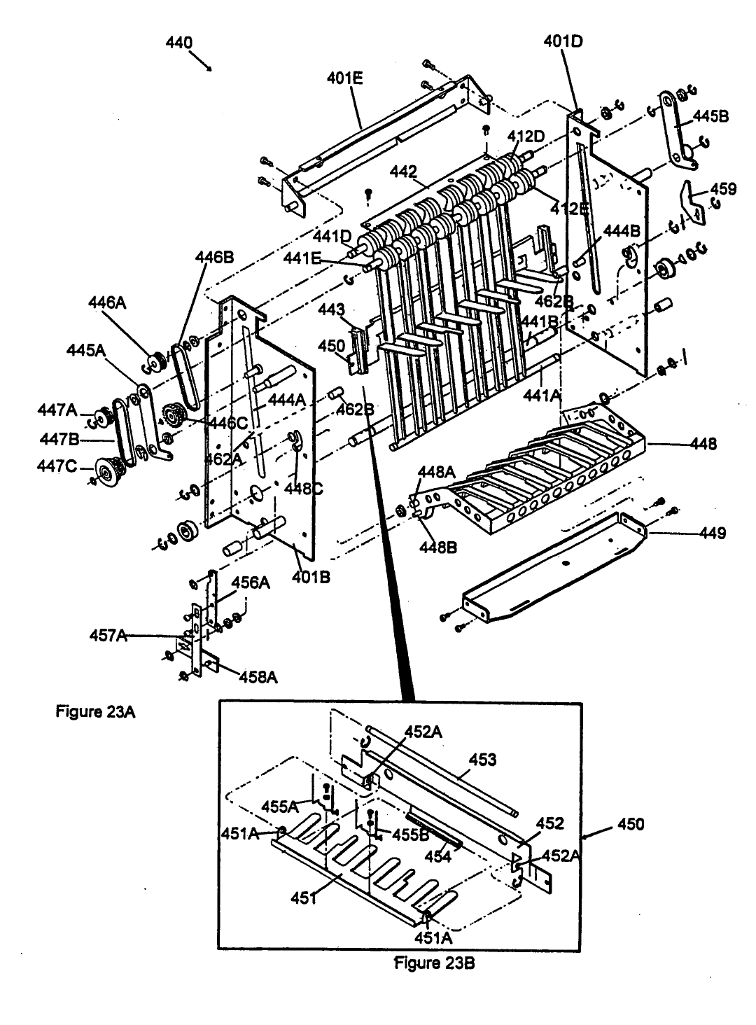

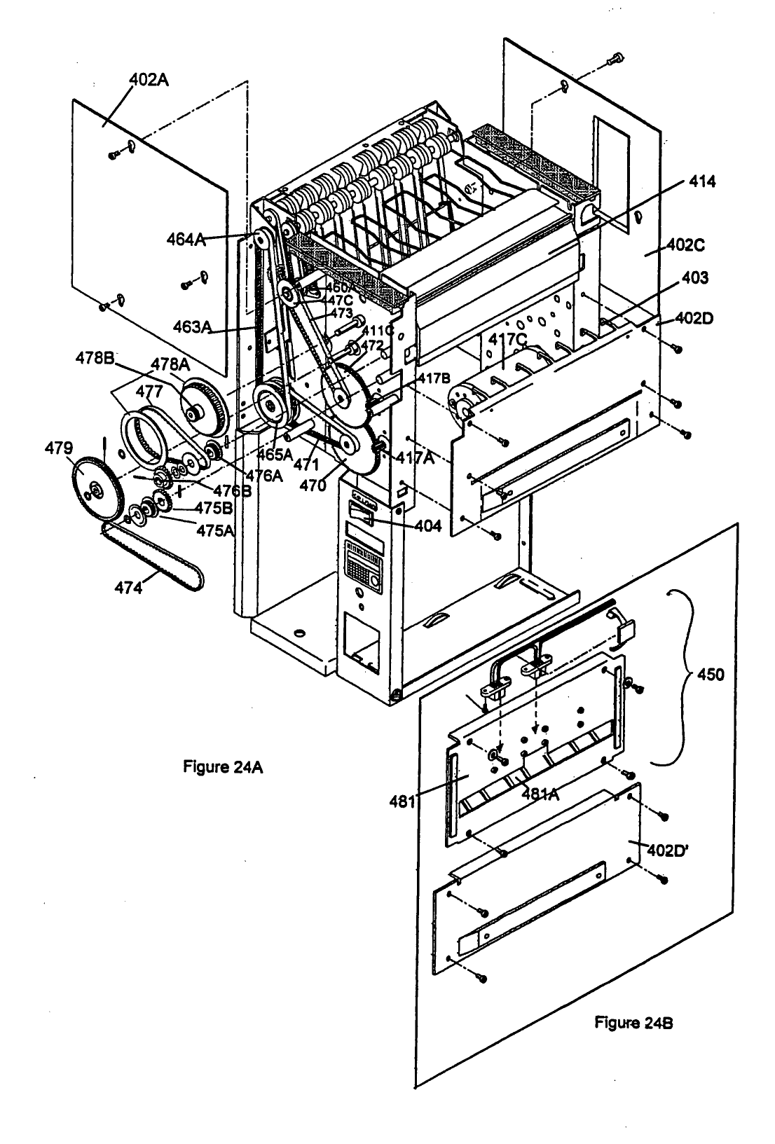

FIGS. 20 and 21 show, respectively, a front perspective view and a rear perspective view of the stacker and delivery module 400. The lower housing 495 comprises a base 496A, a rear wall 496C and side walls 496B and 496D which together define a bay into which the reject cassette 600 (not shown) fits in use. One side wall 496D is provided with a front panel portion which, together with base 497, defines a further bay which, in use, houses a power supply. The stacker system 410 and the delivery system 440 are disposed above the housing 495 and are illustrated in FIGS. 22 and 23 respectively. FIG. 24 depicts further details of the drive means which operate the stacker and delivery systems.

4.1 Stacker System 410

The stacker system 410 is supported at its front end by front wall 401 and at its rear end by rear wall 401C. Each wall is provided with a series of pegs for supporting pulleys and apertures for receiving shafts, as will be described below. Transport shafts 411A and 411B extend between the front and rear walls, above one another, adjacent to the endmost feed module 200. Each shaft 411A and 411B is provided with a series of feed rollers 412A and 412B respectively through which a banknote is transported horizontally from the endmost feed module 200 towards a set of three stacker wheels 412C.

Each stacker wheel 412C comprises a disc of curved fingers joined at their inner end to a circular core. The fingers are curved and provided with pointed ends in such a way that they guide a banknote, introduced to the top of the stacker wheel, into the slot defined by adjacent fingers. The stacker wheels turn in an anticlockwise direction (as seen from the front wall 401A) so as to rotate the banknote, held between the fingers, into a vertical orientation. In this position, the banknote is caught by the delivery system 440 as will be described below, and a stack is formed.

The stacker wheels 412C are disposed on shaft 411C which extends between the front and rear walls 401A and 401C. A guard plate 416, equipped with slots to accommodate the three stacker wheels 412C, is disposed immediately beneath shaft 411C so as to prevent any notes becoming caught in the stacker wheels 412C and thus avoid misfed notes blocking the transport path. Similarly, an upper guard 413 is provided which fits between rollers 412B and so directs banknotes towards the stacker wheels 412C rather than around rollers 412B. Upper bar 414 provides a housing for the feed rollers 412A and 412B. Its lower edge defines the upper side of a slot through which banknotes enter the stacker and delivery module 400. The lower side is provided by side panel 402D, shown in FIG. 24A and described below. A guard plate 415 equipped with wire fingers 415A is provided on top of bar 414. This allows access to the interior components for maintenance but prevents notes inadvertently exiting the machine or foreign objects entering the machine when in use. The wire fingers 415A can be hinged upwards relative to the guard plate 415.

A transport motor 417C is mounted on rear wall 401C. (FIGS. 21 and 22). This drives the transport rollers 412A and 412B as well as the stacker wheels 412C and the transport module 260 in each of the feed modules 200. The toothed drive cog of transport motor 417C turns a belt 420 which in turn rotates pulley 421, a second belt 423A and pulley 423B to which it is connected. Pulley 423B is affixed to the rear end of the lower transport shaft 411A. Thus activation of motor 417C rotates feed rollers 412A anticlockwise (as viewed from front wall 401A).

At its other end, the lower transport shaft 411A is fitted with a pulley 475A and toothed cog 475B (see FIG. 24A). The toothed cog 475B meshes with another cog 476B disposed on the front end of upper transport shaft 411B. Thus rollers 412B are simultaneously caused to rotate in a clockwise direction.

A disc 423 is affixed to the rear end of the upper transport shaft 411B and is provided with a series of radial slots. The edge of disc 423 extends into optical sensor 424A which is mounted to rear wall 401C via bracket 424B. The radial slots in disc 423 interrupt the light beam within optical sensor 424A, which may therefore be used to monitor the angular velocity of rollers 412B.

Transport motor 417C also operates the stacker wheels 412C. As already described, the upper transport shaft 411B is caused to rotate in a clockwise direction. A pulley 476A disposed on the front end of upper transport shaft 411B turns belt 477 with it. At the other end of the belt 477, pulley 478A, disposed on a pin on the exterior surface of wall 401A, also rotates. The pulley 478A is equipped with a toothed cog 478B which meshes with cog 479, affixed to the front end of stacker shaft 411C. Thus the stacker wheels 412C are caused to rotate in an anticlockwise direction simultaneously with the rotation of the transport rollers 412A and B.

Drive is transmitted to the endmost feed module via a belt 474 which couples with pulley 475A on the front end of transport shaft 411A which as previously described is directly driven by transport motor 417C. A series of belts 474 are used to “daisy chain” each transport module 260 to the next.

4.2 Delivery System 440

The front wall 401A of the stacker system fits to front wall 401B of the delivery system so as to form a complete front surface. Likewise, rear walls 401C and 401D couple to form a complete rear surface. A cage 442 is supported between walls 401B and 401D by shaft 441D at its top end and shaft 441A at the other. The cage 442 comprises a series of elongate bars separated from one another by elongate apertures. The shafts 441D and 441A are typically not aligned vertically with one another so that the bars of cage 442 lie at an angle. Shaft 441D also supports presenter rollers 412D. These are opposed by more presenter rollers 412E disposed on shaft 441E, adjacent to the top of cage 442. Each end of shaft 441E is supported by the top end of an arm 445A or 445B which is pivotably mounted to the exterior surface of wall 401B or 401D respectively. Thus rollers 412E are moveable towards and away from rollers 412D to accommodate different stack thicknesses. Springs 460A and B act to return presenter rollers 412E to their default position (adjacent to rollers 412D) after a stack of banknotes has been fed through.

As each banknote is rotated by stacker wheels 412C, it is caught by lift assembly 450. The lift assembly 450 is shown in exploded form in FIG. 23B. The lift plate 451 is provided with a series of fingers which extend substantially horizontally through the apertures between the bars of cage 442 and into the spaces between the stacker wheels 412C. The lift plate 451 is rotatably mounted to lift bar 452 via a shaft 453 which extends through mounting points 452A and 451A on the lift bar 452 and lift plate 451 respectively. A spring 454 acts between the lift bar 452 and lift plate 451 so as to urge the lift plate 451 towards its default, horizontal position. The lift bar 452 extends between bushings 443 which are mounted in elongate slots 444A and 444B on the front and rear walls respectively. Each end of lift bar 452 extends through the elongate slot where it connects to a lift block 467A, B via a lift block plate 468A, B. Each lift block 467A, B is fixed to a lift belt 463A, B which extends between a lift pulley assembly 465A, B at its lower end and pulley 464A, B at its upper end, supported on an end of side bracket 401E. When the belts 463A and B rotate in a first direction, the lift blocks 467A and B move up towards rollers 412D and E. Once a stack of banknotes has been successfully deposited on lift plate 451 by the stacker wheels 412C, the belts 463A and B operate (as will be described below) to slide the lift assembly up. The stack of banknotes is guided by the bars of cage 442 into the nip of presenter rollers 412D and 412E which act to grab the stack of banknotes off the lift plate 451, raising them up and presenting them to the teller.

If, on the other hand, the stack of banknotes deposited on the lift plate 451 is deemed to be defective (for example by the doubles detector, see section 4.4), the belts 463A and B are rotated in the opposite direction. The lift assembly 450 then moves down towards shaft 441A. Pins 462A are provided which protrude from the interior surfaces of front wall 401B and rear wall 401D. Each pin 462A is covered by a length of tubing 462B to protect it from wear. As the lift assembly moves down, the side of lift plate 451 furthest from stripper wheels 412C comes into contact with the two pins 462A. As the lift assembly continues to move down, the pins 462A cause the lift plate 451 to pivot about shaft 453. The fingers on lift plate 451 supporting the stack of banknotes drop down, becoming flush with the bars of cage 442. The rejected stack of banknotes falls, guided by the bars of cage 442, into the reject cassette 600 which is situated below.

A grid of cleaner fingers 448 is also provided which assists in guiding the rejected banknotes into the reject cassette 600. The grid 448 consists of a frame having front and rear arms and a side bar at the side nearest the endmost feed module 200, supporting a number of elongate fingers. The side arms and fingers are shaped so as to direct banknotes towards the reject cassette 600. Each side arm is provided with pivot pins 448A which extend through holes in the front and rear walls 401B and 401D respectively, and about which the cleaner fingers 448 pivot. Second pins 448B are also provided adjacent to the pivot pins 448A and extend through an arcuate aperture in each of the front and rear walls, so allowing the cleaner fingers to pivot through a limited angle of approximately 90 degrees. When assembled, the cleaner fingers extend beneath the transport rollers 412A and B and the stacker wheels 412C so as to direct any misfed or dropped notes towards the reject cassette 600.

At its front end, the cleaner fingers grid 448 is connected to plate 456A via pin 448B. Plate 456A is fixed to a second plate 457A which is pivotably coupled with link plate 458A, pivotably mounted to the exterior of wall 401B. Similarly, at its rear end, cleaner fingers grid 448 attaches in the same manner to plates 456B, 457B and link plate 458B (FIG. 21). A spring 469A acts between pin 425A on the rear wall 496C of the lower housing 496 and one end of link 458B. This urges cleaner fingers 448 into their default, substantially horizontal position. Another spring 469B extends between tab 425B on rear wall 401C and plate 456B so as to assist in this.

A cam follower plate 470 is disposed on the rear link plate 458B, with a further spring 469C biassing the two components towards one another. A cam follower roller 470A is disposed on a pin near to the top of cam follower plate 470. The cam follower roller 470A bears against cam 466, which is affixed to lift pulley assembly 465B. When the pulley assembly 465B and lift belt 463B turn in the second direction (so as to drop the stack of banknotes into the reject cassette 600), the cam 466 acts on cam follower plate 470 so as to push cam follower roller 470A down. The link plate 458B thus pivots, pushing the cleaner fingers up via pin 426B. The cleaner fingers 448 pivot in such a way that any banknotes resting on them are tipped towards the reject cassette 600. Thus any banknotes which inadvertently fall from transport rollers 412A and 412B, or from the stacker wheels 412C, are caught by the cleaner fingers 448 and later deposited into the reject cassette 600 when a defective stack of banknotes is rejected.

The delivery system 440 is driven by motors 417A and 417B, both mounted on the inside of front wall 401A. The lift assembly is driven by lift motor 417A, whose toothed drive cog meshes with a cog 470 to turn belt 471. Belt 471 connects with drive pulley assembly 465A at the lower end of the lift belt 463A. As seen from front wall 401A, clockwise rotation of lift motor 417A turns drive pulley assembly 465A anticlockwise, raising the lift assembly towards the dispensing position. Anticlockwise rotation of lift motor 417A moves the lift assembly down towards the reject cassette 600.

The presenter rollers 412D and 412E are driven by presenter motor 417B. The toothed drive cog on presenter motor 417B turns a cog 472 which operates belt 473 to turn pulley 447C, mounted at the pivot point of supporting arm 445A. Pulley 447C drives a belt 447B which extends along the length of supporting arm 445A to turn pulley 447A affixed to the front end of presenter shaft 441E. Anticlockwise rotation of presenter motor 417B thus causes presenter rollers 412E to rotate clockwise. Simultaneously, pulley 447C meshes with toothed cog 446C which rotates pulley 446A via belt 446B. Pulley 446A is affixed to the front end of shaft 441D and so turns presenter rollers 412D in an anticlockwise direction. The stack of banknotes is grabbed by the presenter rollers 412D and 412E, and is moved up for presentation to the teller.

The stacker and delivery unit 400 is closed by means of panels 402A to D as shown in FIG. 24. In the embodiment shown in FIG. 24A, the banknotes enter the stacker and delivery module 400 from the endmost feed module 200 through a slot defined between the upper bar 414 and side panel 402D. However in other embodiments, a doubles detector plate 481 (shown in FIG. 24B) may be incorporated into the side wall and provide the slot 481A itself. The double detector plate 481 houses a system for detecting multiple or defective banknotes as will be described in Section 4.4. In this case, a side panel of reduced height 402D′ is provided which fits underneath the doubles detector plate 481.

4.3 Sensor System

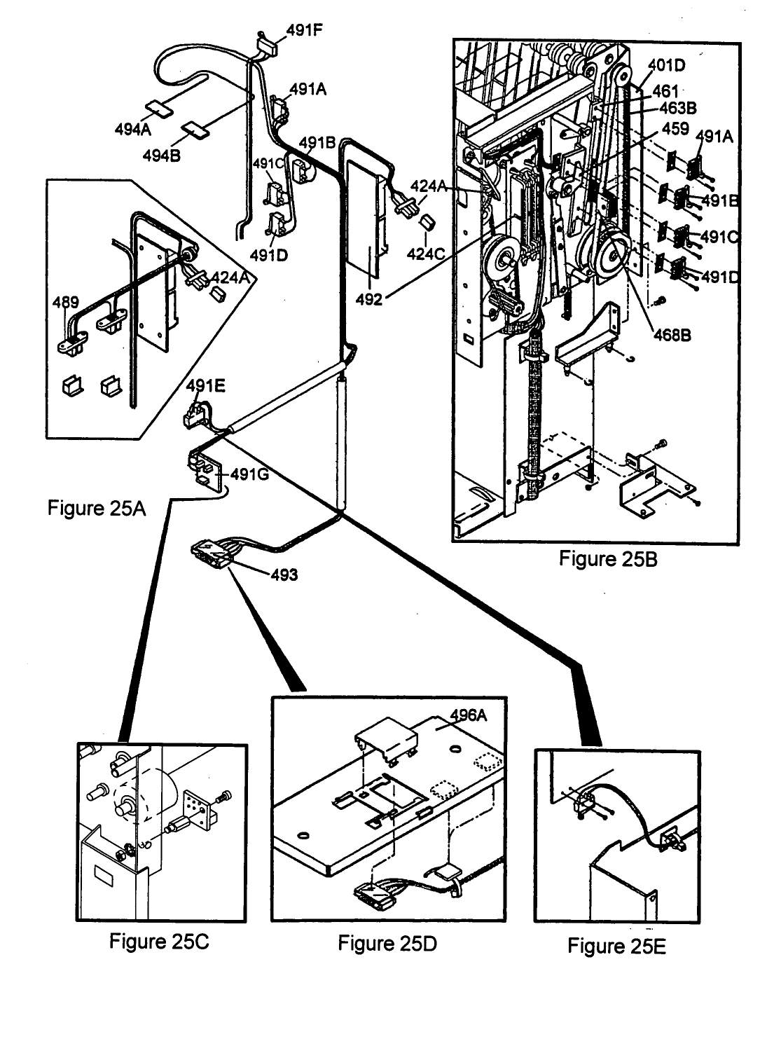

FIGS. 25A to E illustrate the sensing system which is incorporated into the stacker and delivery module 400. Four microswitches 491A to D are disposed along mounting strip 461 on the exterior side of rear wall 401D. Microswitches 491A, C and D are positioned near the top, middle and bottom of slot 444B respectively. Each switch is activated by contact with the lift block plate 468B disposed on belt 463B. Contact between the middle microswitch 491C and the lift block plate 468B indicates that the lift assembly 450 is at the correct position to receive the stack of banknotes from the stacker wheels 412C.

As the lift assembly 450 is moved up for the stack of banknotes to be presented, the top microswitch 491A is activated. This indicates that the lift assembly has reached the top and that the motor 417A can be reversed so as to return the lift assembly 450 to its middle position ready to receive the next stack of banknotes. When a stack of banknotes is rejected, and the lift assembly moved down, lift block plate 468B comes into contact with lower microswitch 491D, indicating that the lift plate assembly has reached its lowest position, and therefore that the stack of banknotes has been deposited into the reject cassette. The lift plate can then be returned to its default position.

Microswitch 491B is disposed on a raised portion of mounting strip 461 adjacent to a tab 459 which is fixed to the end of the pivot pin 448A on the rear side of cleaner fingers grid 448. The microswitch 491B is contacted by tab 459 when the cleaner fingers 448 are in their lowered (substantially horizontal) position. When cam 466 and cam follower 470 act to tip the cleaner fingers 448 up, this is detected by microswitch 491B losing contact with tab 459. Sensor assembly 494 and microswitch 491F form part of the presenter system and their function will be described below in section 4.6. Optical sensor 424A sits adjacent to the rear end of transport shaft 411B as previously described (section 4.1) and detects rotation of disc 423. A microswitch 491E is disposed near the bottom of side wall 401D at its front edge, as shown in FIG. 25E. This is used to detect when there is a reject cassette 600 in position. An RC network and diode 491G is also provided, as shown in FIG. 25C, which acts as a noise filter for the main motor and stacker motors. A PCB connector socket 493 is provided in the base 496A of the cassette bay 496. In use, this couples with a PCB plug on the underside of reject cassette 600. All the above-described components connect to a connection socket 492 via a series of cables. The connection socket 492 is fitted to rear wall 401C by means of snap mounts.

If the stacker and delivery module 400 is equipped with a doubles detector 480, sensors 489 are also provided and connected to the connection socket 492.

4.4 Doubles Detector

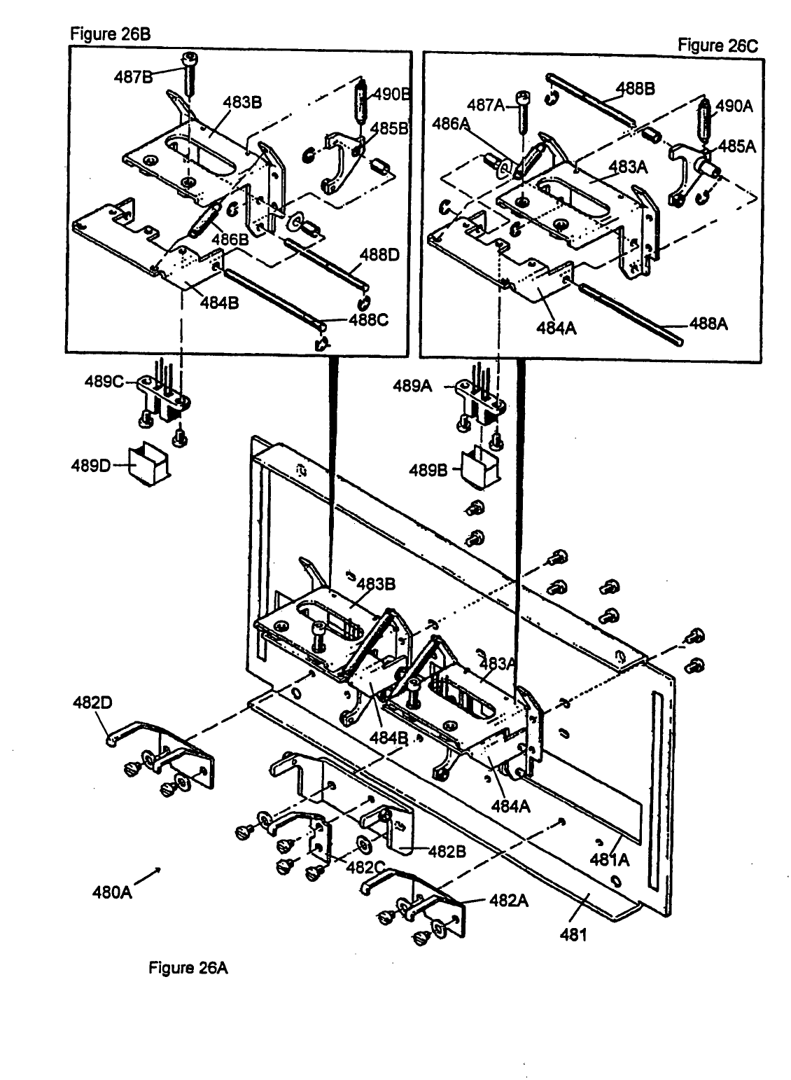

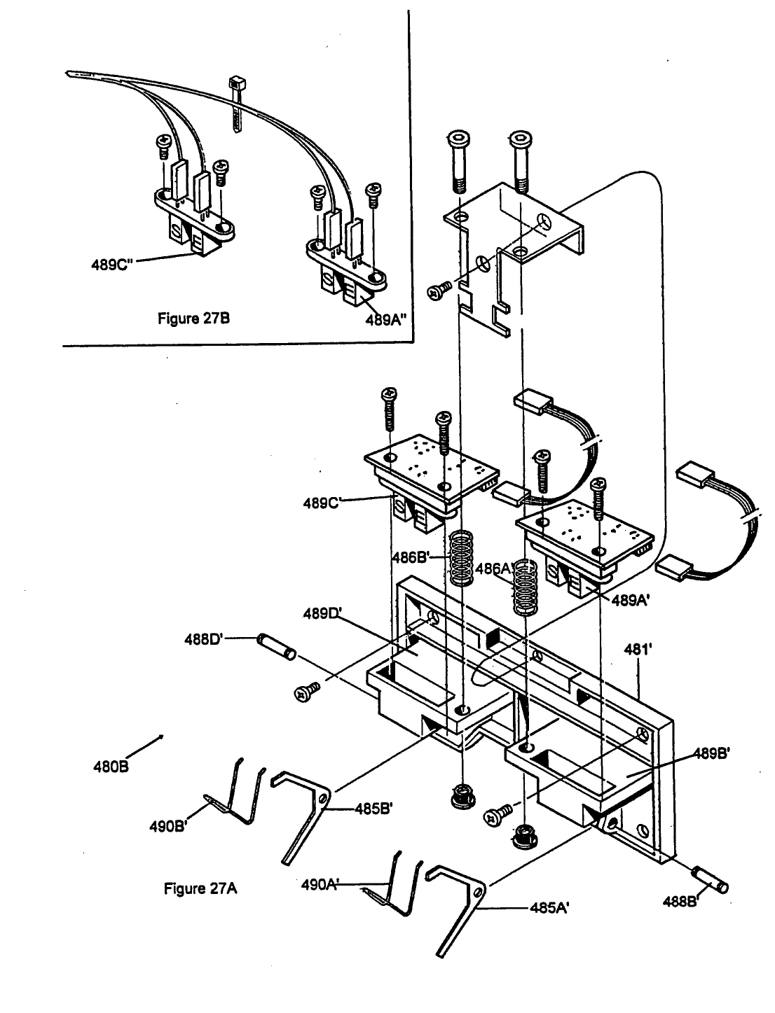

The stacker and delivery module 400 is typically provided with a double detector assembly 480 for detecting the passage of multiple or defective banknotes. The doubles detector 480 is located immediately adjacent to the point at which the banknotes enter the stacker and delivery module 400 from the endmost feed module 200. Various different configurations are possible, of which two examples are shown, designated 480A and 480B, in FIGS. 26 and 27 respectively. The principles of operation are the same in each case and components have the same function in each embodiment have been identified using corresponding reference numerals.

A doubles detector plate 481 or 481′ is provided to support the sensor components and to define a path through which banknotes entering the stack and delivery module 400 will pass. This may be in the form of a slot 481A or the banknotes could pass one edge of the plate 481′. As shown in FIG. 26, guide fingers 482A to D may be provided underneath the banknote path so as to guide each note in the correct direction. Two sensor mounts 483A and B are provided above the banknote path and are spaced from each other laterally along the length of the banknote. Optical sensors 489A and C are mounted on the underside of sensor plates 444A and B respectively, fixed to the sensor mounts 483A and 483B. Each sensor 489A, C defines a light path therewithin. A sensor arm 485A and B is pivotably disposed directly beneath each sensor 489A, C by means of shafts 488B and D. Each sensor arm 485A, B is provided at its lower end with a roller which in use rests against two of the guide fingers 482B, also provided with corresponding rollers.

When a banknote enters the stacker and feed module 400 through slot 481A, it travels over guide fingers 482A to D, between the rollers disposed on fingers 482B and sensor arms 485A and B. As a result of the thickness of the banknote, sensor arms 485A and B pivot upwards about shafts 488B and D. The upper portion of each sensor arm 485A and B moves into its respective optical sensor 489A and C, obstructing the light path therewithin. The extent of obstruction (and so the reduction in received light intensity) depends on how far the sensor arms 485A and B pivot, which in turn is determined by the thickness of the passing banknote. Thus if more than one banknote is fed through the detector assembly, both sensors 489A and 489C will detect a greater reduction in light beam intensity than usual. Multiple banknotes passing the double detector assembly can therefore be identified and the stack of banknotes rejected, thus avoiding presentation of an incorrect amount of money to the teller.

The doubles detector assembly can also identify folded or damaged banknotes. A normal banknote passing through the double detector assembly will cause substantially equal reduction in light intensity in each of the sensors 489A and 489C. If however a note is folded in half, one of the sensors 489A and 489C may appear to sense a double banknote passing, whilst the other will detect nothing. Similarly, a torn banknote may activate one of the sensors 489A and 489C and not the other. Thus defective banknotes can often be detected and the stack of banknotes rejected. The doubles detector also provides a second opportunity to count the banknotes before they are dispensed.

The sensitivity of the double detector assembly can be adjusted by changing the position of the sensors 489A and 489C relative to the default positions of sensor arms 485A and 485B. The sensors 489A and 489C are mounted on sensor plates 484A and 484B respectively which are pivotably mounted to mounts 483A and 483B via axles 488A and 488C. A spring 486A, B biasses the sensor plate 484A, B towards the mount 483A, B. A screw 487A, B extends through mount 483A, B to bear against the top of sensor plate 484A, B. By tightening or loosening the screw 487A, B, sensor plate 484A, B (and so the sensors mounted thereon) can be pivoted up and down. The lower the position of the sensor, the thinner the banknote that can be accurately detected. Each sensor is typically further provided with a cover 489B and D to protect it from dust.

The embodiment shown in FIGS. 27A and 27B works in substantially the same manner as that of FIG. 26, with arms 485A′ and 485B, resting against the passing banknotes and biassed by springs 490A′ and 490B′. The mounting apparatus is simplified by the use of a moulded plate 481′ having casings 489B and 489D which support the sensors 489A′ and 489C′ and also act as dust covers. The sensors 489A′ and 489C′ may be connected directly to the connector 492 (FIG. 27B) or could be affixed to PCBs, equipped with components to carry out initial processing (FIG. 27A).

4.5 Presenter System

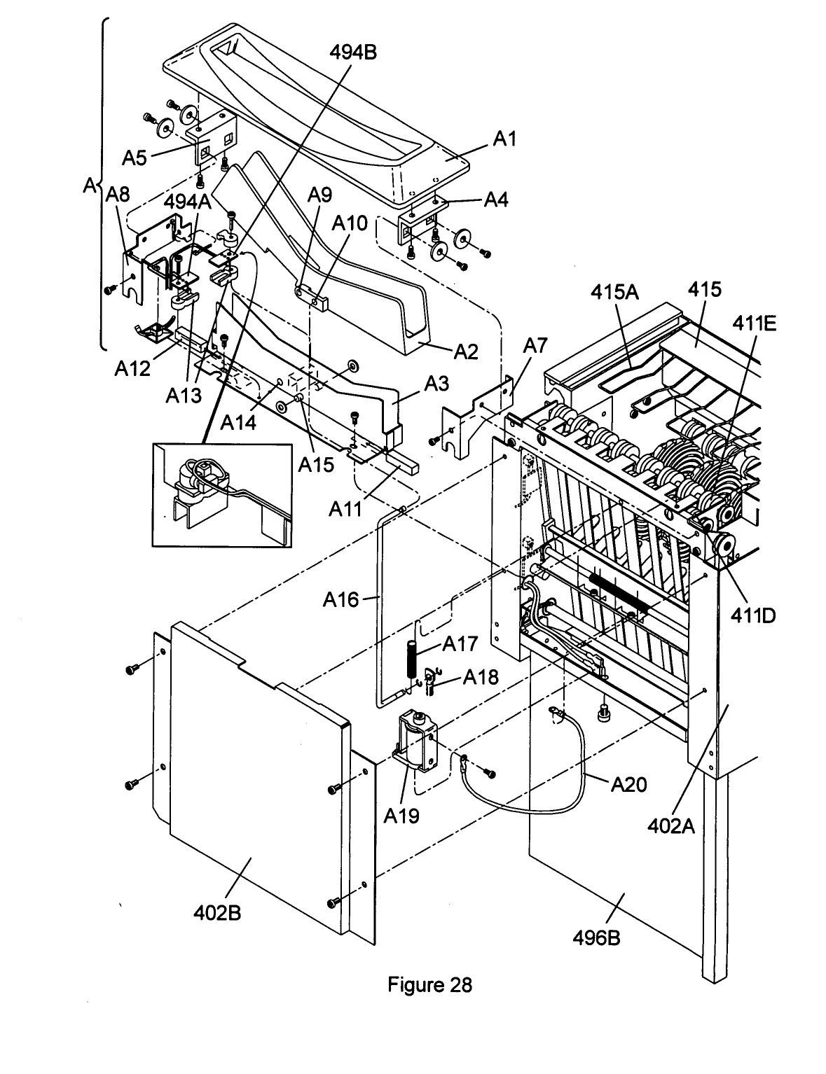

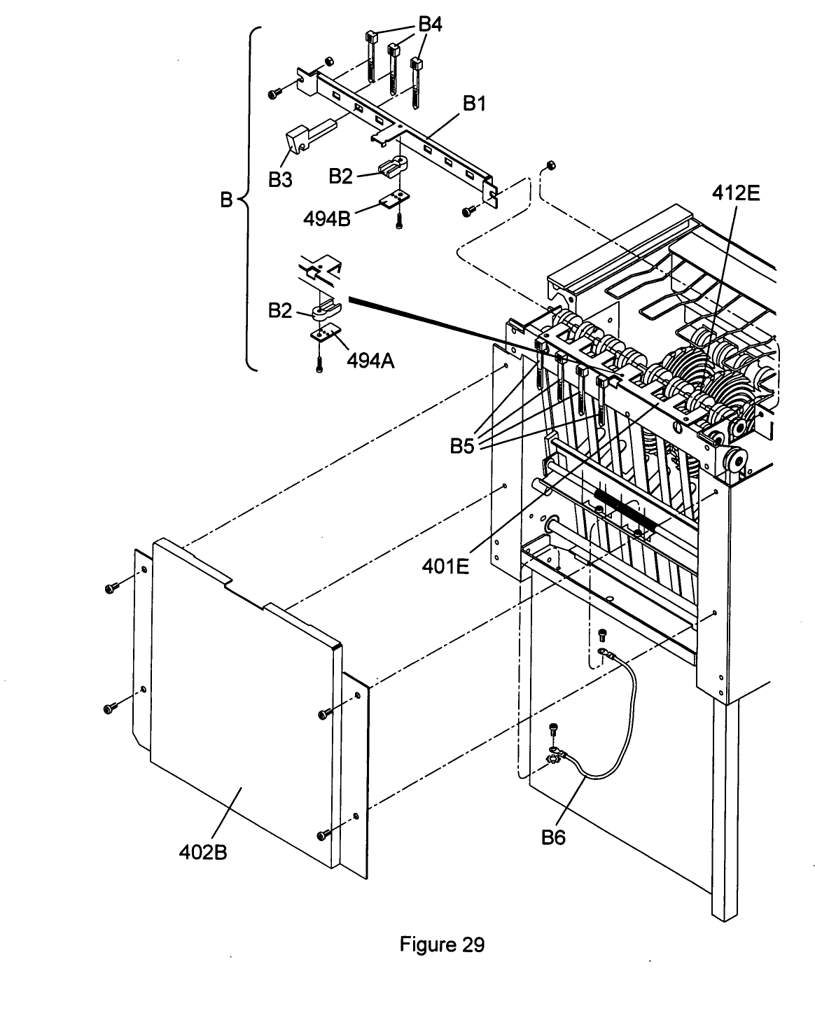

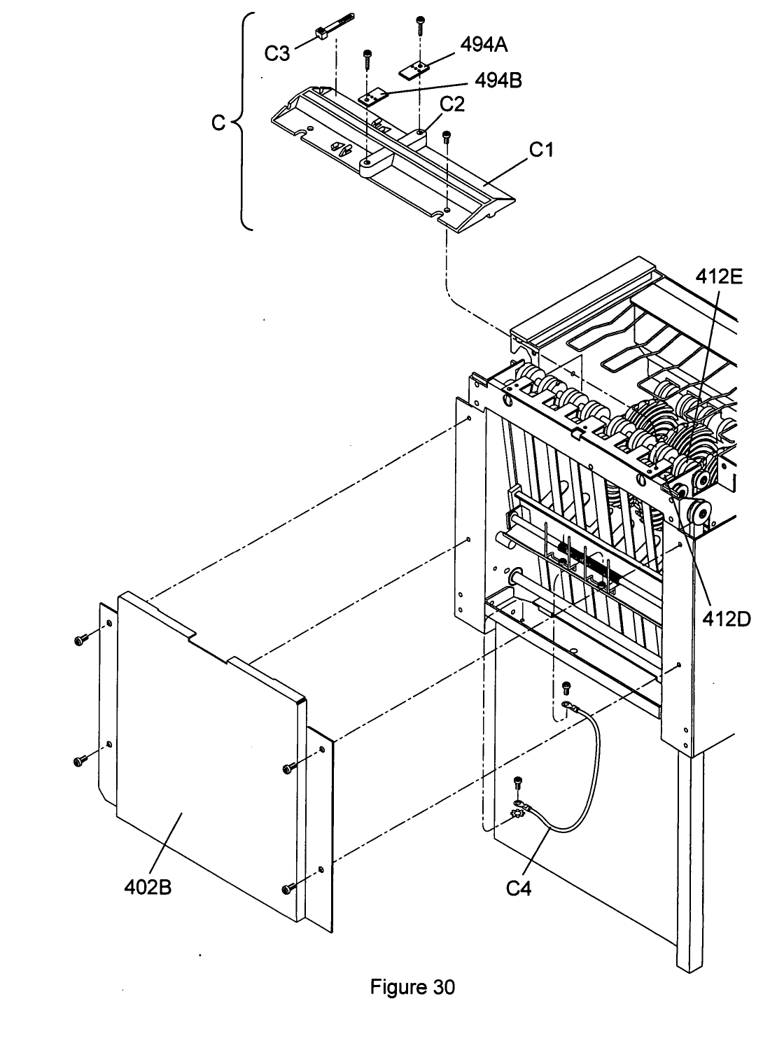

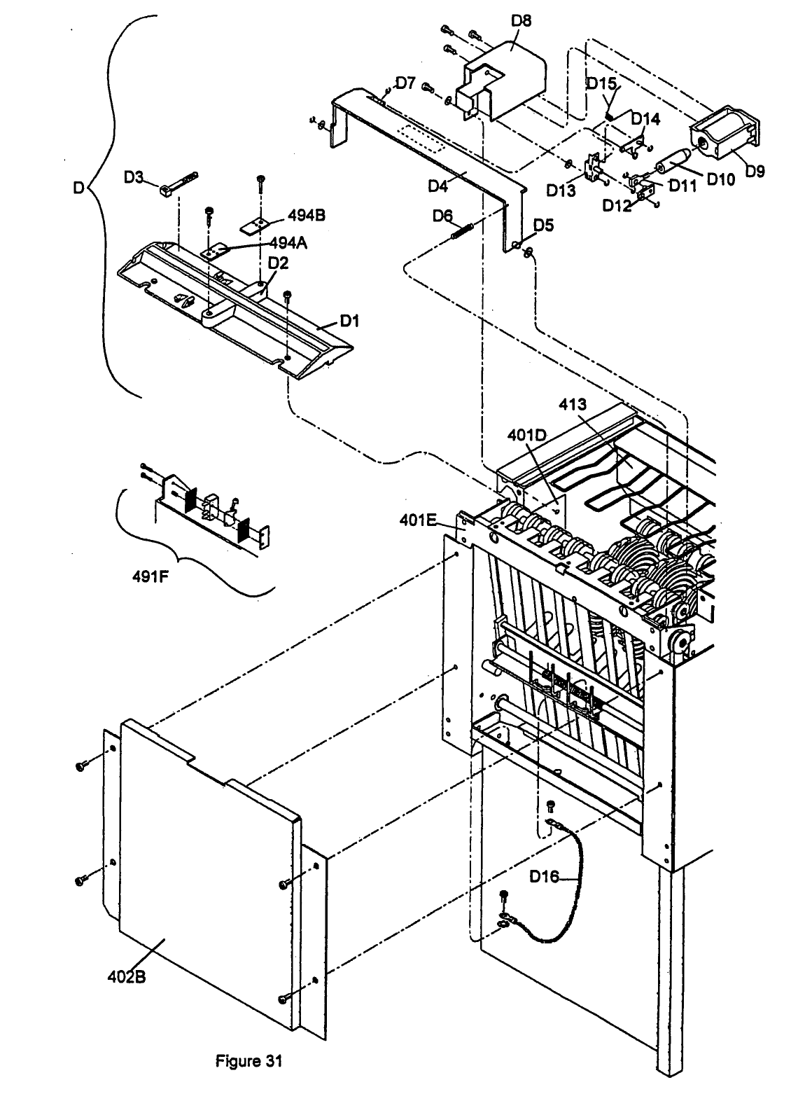

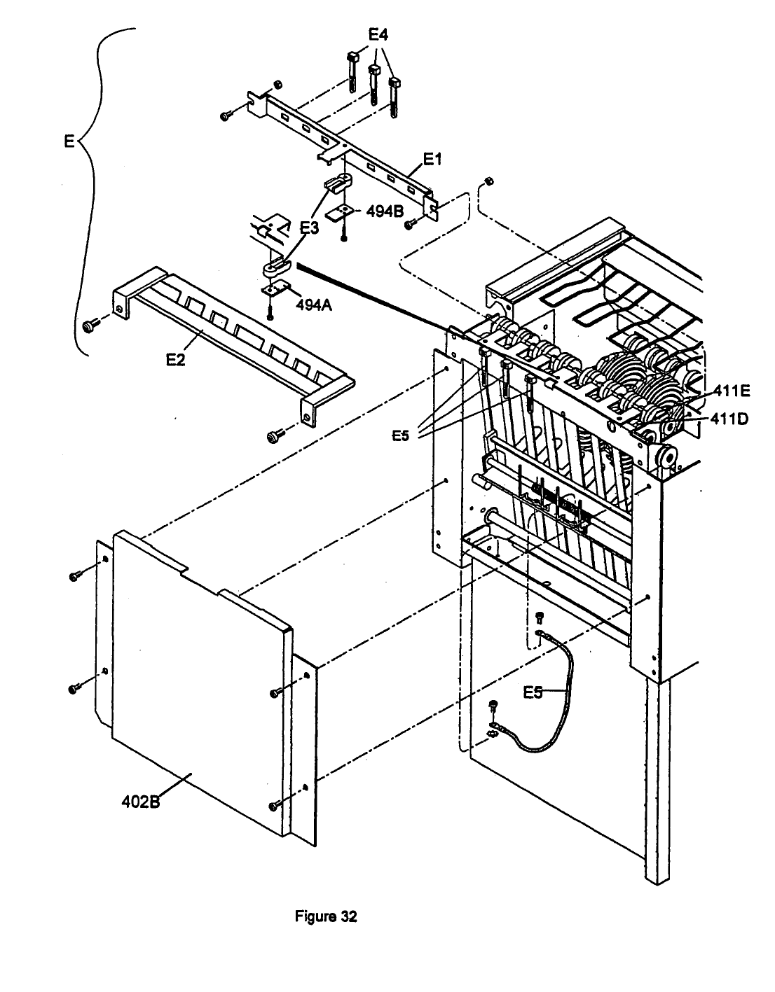

Once a stack of banknotes has been formed on lift assembly 450, raised and then grabbed and pushed up by presenter rollers 412D and E, it can be dispensed to the teller by a variety of means. Five different presenters A to E are illustrated in FIGS. 28 to 32 respectively. Common to all five variants is the provision of a guide slot through which the stack of banknotes is dispensed and sensing assembly 494 (consisting of LED 494A and detector 494B) which monitors the passage of banknotes through the guide slot.

4.5.1 Variant A: Presenter with Cradle

A cradle mount A3 consisting of a plate having two parallel fins defining a guide slot therebetween is positioned above presenter rollers 411D and E. Each fin has a flat central portion and is taller at either end, making a flat-bottomed V shape profile. Pivot pins A15 are provided on the exterior side of each rib at its centre and a cradle A2 is pivotably mounted thereon. The cradle A2 consists of a moulding having two parallel hollow panels which correspond to the ribs of cradle mount A3. One hollow panel fits over each rib in such a way that the mount A3 is covered by the cradle A2 (leaving the guide slot open). The hollow panels are inclined towards the centre of the component in such a way that the cradle base defines a wide angle V shape. The cradle A2 is pivotably supported at its centre A9. When one end of the cradle A2 sits flat against the base of mount A3, the other end of the cradle A2 is raised. In the orientation shown in FIG. 28, the stack of banknotes passing through mount A3 and cradle A2 is directed towards a teller sitting on the front side of the TCD (adjacent to front panel 402A). When the cradle A2 tilts the other way, the stack of banknotes is for a teller sitting on the opposite side.

The orientation of cradle A2 is controlled by rod A16 which connects to aperture A10 on one side of cradle A2, spaced by a small distance from pivot point A9. The other end of rod A16 is attached to the end of a solenoid plunger A18 which co-operates with an electromagnet A19. When the solenoid is activated, rod A16 is pulled downwards and cradle A2 pivots towards front panel 402A. A spring A17 connected between rod A16 and the top of the delivery system acts to return the cradle to its central position and then to push it towards the other teller. Foam pads A11 and A12 are provided, one either end of the mount A3, to cushion the edge of cradle A2 as it tilts in each direction. Front and rear brackets A7 and A8 are provided to support a cradle collar A1 via collar brackets A4 and A5. The cradle collar A1 sits on top of mount A3 and surrounds cradle A2 so as to seal the stacker and presenter module 400 apart from the guide slot through which the banknotes exit the machine.

Collar A1 also provides a casing for sensor assembly 494, of which LED 494A and detector 494B sit either side of mount A3, on supports A13. The light path passes through cutouts in the two hollow panels of cradle A2 and through holes A14 in the ribs of mount A3 and is obstructed by passing stacks of banknotes so as to monitor their passage.

4.5.2 Presenter without Cradle

In some circumstances, no cradle is required (for example when the TCD is used by a single teller) and in this case a single guide bar B1 may be provided to oppose side bar 401E and thus complete the guide slot therebetween through which the stack of banknotes exits the stacker and delivery module 400. The bar B1 sits adjacent to presenter rollers 412E and is provided with a series of inner guide pieces B3 which, when assembled, sit inbetween the presenter rollers 412E and clip to the presenter shaft 441E. Since the presenter shaft 441E is pivotably mounted on arms 445A and B, inner guide pieces B3 are not rigidly fixed to bar B2 but instead are slidably engaged so that movement of presenter shaft 441E is not restricted.

Bar B1 is provided with a central protrusion on which detector 494B is disposed via mount B2. The corresponding LED 494A is disposed underneath the central protrusion of side bar 401E via a second mount B2. Tie-wraps B4 and B5 are provided to strap the sensor cables (not shown) to the bar B1.

4.5.3 Variant C: Presenter with Collar

As an alternative to the bar arrangement of variant B, a collar C1 may be provided to guide the banknotes out of the stacker and feed module 400. The collar C1 defines a guide slot down its centre and sits above presenter rollers 412D and 412E. Mounting points C2 are provided near the centre of the collar to support LED 494A and detector 494B opposite one another across the guide slot. A tie-wrap C3 is provided to strap the sensor cable to the collar C1.

4.5.4 Variant D: Presenter with Shutter

To secure the stacker and delivery module 400 and prevent dust or other foreign objects entering the system, the presenter may include a shutter which closes the exit slot when not in use. A collar D1 is provided as previously described with respect to variant C. A shutter D4, comprising a substantially U-shaped panel, fits over the collar D1 to seal the guide slot. The shutter D4 is pivotably mounted to the front and rear walls of the stacker and delivery module 400 at either end. A spring D6 is provided between a point on side bar 401E and the shutter D4 so as to urge the shutter towards its upright (closed) position. A solenoid assembly is housed within casing D8 positioned on the interior of rear wall 401D. A pin D7 disposed on the shutter D4 connects via a series of components D12 to D15 to a connecting rod D11 on one end of a plunger D10 which co-operates with electromagnet D9. When the solenoid is activated, the shutter is pulled towards housing D8, thereby uncovering the guide slot and allowing the stack of banknotes to pass therethrough. In this embodiment, an extra microswitch 491F is provided to detect opening and closing of the shutter D4. The microswitch 491F is fitted to the frame adjacent to side bar 401E at the end of collar D1 proximate pin D7.

4.5.5 Variant E: Presenter without Collar and Shutter

As a further alternative to variants B and C, the notes could be guided by a combination of bar E1, similar to bar B1 but with no inner guide pieces B3, and a guide frame E2 in their place. The guide frame E2 sits above presenter rollers 411D and E. The LED 494A and detector 494B are fitted to the underside of side bar 401E and bar E1 as arranged in variant B.

5. Vertical Transport Module 500

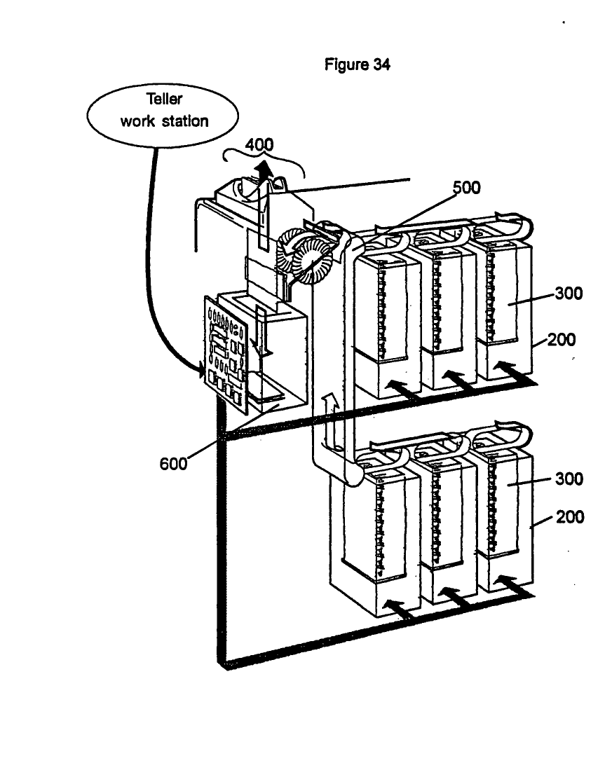

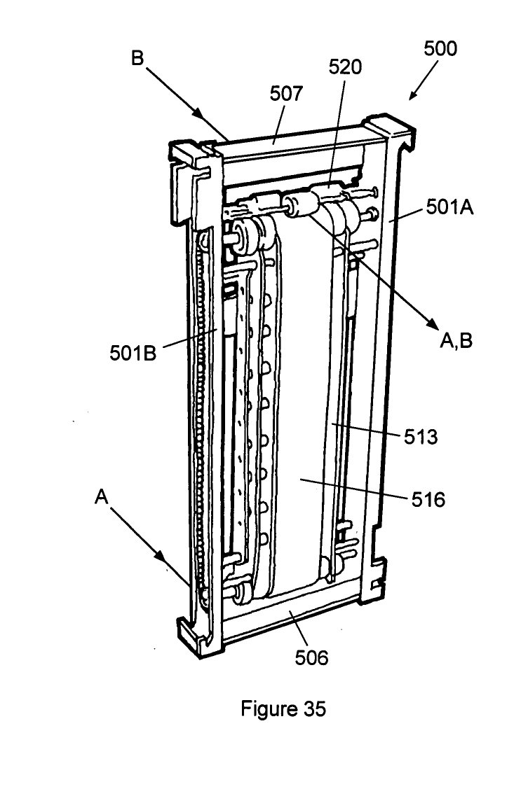

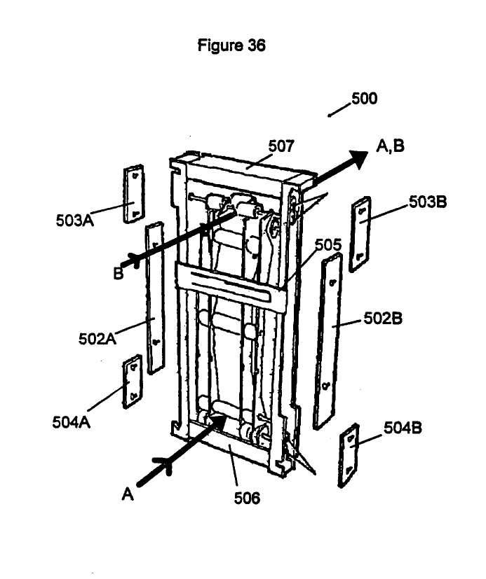

As previously described with reference to FIGS. 5a and 5b, the TCD may be provided with all its feed modules 200 on one level (FIG. 5a, see also FIG. 33) or alternatively in two rows, one above the other. A schematic diagram showing the latter case is depicted in FIG. 34. A vertical transport module 500 is required to carry banknotes dispensed from the lower row of feed modules 200 up to the stacker and delivery module 400 described in section 4. The vertical transport module 500 is situated between the endmost feed modules 200 and the stacker and delivery module 400. Banknotes from the lower feed modules 200 enter the vertical transport module 500 near its lower end and are carried upwards by a transport belt 516 to its upper extreme, where banknotes exit the vertical transport module 500 and enter the stacker and delivery module 400. Banknotes from the upper feed modules 200 enter the vertical transport module 500 at its upper end, cross the top of the transport belt 516 and exit directly into the stacker and delivery module 400.

Perspective views of the vertical-transport module 500 are shown in FIGS. 35 and 36, from the stacker and delivery module 400 side, and the feed module 200 side respectively. The dashed lines A and B indicate the paths taken by banknotes A from the lower feed modules and B from the upper feed modules. The vertical transport module 500 is supported by a frame comprising front and rear walls 501A and 501B, spaced by lower bar 506 and upper bar 507. Reinforcement is provided by plate 505 which extends between walls 501A and 501B approximately halfway up the module. When fully assembled, the walls 501A and 501B are covered by panels 502 to 504.

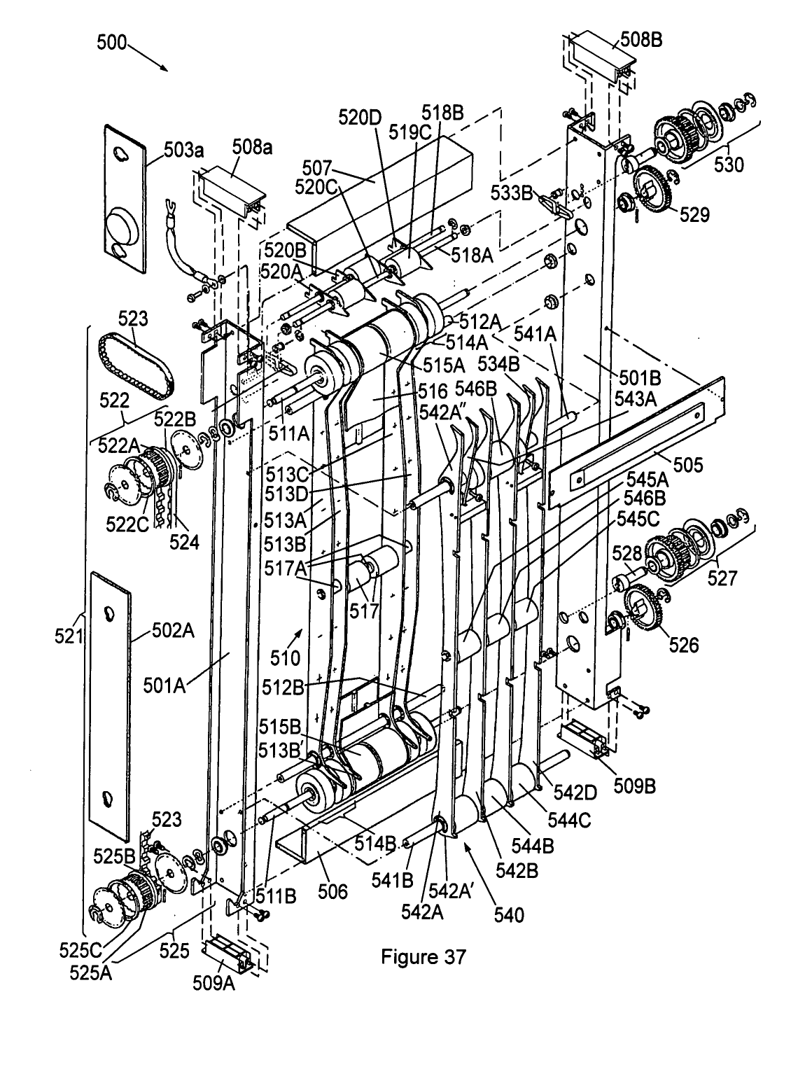

FIG. 37 shows an exploded view of the vertical transport module 500. The main functional components are the transport belt assembly 510 which moves banknotes from the bottom to the top of the module, the drive system 521 which operates the transport belt and the guide assembly 540 which supports the banknotes against the transport belt.

5.1 Transport Belt Assembly 510

The transport belt assembly 510 is supported between walls 501A and 501B by drive shafts 511A and B at its top and bottom ends respectively, as well as support shafts 512A and B. Four elongate guide ribs 513A to D extend between the top and bottom shafts and define the path taken by the banknotes through the vertical transport module 500. Each guide rib 513A to D is provided with a flat edge on its side facing the stacker and delivery module 500 and a gently curved edge on the other. At its bottom end, each guide rib is provided with a pointed finger (for example 513B′) which extends towards the transport module 260 on the endmost lower feed module 200. These direct incoming banknotes up the correct side of the transport belt assembly 510. At the top end, the guide ribs are provided with fingers (for example 513B″) which direct the banknotes away from the transport belt assembly 510 and towards the stacker and delivery module 400.

Each drive shaft 511A and B supports a series of wheels. Central wheels 515A and B hold a transport belt 516 between them. As previously described with respect to the transport belt 267 in feed modules 200 (section 2), the transport belt 516 is ridged on its inner surface and drive wheel 515A is provided with a corresponding groove. Side wheels 514A are disposed on either side of the transport belt, the fingers on guide ribs 513A to D extending therebetween.

Two further shafts 518A and B are disposed between walls 501A and 501B above wheels 514A and 515A. Between them, the shafts 518A and B support four guide fingers 520A to D spaced by three rollers 519A to C. In use, the guide fingers 520A to D and rollers 519A to C define the top surface of the transport path and guide the banknotes towards the stacker and feed module 400.

5.2 Drive System 521

The transport belt 516 is driven by wheels 515A and B which in turn are powered by the transport motor 417C in the stacker and feed module 400 (see section 4.1). Pulley assembly 522 is affixed to the front end of drive shaft 511A and includes pulleys 522A and 522B. Drive is transmitted from transport motor 417C via belt 523 which couples with pulley 522A. Another belt 524 extends between pulley 522B and a second pulley assembly 525 affixed to lower drive shaft 511B. Both pulley assemblies 522 and 525 turn in an anti-clockwise direction (as viewed from the front wall 501A) and the transport belt 516 is driven.

At their rear ends, drive shafts 511A and B affix to the rear walls 529 and 526 respectively. Upper gear wheel 529 meshes with gear assembly 530, supported on the exterior of rear wall 501B by pin 531. Similarly, lower gear wall 526 meshes with gear assembly 527, supported on pin 528. Gear assemblies 530 and 527 are provided to transmit drive to the Vertical Transport Module when the stacker is in an alternative position (not shown), and may otherwise be omitted.

Pulley assemblies 522 and 525 also transfer drive to the endmost feed modules 200. A belt (not shown) connects pulley 522A to the drive pulley 266A which operates the transport module 260 of the endmost feed module 200 on the upper level. The remaining feed modules 200 on the same level are driven by means of a “daisy chain” of belts from one drive pulley 266A to the next. Similarly, another belt (not shown) connects pulley 525A to the drive pulley 266A on the endmost feed module of the lower row.

5.3 Guide Assembly

In use, banknotes are supported against transport belt 516 by guide assembly 540. This is supported by two shafts 541A and B at its top and bottom ends respectively. Shaft 541A sits just lower than, and to one side of, drive shaft 511A, adjacent to support shaft 512A. Similarly, shaft 541B sits above drive shaft 511B, adjacent to support shaft 512B. Four elongate guide fingers 542A to D are supported between shafts 541A and B and extend vertically so as to oppose the transport belt 516. The edge of each guide finger 542A to D facing the endmost feed module 200 is flat, and the other is shaped so as to correspond to the shape of guide ribs 513A to D. In use, the banknote travels between guide fingers 542A to D and guide ribs 513A to D. The guide fingers 542A to D are provided with curved bottom ends (e.g. 542A′) and top ends (e.g. 542A″) which correspond to the shape of transport belt assembly 510 and assist in guiding the banknotes around it.

The guide assembly 540 is provided with three sets of rollers 544,545 and 546 at its bottom, middle and top ends respectively. The topmost shaft 541A also supports two additional guide fingers 546A and B which assist in guiding the banknote around rollers 514A and 515A.

Banknotes being deposited from the upper row of feed modules 200 enter the vertical transport module 500 between the top edge of the guide fingers 542A to 542D and the bottom of guide fingers 520A to D, above rollers 514A and 515A. The banknotes follow a straight line path directly through the module 500 into the stacker and delivery module 400.

6. Reject Cassette 600

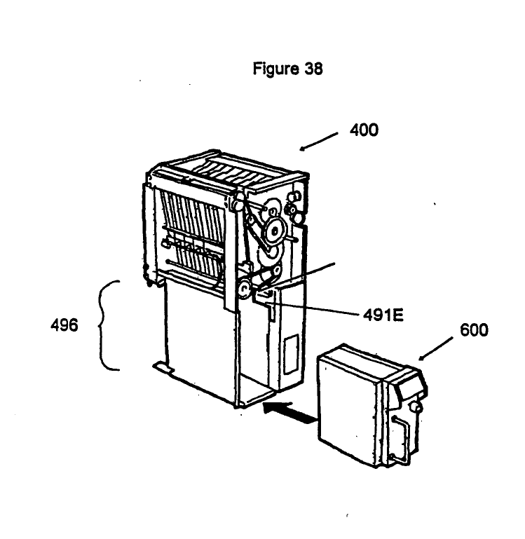

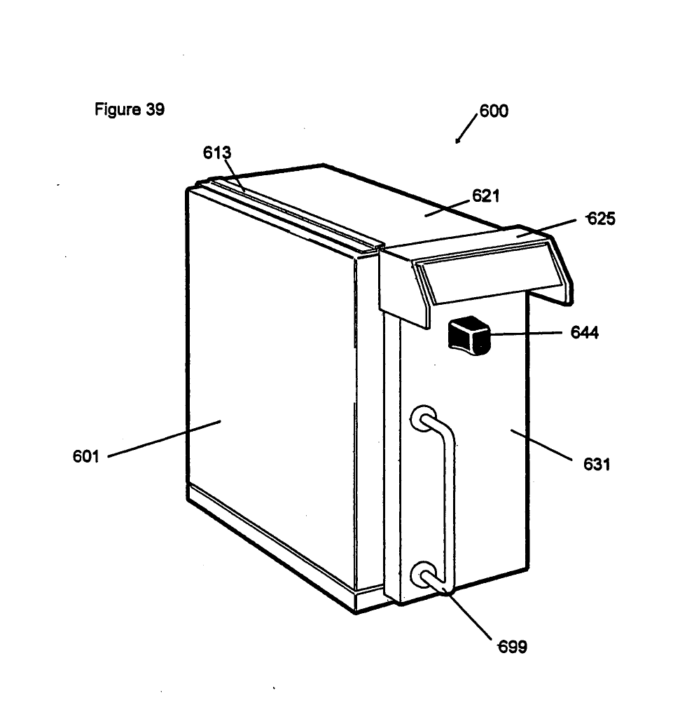

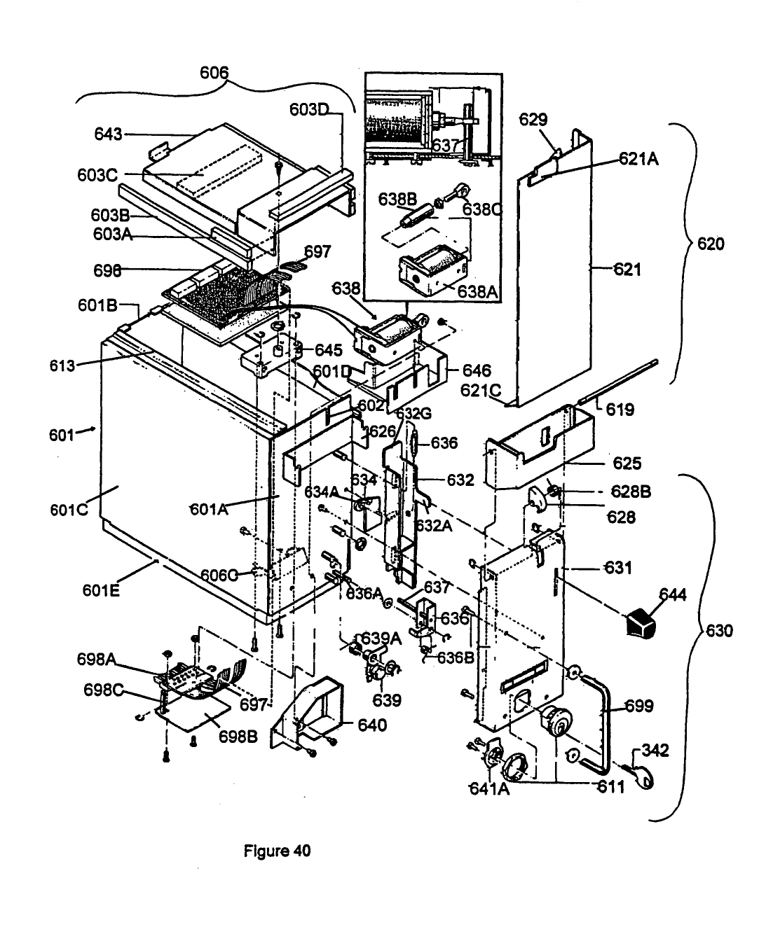

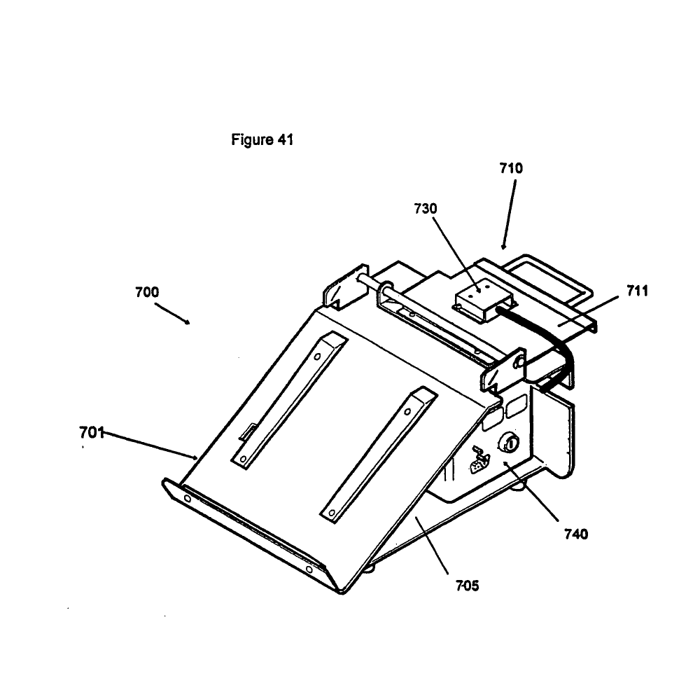

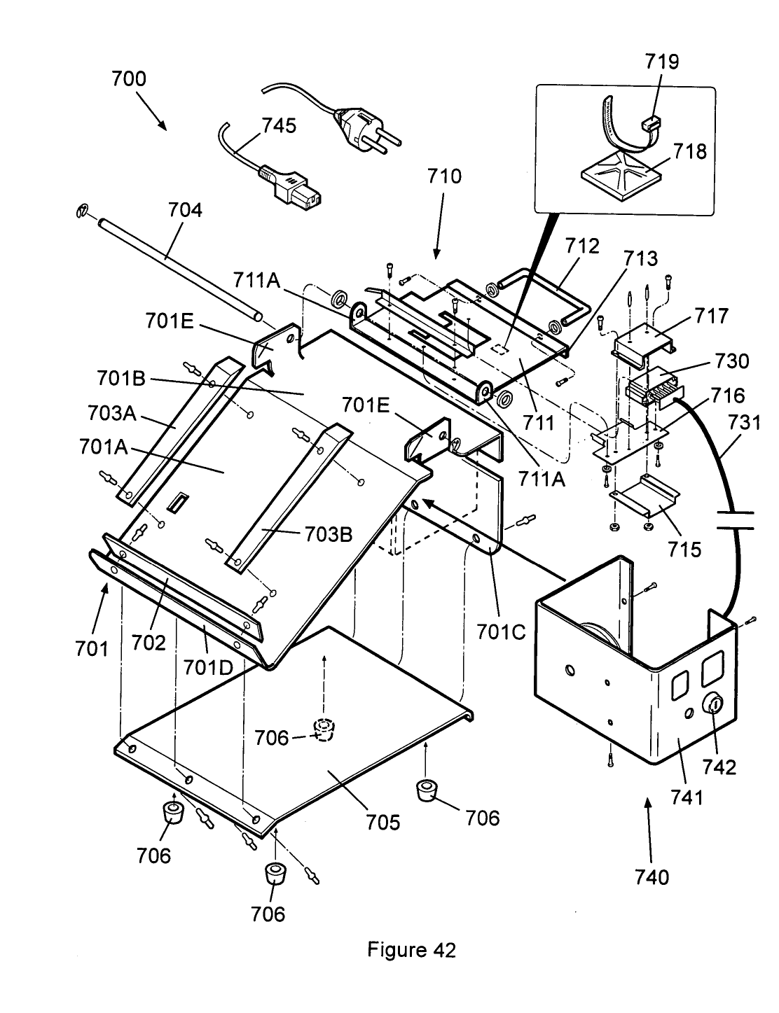

In use, the stacker and delivery module 400 is provided with a reject cassette 600 which slides into lower housing 496 as shown in FIG. 38. A switch 491E disposed on the inside of housing 496 detects the presence of a reject cassette 600 and whether its lid is open or closed. The reject cassette 600 shares many features with the feed cassette 300 described in section 3. Components having similar identical functions have therefore been labelled with reference numerals corresponding to those used in section 3, but with the prefix 6 instead of 3. FIG. 39 shows a perspective view of an assembled reject cassette 600 and FIG. 40 shows an exploded view.

The reject cassette 600 comprises a box 601, closed by a lid assembly 620 held shut by front locking assembly 630. The cassette base assembly 606 houses a PCB and, optionally, components for electronic locking of the reject cassette 600. The mechanical and electronic locks are identical to those described with respect to the feed cassette 300 in section 3.5 and will not be described again here.

The main body of the reject cassette 600 comprises a box 601 having front wall 601A, rear wall 601B, side walls 601C and D and base 601E. Unlike the feed cassette 300, there is no door and instead all four walls are permanently sealed shut. Inside the box 601, there are no guides (such as length and width guides 308 and 309 in the feed cassette 300) or an equivalent to pusher plate assembly 350. In use, when a stack of banknotes is rejected, it is dropped from the lift assembly 450 in the stacker and delivery module 400 and falls into box 601. There is no requirement to guide or otherwise support the banknotes once they are inside the reject cassette 600.

6.1 Lid Assembly 620

Lid 621 corresponds to lid 321 of the feed cassette 300 and is operable in the same manner. The lid 621 slides through guide 613, on the top of side wall 601C, and corner hinge 625 which is pivotable about axle 619. The lid 621 can thus be rotated from a horizontal to a substantially vertical position and allowed to hang down, supported by corner hinge 625, over front panel 631. The reject cassette box 601 is thus open and ready to receive rejected banknotes.

6.2 Front Locking Assembly

The locking assembly is substantially similar to that employed in the feed cassette 300 but, since there is no door on the reject cassette 600, the locking mechanism is only required to hold lid 621 closed. An elongate actuator 632 is slidably disposed on the exterior surface of front wall 601A, covered in use by front panel 631. A tab 632A on actuator 632 extends through a slot in front panel 631 where it fits to slide cover 644 which is operable by the user. A spring 636 acts between front wall 601A and actuator 632 so as to return the actuator to its upper position. In this upper position, tab 632G on actuator 632 obstructs slot 602 in the top edge of front wall 601A. Rib 629, which extends along the underside of lid 621, is thereby prevented from sliding through slot 602, and lid 621 cannot be opened.

When slide 644 is depressed by a user, tab 632G moves out of the way and allows for the passage of rib 629 through slot 602. Once lid 621 has been slid at least partially through slot 602, the same rib 629 bears against the top edge of tab 632G, holding actuator 632 in its lower position.

Locking tab 634 is pivotably disposed on the exterior of the front wall 601A and includes a protrusion 634A which couples with actuator 632. When actuator 632 is slid downwards, tab 634 pivots and extends out to one side of the reject cassette 600. In use, tab 634 engages with a slot in housing 496 underneath the stacker and delivery module 400, locking the reject cassette 600 in place.

6.3 Base Assembly 606

The base 601E of box 601 supports a PCB 696 and, if the cassette is provided with an electronic lock, solenoid assembly 638. The PCB 696 connects to a PCB connector plug 698A via cable 697 which passes through an aperture 606C in base 601E. The PCB connector plug 698A is movably mounted on a plate 698B via guide rods 698C which are slidably engaged with mount 645. The base assembly 606 is completed by a removable cover 643 which is provided with foam pads 603A to D on each side to protect it from wear.

As in the case of the feed cassette 300, if the reject cassette 600 is provided with an electronic locking mechanism, in order to open the cassette, the PCB connector plug 698A must be coupled with a corresponding socket in the loading frame 700.

7. Loading Frame 700

The TCD is typically provided with a loading frame 700 which assists the user in handling the feed cassette 300 and reject cassette 600. The loading frame fulfills two main functions. Firstly, where the cassette is provided with an electronic lock, the loading frame 700 couples with the cassette 300 or 600 in order to unlock it. Secondly, as discussed in Section 3, when banknotes are loaded into the feed cassette 300, it is important that the pusher plate assembly 350 is positioned correctly so as to exert the right degree of pressure on the stack of banknotes. The loading frame 700 is equipped with a support surface 701 which holds the feed cassette 300 in the correct orientation for achieving the required pressure.

The loading frame consists of three main functional parts: the support surface 701, a connector bracket assembly 710 and a control system 740.

7.1 Support Surface 701

The main body of loading frame 700 comprises a support plate 701 mounted to a base 705. The support plate includes a feed cassette support surface 700A which is inclined relative to the base 705. A lip 701D is provided at the lower end of support surface 701A which adjoins, at its top end, a reject cassette support surface 701B. This portion of the support plate 701 is substantially parallel to the base 705. The support plate 701 is completed by rear wall 701C which extends vertically between reject cassette support surface 701B and the base 705.

The feed cassette support surface 701A is provided with a guide strip 702, affixed to lip 701D, and guide wedges 703A and B on top of surface 701A, which together hold the feed cassette 300 in the desired orientation.

The reject cassette support surface 701B is provided with tabs 701E at either side which in use support the connector bracket assembly 710 between them on axle 704.

The base 705 is provided with four base pads 706 which ensure the loading frame sits level on the work surface.

7.2 Connector Bracket Assembly 710

Connector bracket assembly 710 is pivotably mounted to support plate 701 by means of axle 704. The connector bracket 711 consists of a plate having tabs 711A, through which axle 704 passes, and aperture 711B into which the PCB connector socket 730 fits. The bracket 711 does not extend the full distance between tabs 701B so it may also be slid along axle 704. A flange 713 is affixed to the plate 711 at its end furthest from axle 704, on which is mounted a handle 712. Another flange 714 is provided at the other end to help reinforce the bracket 711. A mount plate 716 fits underneath aperture 711B and supports a PCB connector plug 713 between covers 715 and 717. A harness mount 718 and strap 719 are disposed adjacent to aperture 711B and in use restrain a cable 731 which connects PCB connector socket 730 to the control system 740.

7.3 Control System 740

The control system 740 is housed in a casing 742 located underneath reject cassette support surface 701B. The control system includes a power supply, to be connected to the mains via cable 745, and a PCB which is configured to unlock a feed cassette 300 or reject cassette 600. The PCB is activated by means of lock 742, provided with a key switch (not shown) which in turn operates the PCB.

7.4 Use of Loading Frame 700

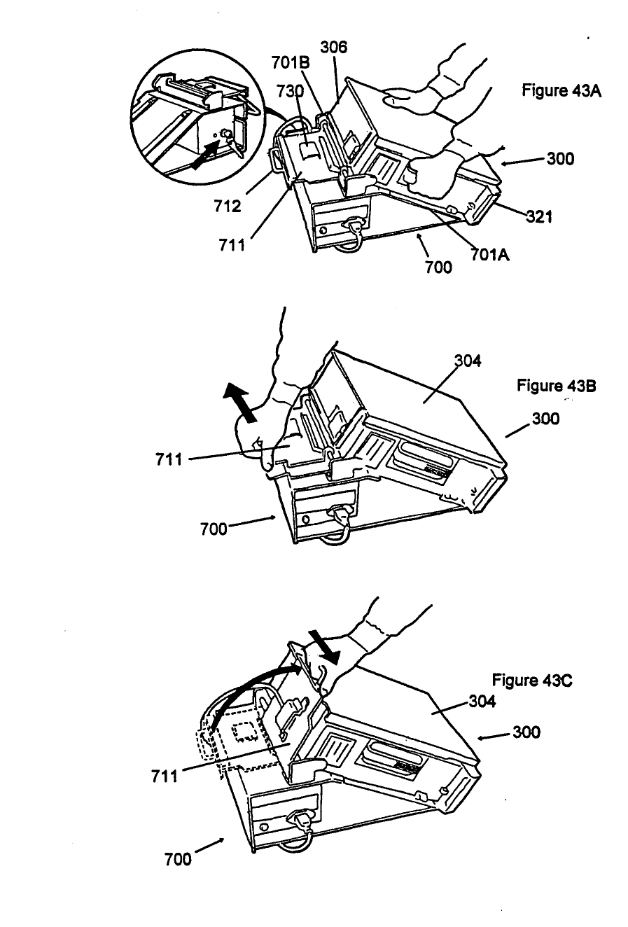

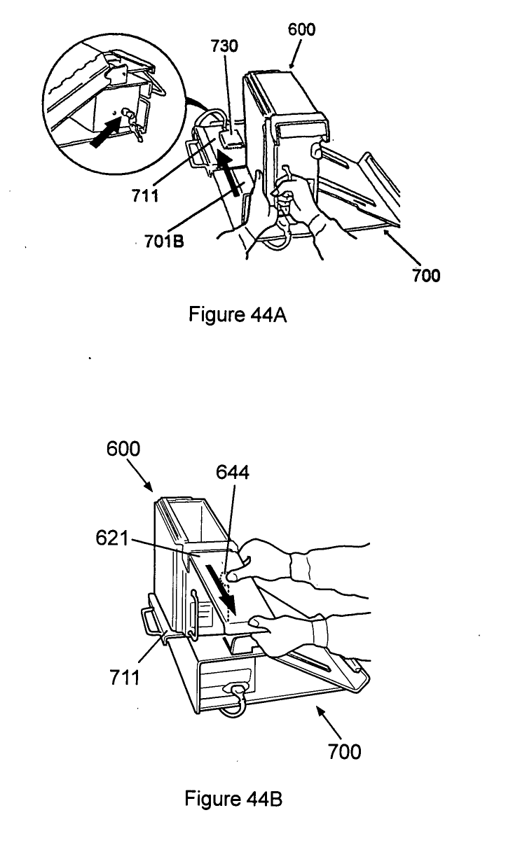

The mode of operation differs according to the type of cassette to be unlocked. FIGS. 43 and 44 depict the use of the loading frame 700 in conjunction with a feed cassette 300 and reject cassette 600 respectively.

7.4.1 Use of Loading Frame 700 with Feed Cassette 300

A feed cassette 300 is positioned on support surface 701A as shown in FIG. 43A. The lid 321 of the feed cassette 300 is positioned against the guide 702 on lip 701D of support plate 701. The base 306 of the feed cassette 300 faces towards bracket assembly 710, exposing the PCB connector plug 398A on the underside of feed cassette 300. The connector bracket 711 is positioned against the tab 701B furthest from connector plug 398A.

Using handle 712, the user lifts the bracket 711, pivoting it about axle 704 so as to bring it into contact with base 306 of the feed cassette 300. In this position, the bracket 711 is slid along axle 704 towards the front of cassette 300, thereby coupling the PCB connector socket 730 to the PCB connector plug 398A. The feed cassette 300 is unlocked allowing opening of door 304. The feed cassette 300 can be reloaded with banknotes and the pusher plate assembly easily adjusted to the appropriate position to exert the correct pressure on the stack of banknotes.

7.4.2 Use of Loading Frame with Reject Cassette

With the connector bracket 711 in its lower (flat) position, resting on support surface 701B, a reject cassette 600 is placed onto the loading frame 700 as shown in FIG. 44A and slid towards PCB connector socket 730. The PCB connector plug 698A on the base of reject cassette 600 couples with the PCB connector socket 730 and the reject cassette is unlocked allowing lid 621 to be slid open as shown in FIG. 44B. Rejected banknotes contained inside the reject cassette 600 can then be removed.

8. Electronic Control System

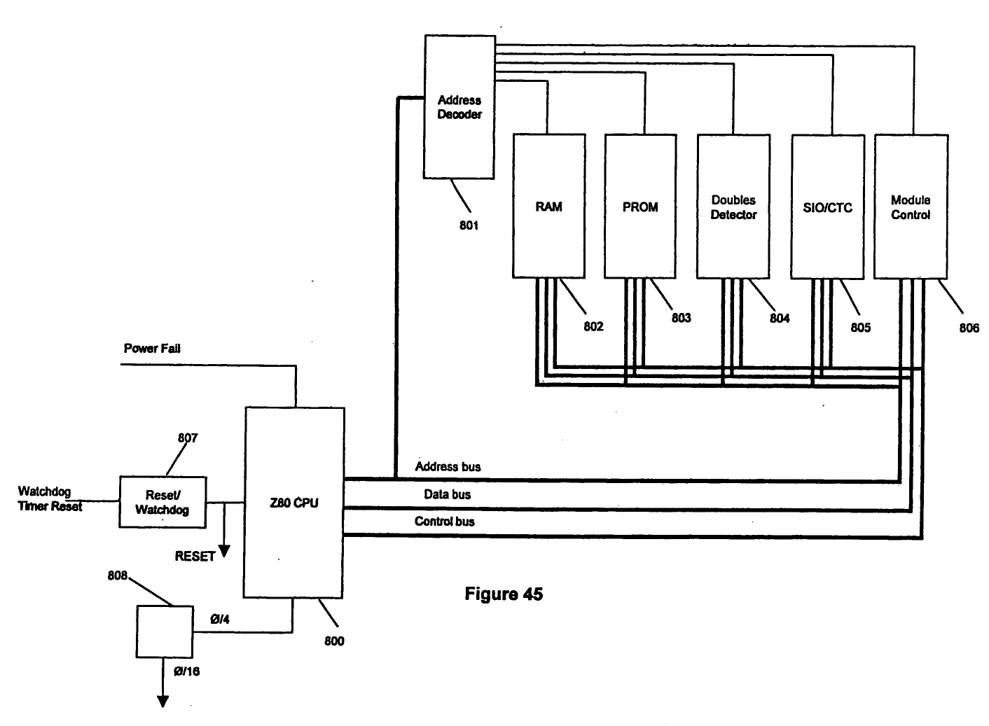

The cash dispensing apparatus comprises an electronic control system that controls and monitors its operation. A block diagram of the electronic control system is shown in FIG. 45.

8.1 Central Processing Unit

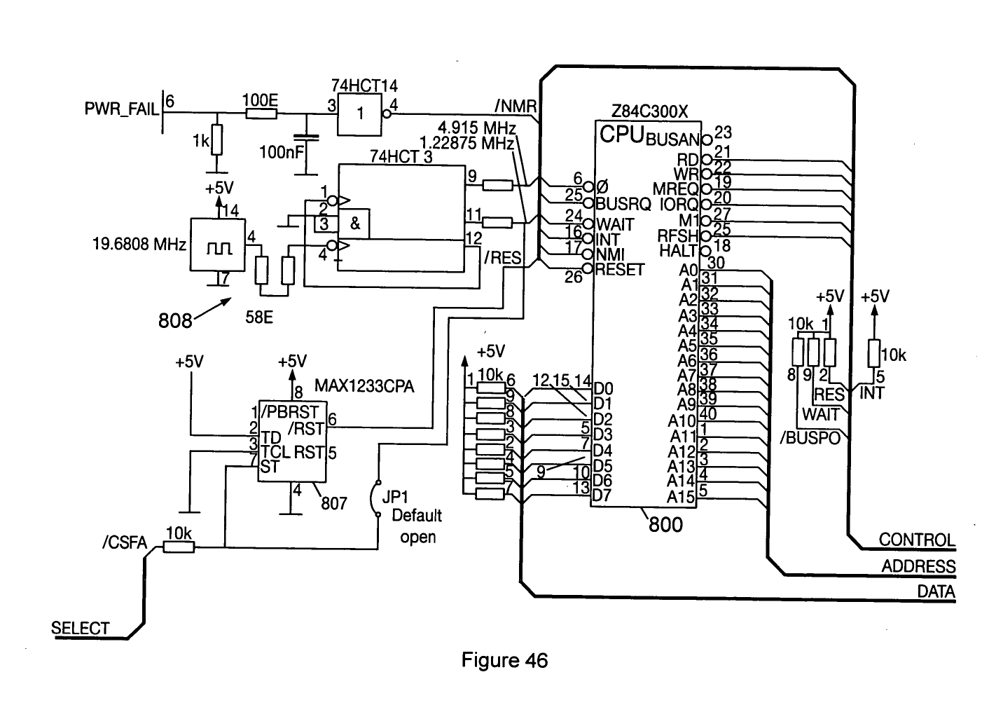

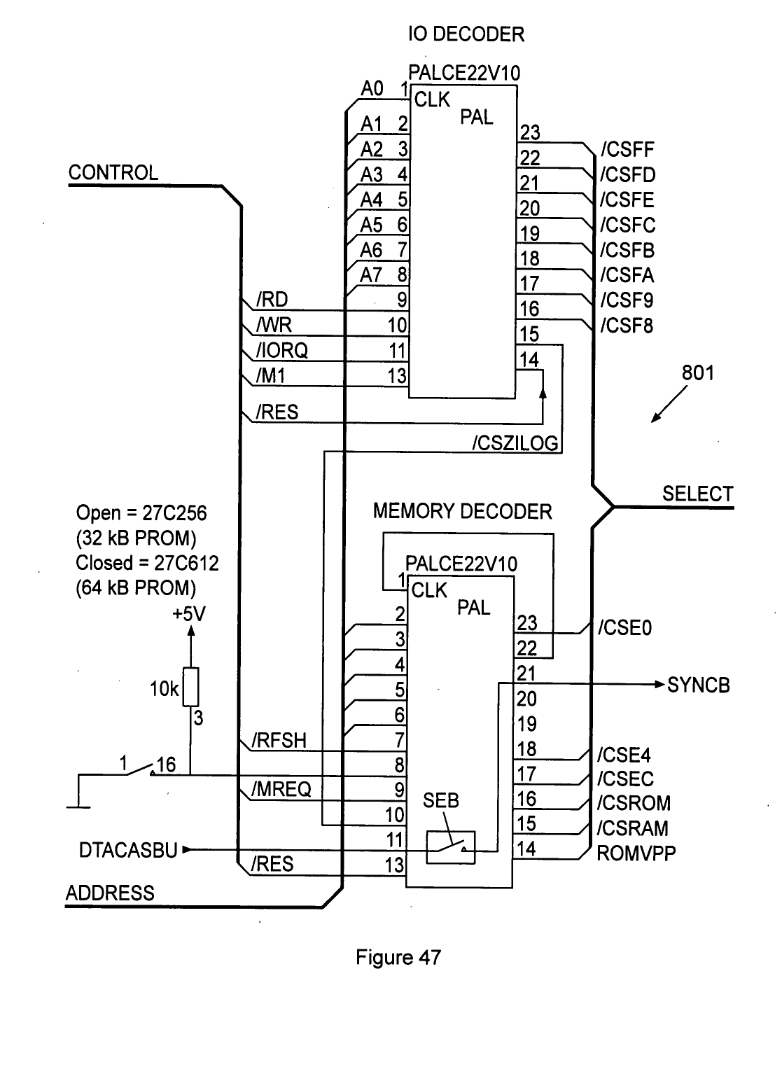

The central processing unit (CPU) is shown in detail in FIG. 46, as well as schematically in FIG. 45. It comprises a Z80 microprocessor 800. This is a very well known microprocessor that has an 8 bit data bus and 16 bit address bus along with various control signals forming a control bus. Thus, the microprocessor 800 can individually address any one of 65536 8 bit bytes. It also has separate memory request and input/output (I/O) request signals, and as such the I/O resources can be mapped into a separate I/O space rather than occupying part of the memory.

The system clock is generated by a crystal oscillator and divider circuit 808. This comprises a crystal oscillator that produces a 19.6608 MHz output. This clock frequency is divided by four using a counter circuit to provide the master clock frequency used by the microprocessor 800. At the same time, the oscillator output is divided by 16 to provide a time reference at a quarter of the master clock frequency for a counter timer circuit described later.

The CPU also comprises a reset and watchdog circuit 807. This has two functions. Firstly, it monitors the 5 volt supply that the control system is powered by. If this falls below a preset threshold then it will apply a reset signal to the microprocessor 800 and other circuitry of the control system. Thus, during power up, power down and low voltage conditions, the microprocessor is held in a reset condition.

The second function is the monitoring of software execution. The watchdog performs this by resetting the microprocessor 800 if the watchdog timer times out. This timer is periodically reset by the microprocessor 800 by writing to the address 00FA in the I/O space where the watchdog timer is located. The period between such writes is less than the timeout period (nominally 1.2 seconds, worst case 500 milliseconds). Thus, if the microprocessor 800 should crash then the watchdog circuit 807 will reset the microprocessor 800.

The microprocessor 800 can respond to two types of interrupt signal. The first is a non-maskable interrupt (NMI) and this is triggered by the power fail signal supplied by the power supply. In case of power failure the microprocessor 800 can save critical data in a battery powered random access memory (RAM). The second type of interrupt, which is maskable, is used by the serial input/output and counter timer circuit to interrupt the normal progress of instruction execution as described later.

8.2 Address Decoder

The address decoder 801 is shown in FIG. 46. It is a combinational logic circuit that monitors the 16 signal lines forming the address bus and asserts a corresponding one of 14 select signals depending on the address on the address bus.

The address decoder 801 is realised using two programmable array logic (PAL) integrated circuits. The first PAL, known as the I/O decoder, provides select signals for devices that are mapped in the I/O space whilst the second PAL, known as the memory decoder, provides select signals for devices mapped in the memory space.

The table below shows the relationship between the address on the address bus and the select signal asserted when the memory request signal is asserted:

| Hexadecimal address | Description |
|---|---|
| 0000-7FFF | 32 kilobyte PROM (803) |
| 0000-DFFF | 56 kilobyte PROM (803) |
| E000-FFFF | 8 or 32 kilobyte RAM (802) |

The table below shows the relationship between the address on the address bus and the select signal asserted when the I/O request signal is asserted:

| Hexadecimal | | | |
|---|---|---|---|
| address | Data bit | Description | Direction |
| E0-E3 | D0 | Lock solenoid | Out |
| | D1 | Alarm relay | |
| | D2 | Lock buzzer | |
| | D3 | Lock LED 1 | |
| | D4 | Lock LED 2 | |
| | D5 | Data to cassette | |
| | D6 | Load shift register | |
| | D7 | Cashier solenoid | |
| E4 | | Data, serial port A | In/Out |
| E5 | | Control/status, serial port A | In/Out |
| E6 | | Data, serial port B | In/Out |
| E7 | | Control/status, serial port B | In/Out |
| E8 | | Enable/disable feedthrough of | Out |
| | | SYNCB | |
| EC | | Baud rate, serial port A | In/Out |
| ED | | Baud rate, serial port B | In/Out |
| EE | | Timing, internal SW use | In/Out |
| EF | | Timing, CPU interrupt | In/Out |
| F8 | D0-D6 | DD gain data, sensor A | Out |
| | D7 | DD sample/hold | |
| F9 | D0-D6 | DD gain data, sensor B | Out |
| | D7 | LED on control board | |
| FA | | Watchdog | |
| FB | D0-D3 | Module address | Out |
| | D4 | Feed solenoid | |
| | D5 | Relay | |
| | D6 | Main motor | |
| | D7 | Lift motor | |
| FC | D0 | SW1, MSB | In |
| | D1 | SW1 | |
| | D2 | SW1 | |
| | D3 | SW1, LSB | |
| | D4 | SW2: 8 | |
| | D5 | SW2: 7 | |
| | D6 | SW2: 6 | |
| | D7 | SW2: 8 | |
| FD | D0 | Cassette ready | In |
| | D1 | Cleaning fingers home | |
| | D2 | Data from cassette | |
| | D3 | Cassette not in position | |
| | D4 | Note in delivery throat | |
| | D5 | Low level | |
| | D6 | SW2: 2 | |
| | D7 | Feeder count signal | |
| FE | D0, 2, 4, 5 | Note thickness, DD sensor A | |
| | D1, 3, 6, 7 | Note thickness, DD sensor B | |
| FF | D1 | Power failure | In |
| | D1 | SW2: 3 | |
| | D2 | Safety switch closed | |
| | D3 | Alarm loop present | |
| | D4 | Door unlocked | |
| | D5 | Start timer | |
| | D6 | Delivery lift busy | |
| | D7 | Load/OP switch | |

The memory decoder also has the special function of enabling or disabling feed through of a data signal, DTACASBU, from the cassette to a signal SYNCB supplied to the serial input/output circuit, described later.

8.3 Memory

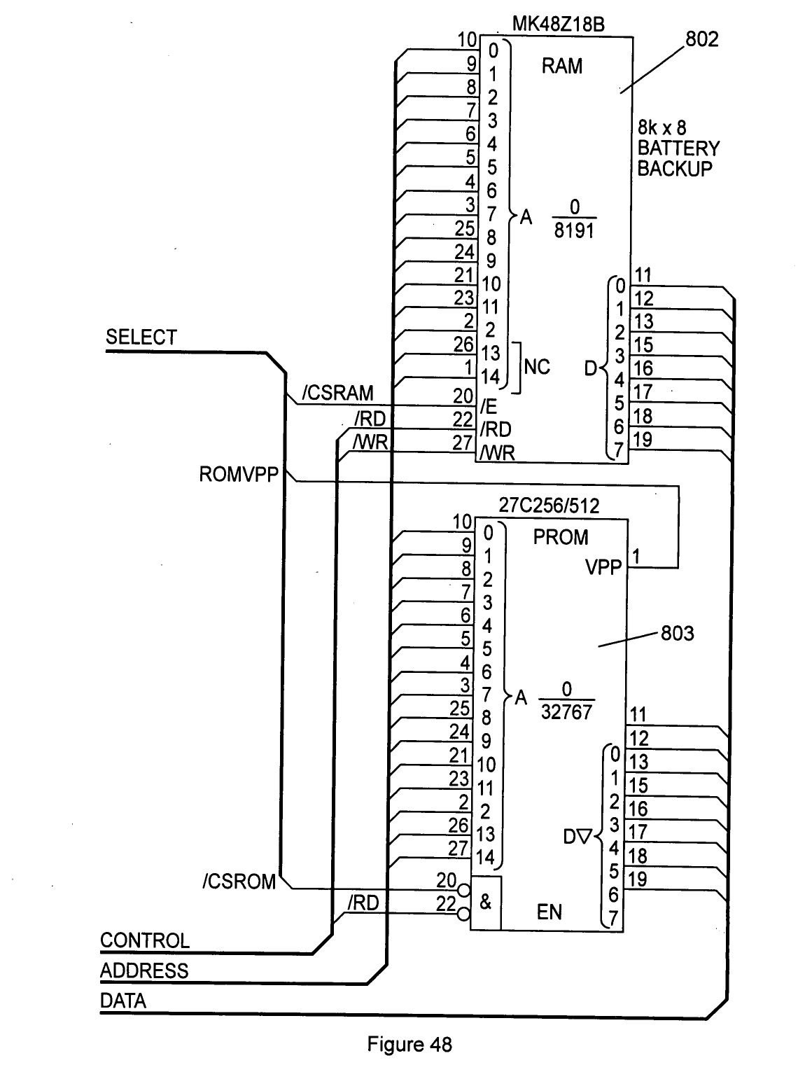

The memory space is shared between a random access memory (RAM) 802 and a programmable read only memory (PROM) 803. These are shown in FIGS. 45 and 48. The RAM has an internal lithium battery that allows vital data to be retained during power failure. It is also provided with a circuit that disables write attempts to the RAM 802 when the power supply voltage is below a certain level. As mentioned in section 8.2, the RAM may be either 8 or 32 Kbytes and occupies the memory space beginning at address E000.

The PROM 803 can be either a 32 Kbyte or 64 Kbyte device occupying the address space beginning at 0000. In the case of a 32 Kbyte PROM, this occupies the space up to address 7FFF. However in the case of a 64 Kbyte PROM only the lower 56 Kbytes are addressable (i.e. up to address DFFF) since otherwise there would be a clash with the address space occupied by the RAM.

8.4 Double Detect and Note Counting Circuit

The double detect and note counting circuit 804 has the function of receiving signals from a pair of sensors (see section 4.4) and processing the signals to count the number of notes that pass from the transport into the presenter unit and to detect the passage of two notes simultaneously.

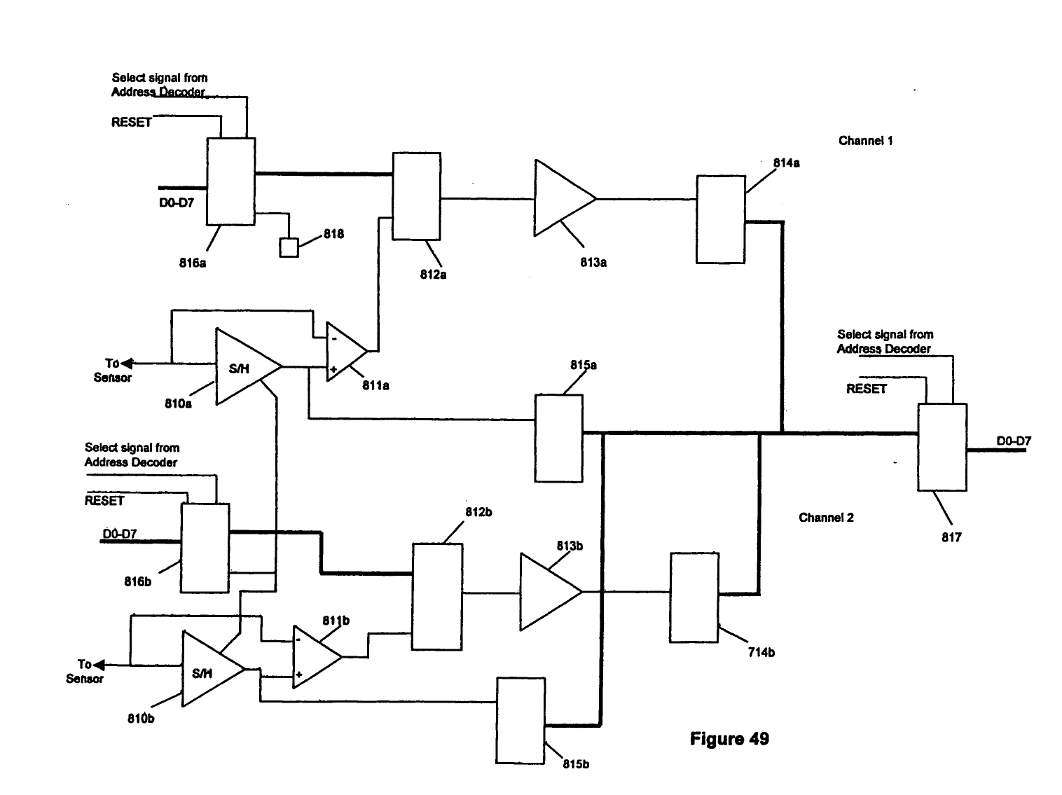

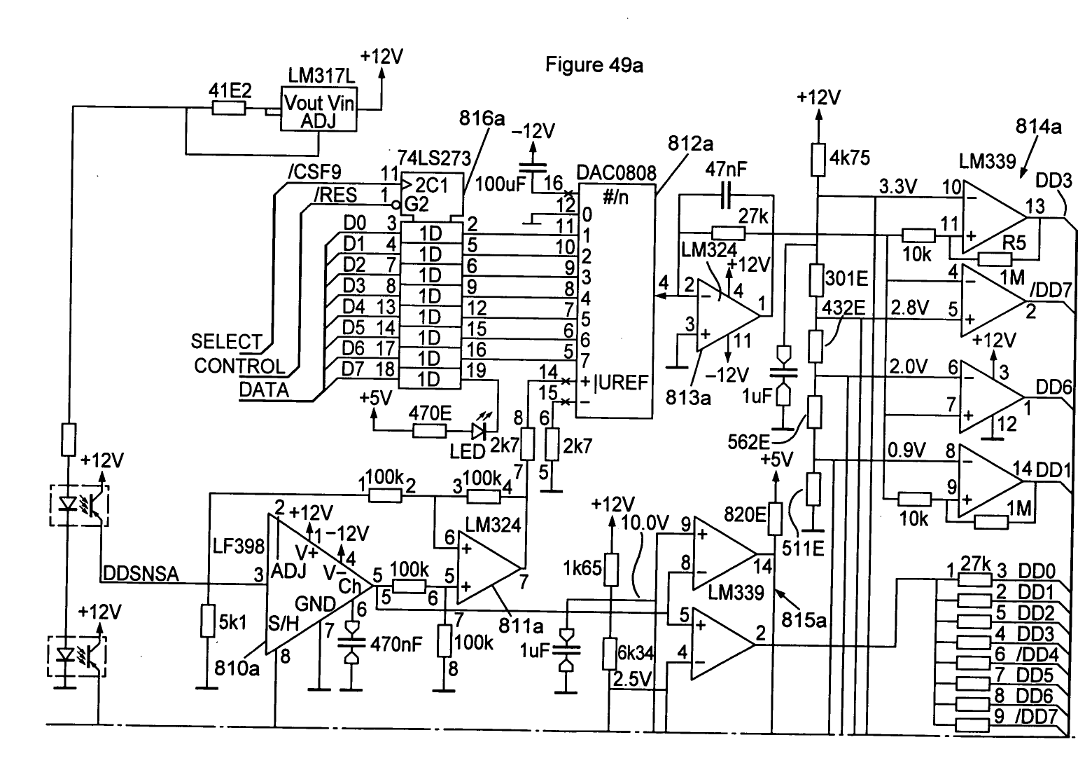

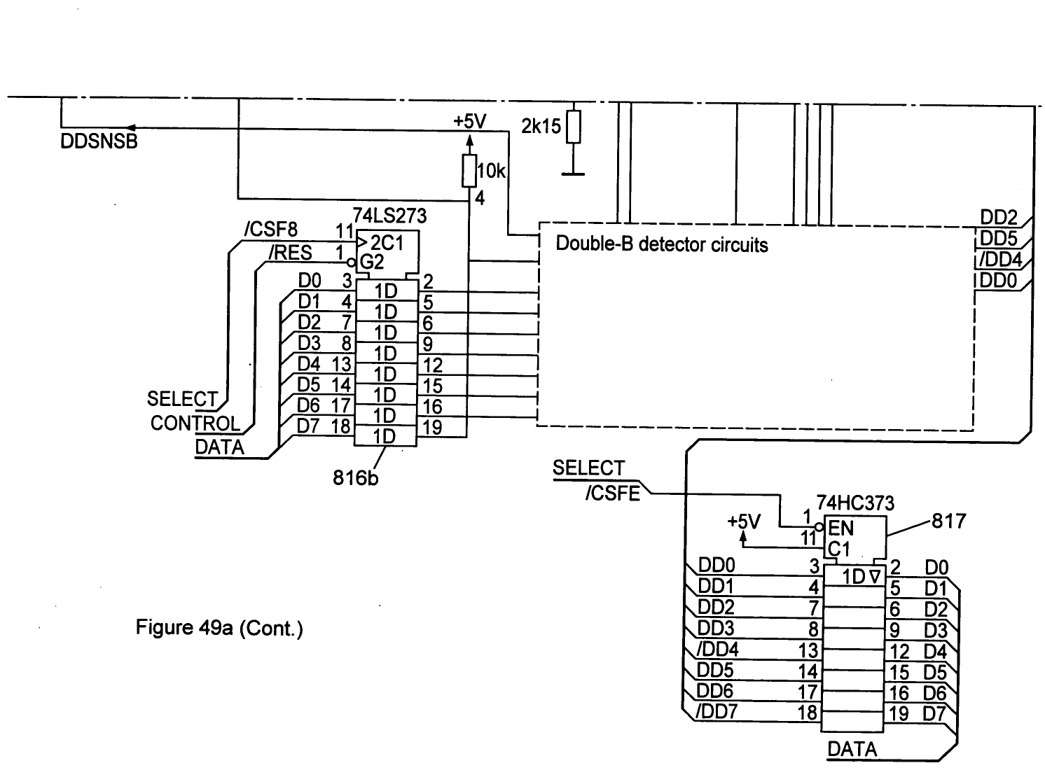

The double detect and note counting circuit 804 is shown in a block diagram in FIG. 49, and in further detail in FIG. 49a. There are two channels, one for each sensor. Each channel comprises a sample and hold circuit, a differential amplifier, a digital gain controlled amplifier, a level detector and a sensor fault detector. The operation of these will be described below.

8.4.1 Sensor

As previously described, the sensors are mounted on the presenter unit. Each one consists of an infrared slotted opto-coupler. A lever arm is disposed within a slot of each sensor, and is adjusted to interfere partly with the lightbeam when no note is under the lever arm. When a note passes under the lever arm, it is moved by an amount proportional to the thickness of the note such that the infrared beam is further obscured. Hence, the output current from the phototransistor in the opto-coupler is reduced in proportion to the note thickness.

8.4.2 Sample and Hold Circuit

Each channel has its own sample and hold circuit 810a, 810b that is used to take a sample of the signal level output by the respective sensor when no note is present under the lever arm and hold this level during subsequent processing.

The sample and hold circuits 810a, 810b are placed in the hold state by the software executing on microprocessor 800 when the transport motor is running and in the sample state when the transport motor is stopped. In order to place the sample and hold circuits 810a, 810b in the hold state, the software writes a binary “1” to bit D7 of I/O address F8.

8.4.3 Differential Amplifier

The differential amplifiers 811a and 811b monitor the difference between the output from the respective sample and hold amplifier 810a and 810b and the present signal provided by the respective sensor. As such, when the sample and hold amplifier 810a is in the hold state, the differential amplifier 811a output represents the difference between the sensor output when no note is present under the lever arm and when a note is present.

8.4.4 Programmable Gain Amplifier

The output from each differential amplifier 811a,811b is fed through a respective resistor to the reference current input of a respective digital-to-analogue converter (DAC) 812a,812b. The digital input to each DAC 812a,812b is supplied from a respective latch 816a,816b that will be described later. The digital input to each DAC 812a,812b is only 7 bits wide, the most significant bit being hardwired to a digital value of zero.

A fraction of the reference current supplied from each differential amplifier 811a,811b to the respective DAC 812a,812b is fed to a respective current to voltage converter 813a, 813b. These produce output voltages which are proportional to the fraction of the reference current. This fraction depends on the digital value expressed in decimal, D, at each DAC's digital input. The output voltage of each current to voltage converter 813a,813b is configured to be equal to 10 times the output voltage of the differential amplifier 811a,811b multiplied by a scaling factor of D/128 (where D equals the digital value).

8.4.5 Level Detector

Each level detector 814a,814b receives the output signals from the respective current to voltage converter 813a,813b to which it is connected and asserts one of four outputs depending on the detected level. These four outputs are connected to a latch 817 which will be described later. The following table indicates the meanings of the possible detected levels:

| Detected level | Description |
|---|---|
| <1.0 V | No note |
| 1.0 V-2.0 V | Gain too low |
| 2.0 V-2.8 V | Correct level for one note |
| 2.8 V-3.3 V | Gain too high |
| >3.3 V | Double note |

8.4.6 Sensor Fault Detector

Each sensor fault detector circuit 815a,815b comprises two comparators which receive the output signal from the respective sample and hold amplifier 810a,810b and pull down all eight inputs to the latch 817 if the signal level at the output of the respective sample and hold amplifier 810a,810b is below a first predetermined threshold or exceeds a second predetermined threshold.

8.4.8 Interface Circuit

The interface circuit comprises three latches 816a,816b and 817 that provide an interface between the two channels of the double detect and note counting circuit and the data bus.

Latches 816a and 816b latch the 8 bits of the databus when an I/O write occurs to addresses F9 and F8 respectively. In either case, when such a write occurs, the address decoder 801 will output a respective select signal that will cause the latch 816a or 816b to latch the contents of the data bus. In both cases, the least significant 7 bits are used as previously described to provide a digital gain value to the digital-to-analogue converters 812a and 812b. The most significant bit of latch 816a is used to illuminate an LED 818 whilst the most significant bit of latch 816b is used to toggle the sample/hold signal for the sample and hold amplifiers 810a,810b.

The latch 817 latches each 4 bit output from the two level detectors 814a and 814b and maps these onto the eight bits of the data bus when an I/O write occurs to address FE causing the corresponding select signal to be asserted by the address decoder 801. However, if a sensor fault is detected by one of the sensor fault detectors 815a,815b then all eight inputs to the latch 817 are pulled down as already described, and the corresponding data outputs on both channels will be zero.

8.5 Serial Interface and Counter Timer Circuit

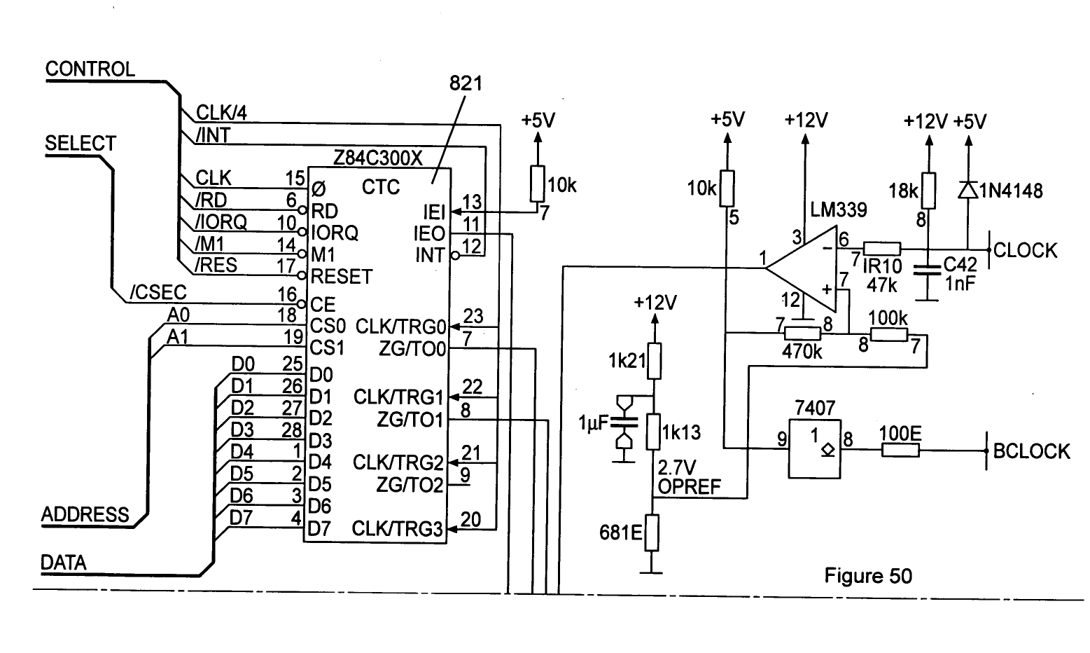

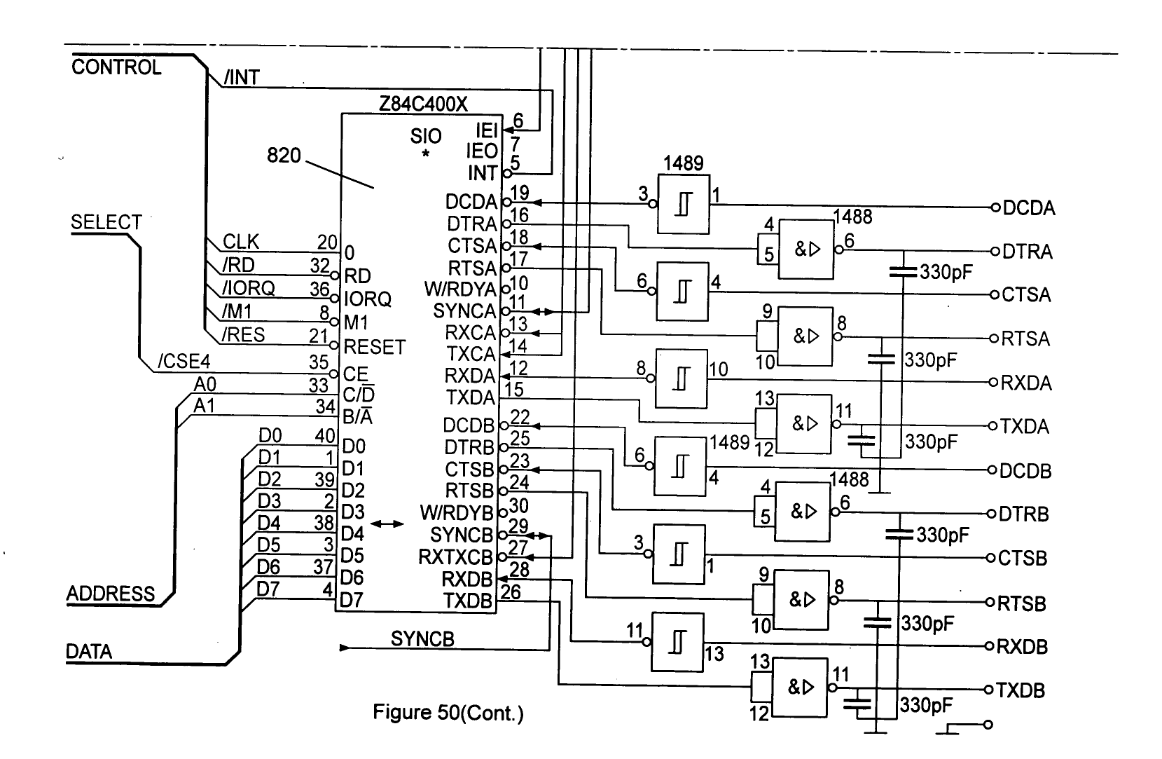

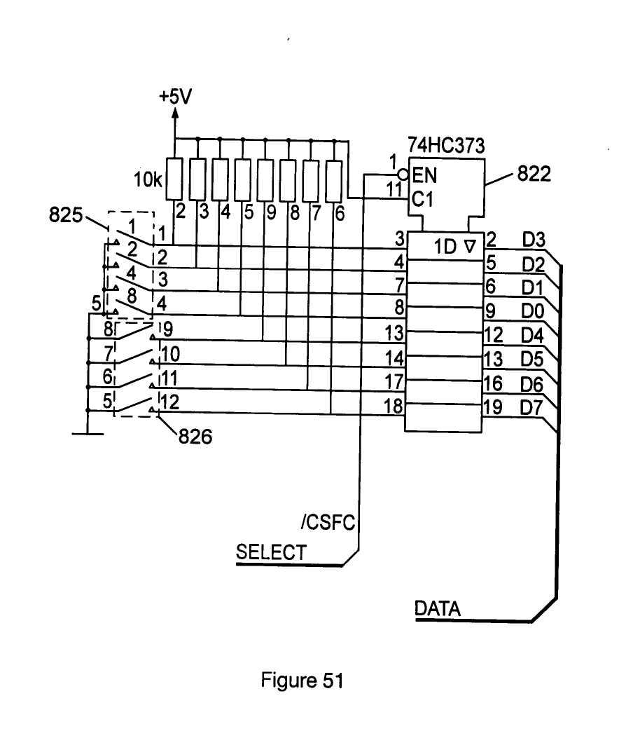

The serial communications and counter timer circuit 805 is shown in FIGS. 50 and 51. It comprises a serial input/output device 820, a counter timer circuit 821 and a latch 822.

8.5.1 BAUD RATE AND TIMER GENERATOR

The counter timer circuit (CTC) 821 has four timer channels. The timing signals in all four cases are derived from the divided-by-16 clock signal received from the crystal oscillator 808.

The first and second channels are used as baud rate generators for the serial input/output (SIO) device 820 whilst the second two channels are used for software timing purposes.

8.5.2 Serial Input/Output Circuit

The serial input/output device 820 is a two channel asynchronous serial input/output interface. It converts parallel data received from the data bus into serial data that is output to one of two RS232 serial ports 823 and 824, and vice versa.

The serial input/output device 820 also has two inputs which can be used to interrupt the microprocessor. The first of these is connected to the transport clock and measures the speed of the note transport. The transport clock is generated by disc 423 and optical sensor 424A (see FIG. 22A). As the transport runs, the microprocessor 800 is interrupted at a frequency that depends on the transport speed.

The second input is fed with data supplied from one of the cassettes. The data is received via the switch in the address decoder 801 which has been described already. When the address E8 is written, the switch closes and the signal from the cassette, DTACASBU, is fed to the serial input/output device 820 as signal SYNCB, thereby generating interrupts to the microprocessor 800. When address E8 is written to again the switch opens.

8.5.3 Baud Rate and Test Switch

The four least significant bits of latch 822 (see FIG. 51) are connected to a 16 position rotary switch 825 that has the function of selecting the baud rate and parity of serial communications. This switch setting can be read to determine the selected baud rate and parity, and the counter timer circuit 821 set accordingly. The selected baud rate and parity are as shown in the table below:

| Position | Parity | Baud rate | Test mode |
|---|---|---|---|
| 0 | Even | 110 | Select hopper 0 |
| 1 | Even | 300 | Select hopper 1 |
| 2 | Even | 600 | Select hopper 2 |
| 3 | Even | 1200 | Select hopper 3 |
| 4 | Even | 2400 | Select hopper 4 |
| 5 | Even | 4800 | Select hopper 5 |
| 6 | Even | 9600 | Select hopper 6 |
| 7 | Even | 19200 | Not used |
| 8 | Odd | 110 | Not used |
| 9 | Odd | 300 | Not used |
| 10 | Odd | 600 | Not used |
| 11 | Odd | 1200 | Not used |
| 12 | Odd | 2400 | Not used |
| 13 | Odd | 4800 | Not used |
| 14 | Odd | 9600 | Not used |
| 15 | Odd | 19200 | Initialize |

The four most significant bits of latch 822 are connected to four ways of an 8 way DIP switch 826 that is operable to indicate whether a shutter is fitted to the presenter unit (although this feature is not presently used) and whether the unit is in a test mode or a normal operational mode. In the test mode, the rotary switch 825 is used to select different test positions rather than baud rate as shown in the above table. The following table shows the functions associated with the four ways of an 8 way DIP switch 826:

| DIP switch way | Function |
|---|---|
| 5 | Off = No shutter, On = Shutter |
| 6 | Not used |
| 7 | Not used |
| 8 | Off = 0peration, On = Test mode |

8.6 Module Controller

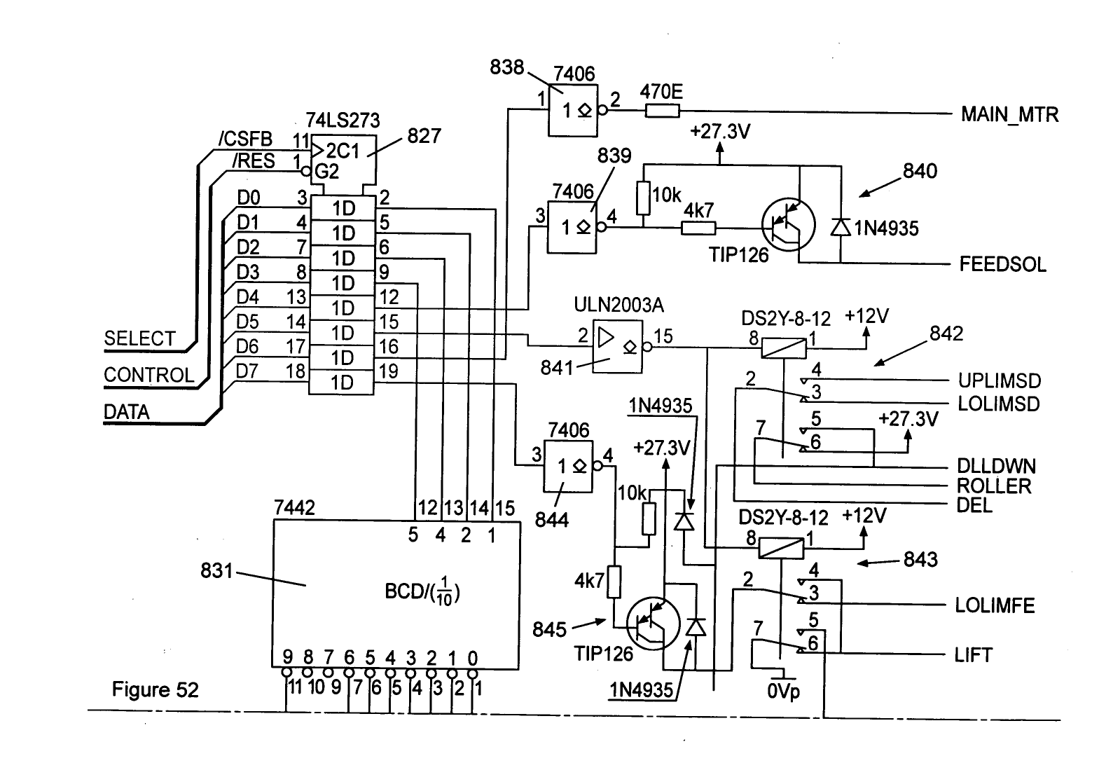

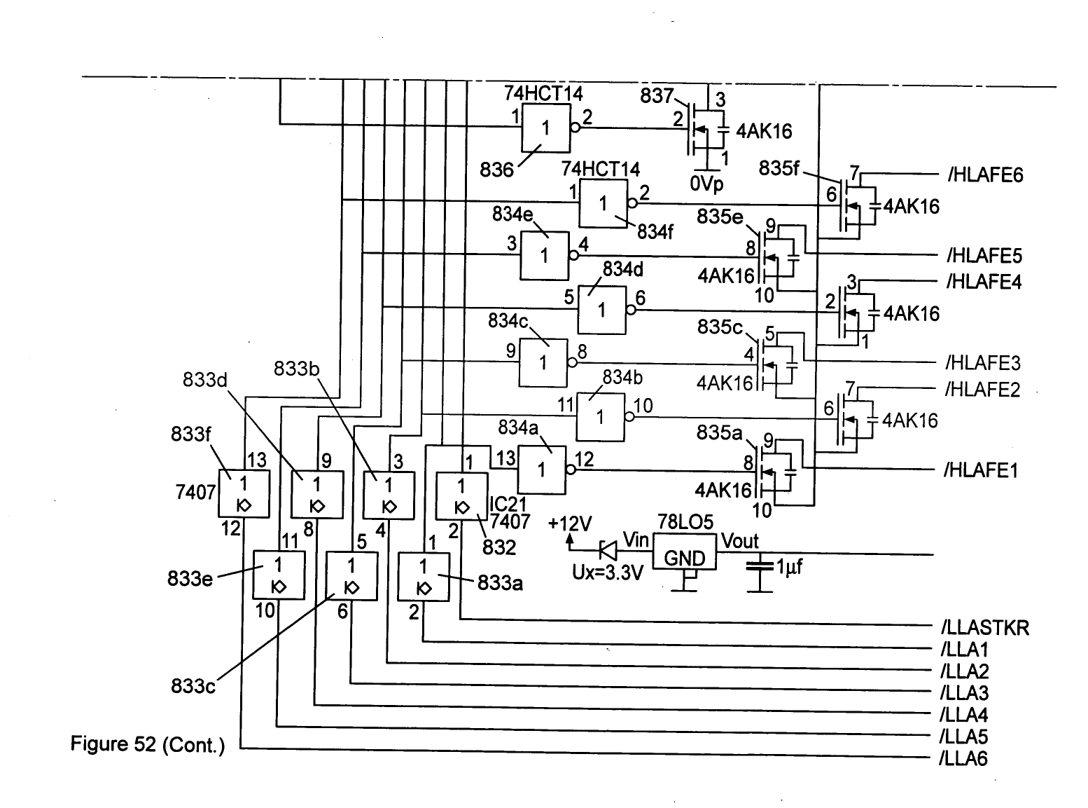

The module controller is shown in FIGS. 52 to 55. It interfaces with and controls the individual feed modules and the stacker and delivery module. It also interfaces with the cassettes when they are loaded into the respective feed modules. The module controller interfaces with the CPU via two 8 bit output ports and two 8 bit input ports.

8.6.1 Module Control Circuit Interface

The module control-circuit interface comprises two output latches and two input latches. The first output latch 827 latches the 8 bits of the data bus when data is written to the I/O address FB. Similarly, the second output latch 828 latches the 8 bits of the data bus when data is written to the I/O address E0.

The first input latch 829 latches the states of eight status lines which are latched onto the data bus when an I/O read occurs at address F0. The second input latch 830 performs a similar function with eight other status lines when an I/O read occurs at address FF.

8.6.1.1 First Output Latch

Only one of the feed modules and the stacker and delivery module can be addressed at any one time. The addressing function is performed by the first four bits of latched data from the first output latch 827 which are connected to a binary-coded-decimal (BCD) to decimal decoder 831. This is responsive to the four least significant latched data bits to negate one of its outputs.

The first of these outputs is buffered to produce a signal designated LLASTKR which is used to address the stacker and delivery module. The next six outputs from BCD to decimal decoder 831 are connected to respective buffers 833a to 833f and to respective inverting buffers 834a to 834f. The outputs from buffers 833a to 833f form signals LLA1 to LLA6 which are used to perform low level addressing of respective feed modules.

The outputs from inverting buffers 834a to 834f are connected to respective MOSFETs 835a to 835f to form high level addressing signals HLAFE1 to HLAFE6.

The final output signal from BCD to decimal decoder 831 is connected via an inverting buffer 836 to a MOSFET 837 which is capable of pulling signal DLLDWN to 0 volts.

Bit 6 of the output latch 827 is connected to an inverting buffer 838 to generate output signal MAIN_MTR, which activates and deactivates the transport motor 417C.

Bit 4 of the output latch 827 is connected to an inverting buffer 839 which is in turn connected to a PNP Darlington transistor 840 acting as a switch to couple output signal FEEDSOL to the 27 Volt supply.

The fifth bit of the latched output data from output latch 827 is connected to an inverting buffer 841 which is connected to the armatures of relays 842 and 843. The other side of the armatures 842 and 843 are connected to the 12 Volt supply, and so a binary “1” on the fifth bit of output data from latch 827 will cause the armatures to be energised.

Finally, the most significant bit of the latch data from output latch 827 is connected to an inverting buffer 844 which is connected to a PNP Darlington transistor 845, the collector of which is connected to one of the poles of relay 843. The emitter of Darlington transistor 845 is connected to the 27 volt supply such that the 27 volt supply may be connected to output signal LOLIMFE or LIFT depending on the state of energisation of the armature of relay 843.

8.6.1.2 Second Output Latch

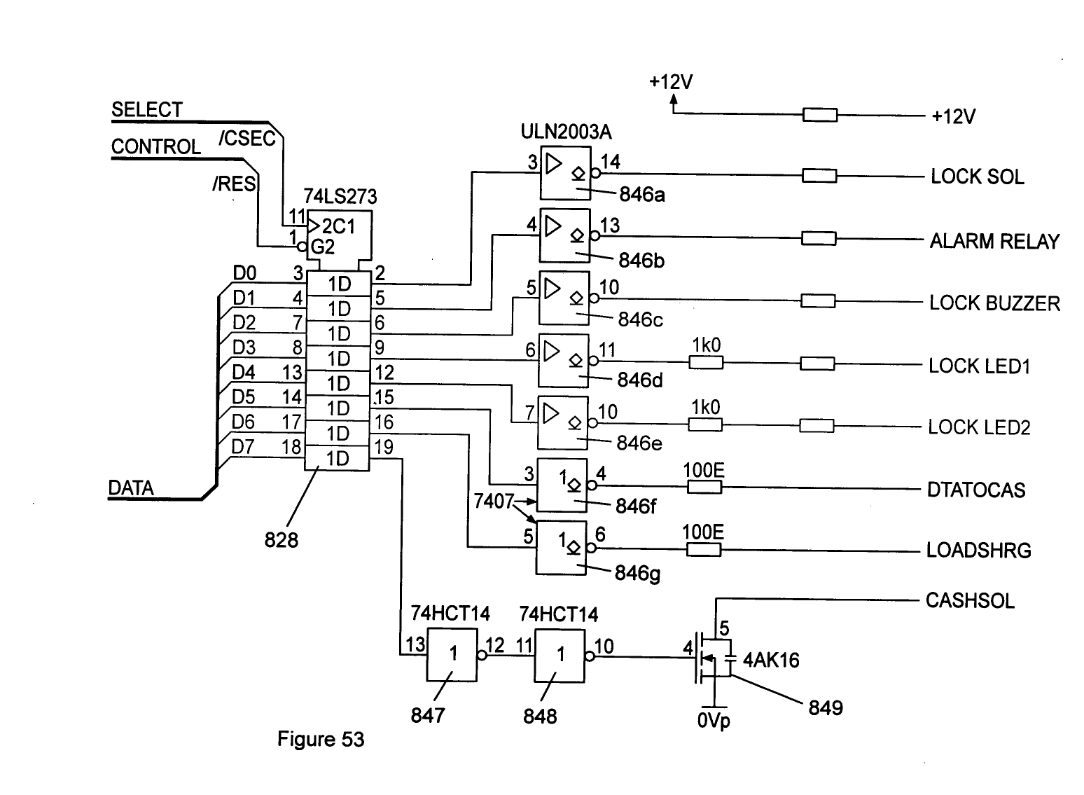

The second output latch 828 (see FIG. 53) has its least significant seven bits connected to inverting buffers 846a to 846g which provide the following output signals:

LOCKSOL, ALARM RELAY, LOCK BUZZER, LOCK LED1, LOCK LED2, DTATOCAS, LOADSHRG. The most significant bit is connected to a pair of inverting buffers in series 847 and 848. The output of inverting buffer 848 is connected to a MOSFET 849 to produce output signal CASHSOL. The purpose of each of these output signals is set out below:

| Signal name | Function |
|---|---|
| LOCK SOL | Controls the lock solenoid in the cabinet lock |
| ALARM RELAY | When asserted, alarm relay is operated which can be |
| | used to activate an external alarm system |
| LOCK BUZZER | When asserted, buzzer in cabinet lock sounds |
| LOCK LED1 | When asserted, LED1 in cabinet lock is lit |
| LOCK LED2 | When asserted, LED2 in cabinet lock is lit |
| DTATOCAS | 24 bit serial information to be fed to cassette |
| | shift registers |
| LOADSHRG | Controls loading of cassette shift registers and |
| | enables the data on signal DTATOCAS to be sent to a |
| | cassette |
| CASHSOL | Controls the cradle solenoid |

8.6.1.3 First Input Latch

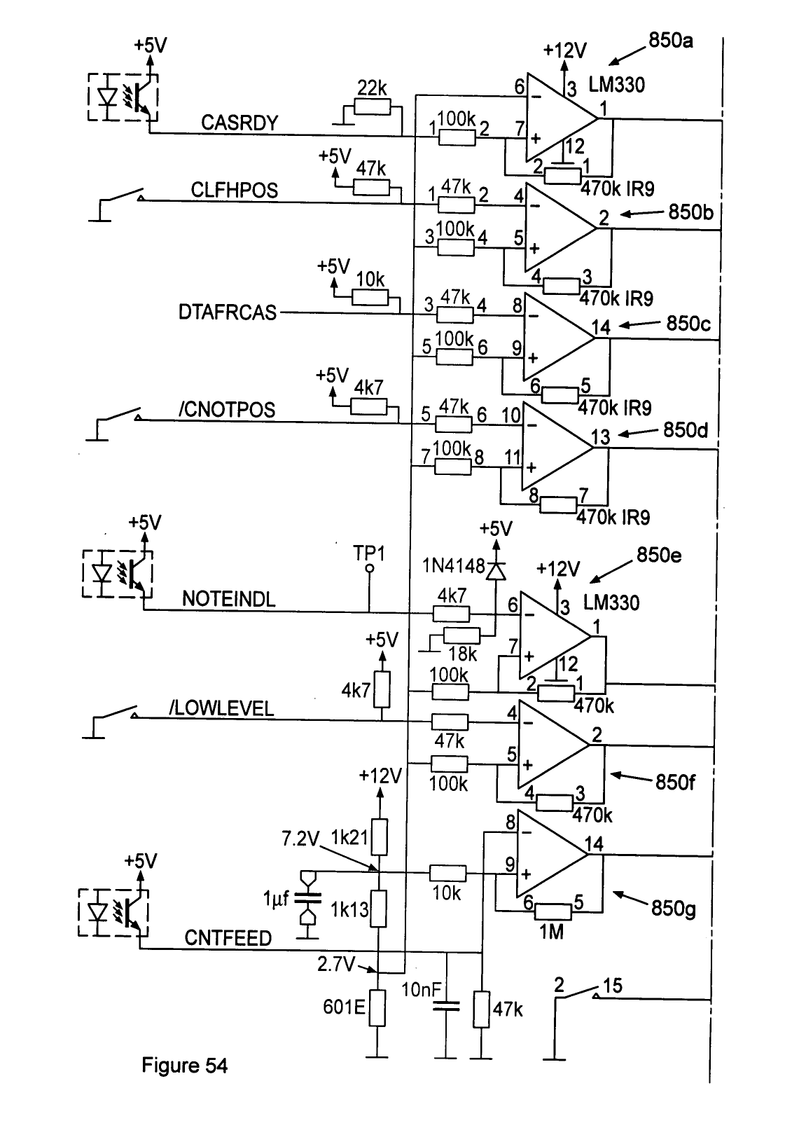

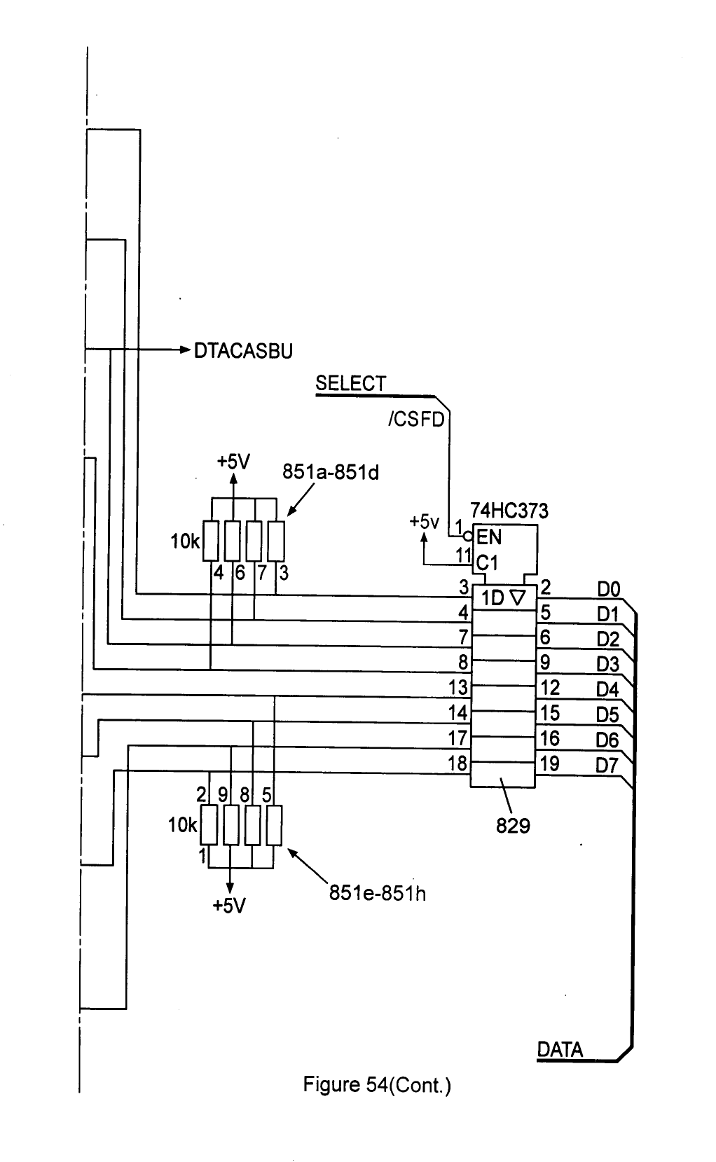

The first input latch 829 (see FIG. 54) latches the following status signals: CASRDY, CLFHPOS, DTAFRCAS, CNOTPOS, NOTEINDL, LOWLEVEL, SW2:2, CNTFEED. The purpose of each of these status signals is set out below:

| Signal name | Function |
|---|---|
| CASRDY | Asserted when photo sensor in cassette detects the |
| | lifter starting to lift the pressure plate |
| CLFHPOS | Microswitch on stacker delivery module indicates |
| | if cleaning fingers are in home position (switch |
| | open) |
| DTAFRCAS | Data from 24 bit shift register in cassettes |
| CNOTPOS | Indicates that cassette is in position |
| NOTEINDL | Sensor at top of stacker indicates if there are |
| | notes left in delivery throat |
| LOWLEVEL | Low level switch on feed module indicates a low |
| | level of notes in a cassette |
| SW2:2 | This signal is not used |
| CNTFEED | Counts notes leaving feeder and indicates high |
| | pressure in cassette |

The CNTFEED signal has two functions as indicated in the above table. Firstly, during a feed command the count sensor is activated and asserts the CNTFEED signal. Secondly, if the count sensor is activated when the feed solenoid is not energised then the pressure exerted by the notes in the cassette on the feeding mechanism is too high.

With the exception of SW2:2, all of the signals are connected to latch 829 via respective Schmitt trigger 850a to 850g. The output from Schmitt trigger 850c also forms a signal known as DTACASBU which is supplied to the address decoder switch, the output of which forms signal SYNCB.

Each output from Schmitt triggers 850a to 850g and signal SW2:2 is pulled to 5 volts via respective 10 KΩresistors 851a to 851h.

8.6.1.4 Second Input Latch

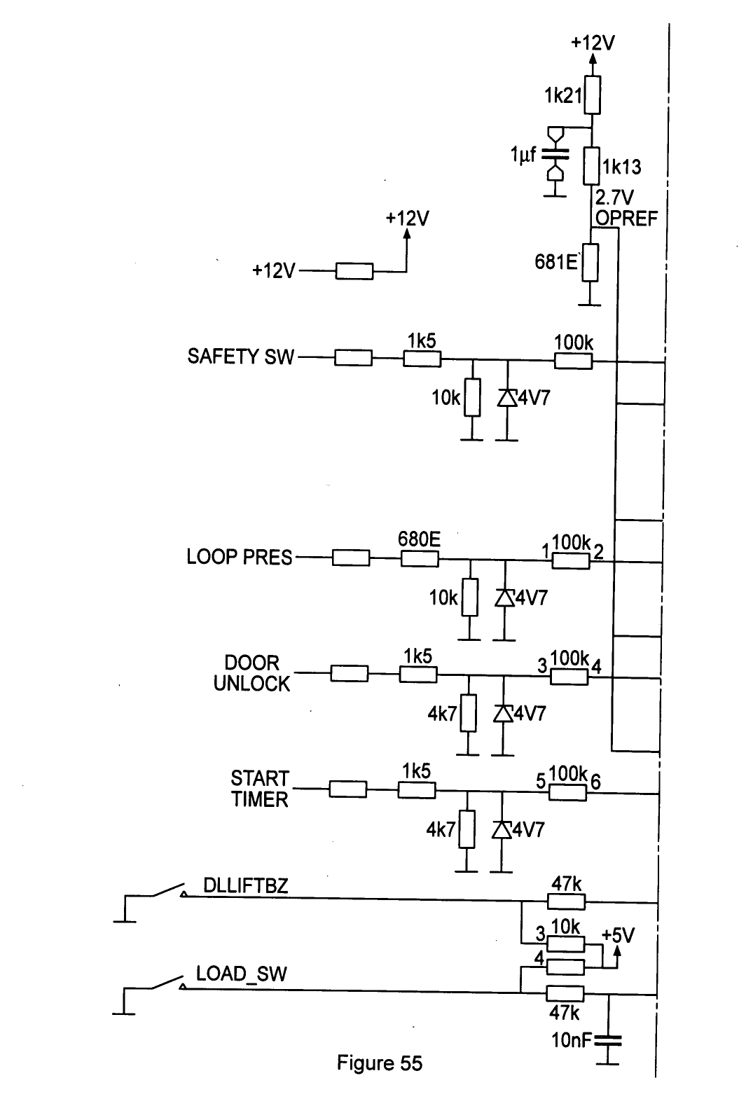

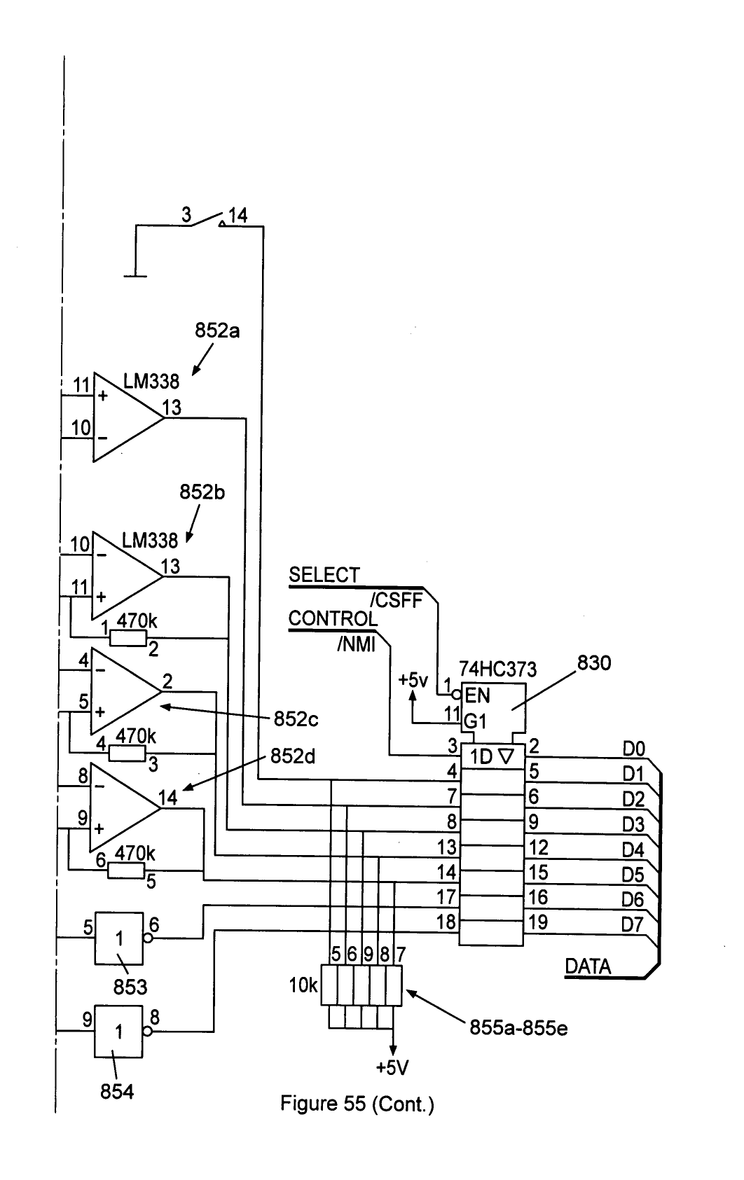

The second input latch 830. (see FIG. 55) latches the following signals on to the eight bits of the data bus: NMI, SW2:3, SAFETY SW, LOOPPRES, DOOR UNLOCK, START TIMER, DLLIFTBZ and LOAD SW. The purposes of each of these status signals is set out below:

| Signal name | Function |
|---|---|
| NMI | Non-maskable interrupt |
| SW2: 3 | This signal is not used |
| SAFETY SW | Safety switch signal, which indicates that the |
| | cabinet door is open and prevents the motors from |
| | running |
| LOOP PRES | Indicates that an external alarm loop is present |
| DOOR UNLOCK | Indicates that cabinet door is not locked |
| START TIMER | Indicates that lock timer is to be started |
| DLLIFTBZ | Microswitch in stacker indicates if delivery lift |
| | is in home position (switch open) or not |
| LOAD SW | OPERATING/LOAD switch position. Switch open in |
| | LOAD position. This controls the operation of the |
| | lift motors, and allows a service technician to |
| | override the control by software |

All signals with the exception of NM1 and SW2:3 are connected to latch 830 via respective Schmitt triggers 852a to 852d. Signals DLLIFTBZ and LOAD SW are connected to latch 830 by respective inverting buffers 853 and 854. Each of the outputs from Schmitt triggers 852a to 852d and signal SW2:3 are pulled to 5 volts through respective 10 KΩ resistors 855a to 855e.

8.6.2 Cassette Interface

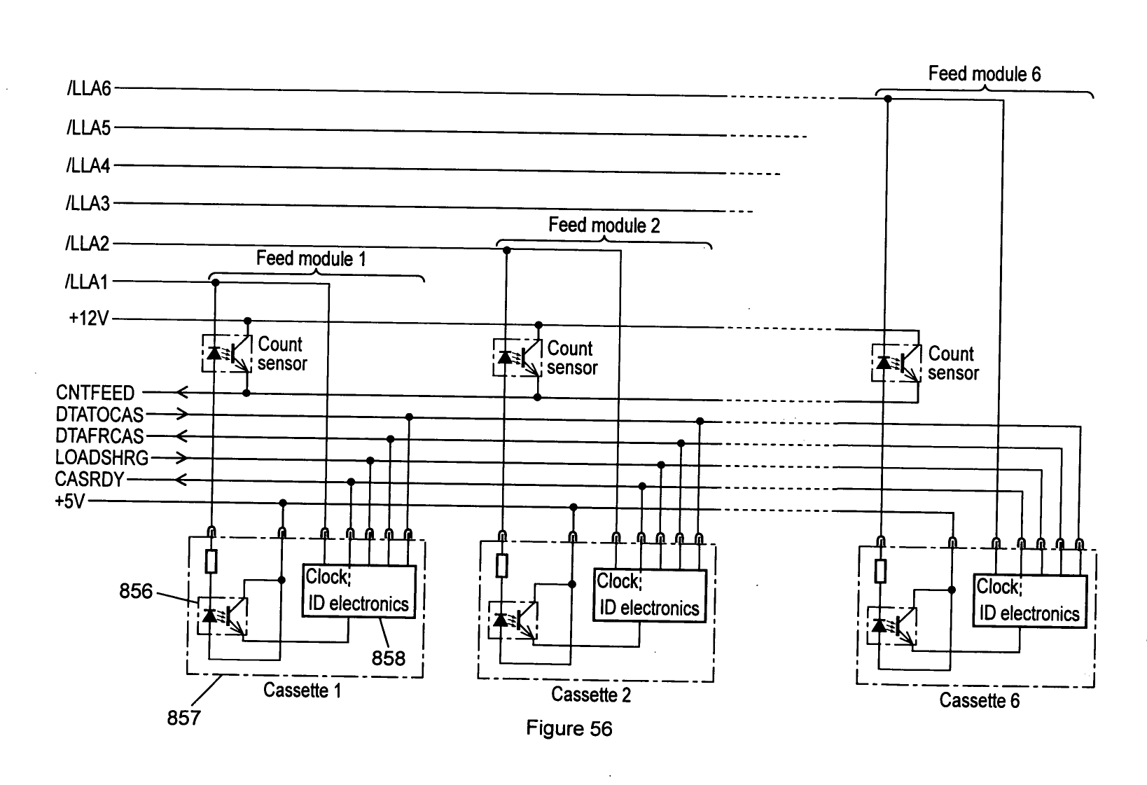

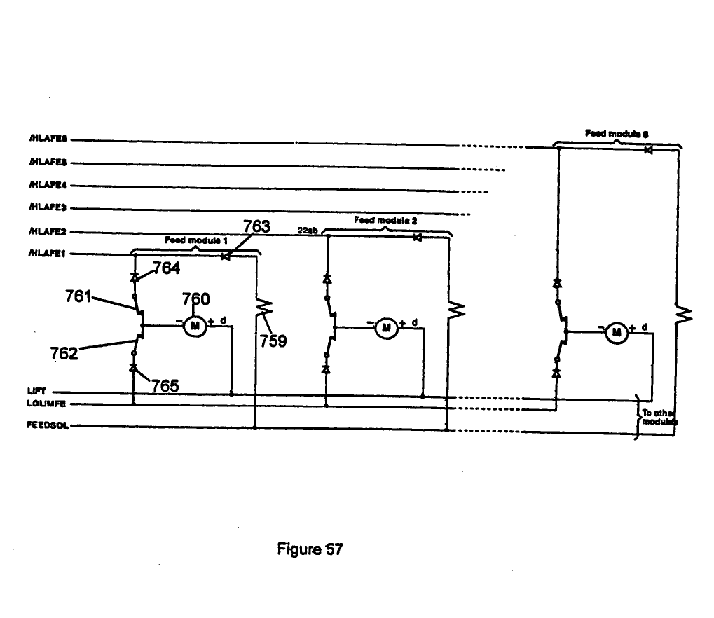

FIG. 56 shows how signals from the interface circuitry communicate with the circuitry in each of the six cassettes. As can be seen, each of the cassettes are multiplexed, all being connected to the CNTFEED, DTATOCAS, DTAFRCAS, LOADSHRG and CASRDY signal lines simultaneously. Each cassette circuit can be enabled by asserting the respective LLA1 to LLA6 signal line. Only one of these signal lines can be asserted at any one time, the circuitry in the other cassettes remaining in a high impedance state so as not to cause contention on any of the signal lines. The operation of the cassette electronics will now be described with reference to one of the six cassettes, the remaining five being identical in nature. In order to enable feed module 1, the signal LLA1 is asserted. This allows current to flow through the LED in the count sensor and also through opto-coupler 856 in cassette 857. The count sensor is operable to cause the signal CNTFEED to be pulled to 12 volts when no note is present. However, when a note passes the respective count sensor, the beam is interrupted causing the phototransistor in the count sensor to represent a high impedance whereby a pull-down resistor will return the CNTFEED signal to 0 volts.

In this way, the notes may be counted as they are fed out of each cassette. The opto-coupler 856 in each cassette detects when the pressure plate in the cassette has been lifted allowing light to impinge on the phototransistor. The phototransistor then becomes a low impedance, applying a 5 volt signal to the cassette electronics. This is made available as the signal CASRDY. The remaining signals DTATOCAS, DTAFRCAS and LOADSHRG are connected to a shift register which can store ID information relevant to the cassette. The signal DTATOCAS acts as the input to the shift register whilst the signal DTAFRCAS acts as the output from the other end of the 24 bit shift register. The clock signal is applied by pulsing the LLA1 signal. The signal LOADSHRG acts as a write-protect signal only enabling the loading of information into the shift register when it is asserted.

8.6.3 Feed Solenoid and Note LIFT Motors

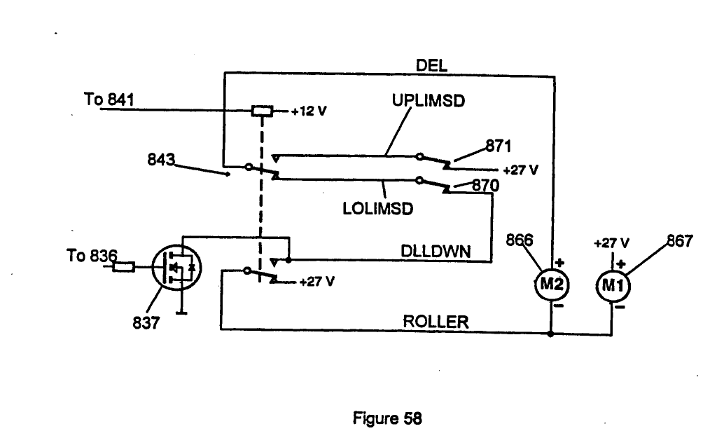

FIG. 57 shows how the high level addressing signals HLAFE1 to HLAFE6 are used to control the operation of the feed solenoids and note lift motors. Each feed module is multiplexed such that it is only enabled by assertion of its respective HLAFE signal, each feed module sharing the LIFT, LOLIMFE and FEEDSOL signals.

The operation of the feed solenoid and note lift motor of one feed module only will be described since all operate in the same manner. In order to enable the feed solenoid and note lift motor of feed module 1, the HLAFE1 signal is asserted. As can be seen from FIG. 52, this causes the respective MOSFET 835a to sink all current from the HLAFE1 signal line.

When the Darlington transistor 840 is activated, 27 volts is present on the FEEDSOL signal line causing the feed solenoid armature 859 to be energised thereby actuating the feed solenoid.

In order to activate the lift motor in a forward direction, the relay 843 is placed in its normally-open state (i.e. opposite to that shown in FIG. 52) such that Darlington transistor 845 can connect 27 volts to the LIFT signal. This flows through the lift motor 860 and the upper limit switch 861 to the HLAFE1 signal line thereby activating the motor in a forward direction until the upper limit switch 861 is interrupted. In order to reverse the motor 860, relay 843 is placed in its normally-closed state (i.e. as shown in FIG. 52), such that the LOLIMFE signal line is connected to 27 volts and the LIFT signal line is connected to 0 volts. This causes current to flow through the lower limit switch 862 and the lift motor 860 until such time as the lower limit switch 862 is interrupted.

Diode 863 prevents current flowing through the lift motor 860 from flowing through the feed solenoid 859. Similarly, diode 864 prevents feed solenoid 859 current flowing through the note lift motor 860, and diode 865 prevents lift motor current and feed solenoid current from flowing through the lift motors of other feed modules via the LOLIMFE signal line.

8.6.3 Stacker Delivery Control

The LLASTKR signal is used to address the reject cassette so that data can be loaded into and read from its shift register via the DTATOCAS, LOADSHRG and DTAFRCAS signals in the same manner as already described with respect to the feed modules. The LLASTKR signal acts as a clock.

FIG. 58 shows how the motors in the delivery module are controlled. The delivery lift and roller motors 866 and 867 are controlled by the BCD to decimal decoder 831 which can assert an output to cause MOSFET 837 to pull the DLLDWN signal to 0 volts. When relay 842 is in the normally-closed position (as shown in FIG. 52), the delivery roller motor is deactivated whilst the delivery lift motor 866 is driven in reverse until the lower limit switch 870 is interrupted. This causes the notes to be rejected.

When the relay 842 is in the normally-open position, the delivery roller motor 867 is in operation and the delivery lift motor 866 is driven in a forward direction until the upper limit switch 871 is interrupted. Thus, the notes are delivered to an operator.

8.7 Internal Personal Computer

The cash dispensing machine may be fitted with an internal personal computer (PC) of usual construction loaded with special driver software to control communications between a terminal PC external to the machine and the cash dispenser machine itself. Communication is normally performed via an RS232 link from the internal PC to the terminal PC and a second RS232 link from the internal PC to the serial I/O circuit 805.

The driver software receives high level commands from the terminal PC and controls the cash dispensing machine in accordance with these commands. It may also control a database storing information on the amounts of cash stored within each cassette, and the amount dispensed. It may also generate log files with service and maintenance information.

8.9 Alarm System

The cash dispenser may be provided with the capability to generate alarms under a number of circumstances.

Firstly, it may be fitted with a seismic alarm unit. This is attached to the inside of the cabinet, and is responsive to any of three sensors that detect vibrations in the cabinet. The sensors are fitted to the door, the cabinet wall and the cabinet floor respectively. This type of alarm is useful to detect attempts to break into the cabinet, for example by drilling through it.

If activated, it may issue an alarm sound or it may communicate with a remote alarm system to cause a silent alarm (i.e. where the law enforcement authorities are notified of the alarm without causing any local report) to be issued.

Once activated, the alarm unit may be reset using a key-operated switch on its case.

An alternative type of alarm is a silent alarm that may be triggered by an operator who can issue a command from their terminal to the cash dispenser indicating that such an alarm should be issued. This command can also cause the dispenser to dispense a required quantity of cash so as not to alert criminals of the alarm.

We claim:

1. A document handling apparatus substantially as herein before described with reference to the accompanying drawings.
